(19) United States
(12) Patent Application Publication
(10) Pub. No.: US 2005/0264833 A1
(43) Pub. Date: Dec. 1, 2005

(54) Image retouching apparatus, corresponding image retouching method, and computer program product for image retouching

(75) Inventors: Yasushi Hiraoka, Nagano-ken (JP); Kiyoshi Mizukura, Nagano-ken (JP); Tomotaka Takarabe, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/073,014

(22) Filed: Mar. 7, 2005

(30) Foreign Application Priority Data
Mar. 9, 2004 (JP) 2004-065505
Mar. 9, 2004 (JP) 2004-065478
Mar. 18, 2004 (JP) 2004-078768

(51) Int. Cl. H04N 1/56; H04N 1/58; H04N 1/60

(52) U.S. Cl. 358/1.9; 358/3.27; 358/531; 358/532; 358/537; 358/538; 358/520

(57) ABSTRACT

The technique of the invention enables the user to readily refer to the details of efficient image processing performed on input image data. On completion of each selected image processing option performed on input image data Dpi, the details of an efficient series of image processing operations sequentially performed for conversion of the input image data Dpi to final retouched image data are updated by taking into account latest settings of relevant parameters of the selected image processing option. The updated details are stored in the form of a work memo file FL2. The work memo file FL2 includes data DT11 ‘execution order’, data DT12 ‘retouching option’, and data DT13 ‘parameters’. The concrete procedure of the invention for ‘efficiency’ updates the parameters of each image processing option to be performed multiple times to the latest settings, while maintaining the user's specified work sequence of the respective image processing options.

### BACKGROUND OF THE INVENTION

1. Field of the Invention

The present invention relates to an image data retouching technique.

2. Description of the Related Art

Image retouching software programs are activated on a computer to perform diverse image processing operations and readily retouch input image data. There are a number of available image processing options, for example, ‘trimming (cutting)’, ‘rotation’, ‘adjustment of brightness’, ‘adjustment of saturation’, ‘unsharp mask’, and ‘blur’. The user sequentially performs plural image processing operations on image data. Some proposed image retouching software programs store the record of the performed image processing operations, for example, Japanese Patent No. 2000-57322A. The record includes identification results of the respective image processing operations and the settings of retouching parameters defining the retouching levels.

There are a large number of different image processing options, and the user may change multiple times the settings of retouching parameters relevant to each image processing option. For example, the user may change the setting of ‘saturation’ from 10 to 15 and then to 20. In such cases, the record does not efficiently inform the user of the optimum settings of retouching parameters relevant to each required image processing operation to obtain a final retouched image. As mentioned above, the record includes all the image processing operations actually performed and all the settings of the retouching parameters. The user accordingly has difficulty in referring to the sequence of plural image processing operations and the required settings of retouching parameters of each image processing operation.

A series of image processing operations may be performed again on the same input image data with no change of retouching parameters or with some change of the retouching parameters. The prior art technique, however, does not properly present the user's intentions of the respective settings of retouching parameters relevant to each image processing operation. The user may thus not sufficiently utilize the existing settings of retouching parameters and may not obtain desired high-quality retouched image data even by re-execution of the image retouching operations.

There is a demand for applying a certain image processing operation to only part of an object image. One proposed retouching technique lays a mask over the object image prior to execution of a required image processing operation as disclosed in JP 2000-132701A. Here the mask represents gray tone paint to mask a specified area. The user lays one gray tone color sheet over an object image and cuts the sheet to a desired shape as a mask. The mask is to be prepared for each image processing operation.

Preparation of masks for individual image processing operations undesirably lowers the working efficiency. Even when multiple image processing operations have an identical area of an object image to be covered with a mask, the prior art technique requires the user to prepare a mask for each of the multiple image processing operations.

### SUMMARY OF THE INVENTION

The object of the invention is thus to enable the user to readily refer to the details of efficient image processing performed on input image data. The object of the invention is also to enhance the convenience for re-execution of a series of image processing operations for input image data and accordingly improve the quality of resulting retouched image data. The object of the invention is further to improve the working efficiency in application of a mask to each image processing operation.

The technique of the invention is actualized by diversity of arrangements discussed below, in order to attain at least part of the above and the other related objects.

The present invention is directed to a first image retouching apparatus that sequentially performs plural image processing operations on input image data, so as to retouch the input image data. The first image retouching apparatus includes: an image processing setting module that, in response to reception of a user's instruction, identifies each image processing operation to be performed on the input image data and specifies settings of retouching parameters relevant to the identified image processing operation; an image processing module that, in response to the identification and the specification of each image processing operation by the image processing setting module, performs the identified image processing operation with the specified settings of the relevant retouching parameters, so as to sequentially implement the plural image processing operations for conversion of the input image data to final retouched image data; and an image processing recording module that, on completion of each image processing operation performed by the image processing module, updates a record file having an efficiently configured record, based on the identification of the image processing operation and the specification of the settings of the relevant retouching parameters by the image processing setting module, where the efficiently configured record of the record file includes results of the identification and the specification of the plural image processing operations grouped into multiple different image processing operations to be performed in a preset order for conversion of the input image data to the final retouched image data.

The first image retouching apparatus of the invention sequentially performs the identified image processing operations with the specified settings of the relevant retouching parameters on input image data. On completion of each image processing operation, the record file is updated based on the identification of the image processing operation and the specification of the settings of the relevant retouching parameters. The record file has the efficiently configured record of the plural image processing operations grouped into the multiple different image processing operations to be performed in the preset order to obtain the final retouched image data from the input image data. This arrangement enables the user to readily refer to the efficient series of image processing operations to be performed sequentially for conversion of the input image data to the final retouched image data. Namely the first image retouching apparatus of the invention enables the user to readily refer to the efficient image processing performed on the input image data.

In one preferable embodiment of the first image retouching apparatus, the image processing recording module includes: a record addition module that sequentially adds record data, which includes results of the identification and the specification of each image processing operation by the image processing setting module, to the record file; and a record overwrite module that, when an identification result of one image processing operation currently identified and specified by the image processing setting module is identical with an identification result of another image processing operation previously performed on the input image data and recorded in the record file, prohibits the record addition module from adding new record data and overwrites existing settings of retouching parameters of the image processing operation previously performed and recorded in the record file with new settings of the retouching parameters of the currently identified image processing operation.

The record file of this arrangement informs the user of the required image processing operations in the required order to be performed on the input image data and of the latest settings of the retouching parameters relevant to each identified image processing operation.

The first image retouching apparatus of this embodiment may further include: an image processing selection module that selects one of the multiple different image processing operations recorded in the record file; a settings rewrite module that rewrites existing settings of retouching parameters of the selected image processing operation in the record file; and an image processing re-execution module that performs the multiple different image processing operations in the preset order on the input image data according to the rewritten record file.

This arrangement enables the user to readily change the settings of the retouching parameters relevant to each image processing operation and to perform the series of image processing operations again on the input image data with the latest settings of the retouching parameters.

In one preferable embodiment of the first image retouching apparatus constructed to rewrite the settings of the retouching parameters, the image processing re-execution module includes: a first display control module that displays an input menu including multiple activation switches, which are arranged in the preset order to respectively correspond to the multiple different image processing operations recorded in the preset order in the record file and are operated to activate the corresponding image processing operations, on a display device; and a second display control module that, in response to operation of one of the multiple activation switches to select a corresponding image processing operation, opens a dialog box for entry of retouching parameters relevant to the selected image processing operation on the display device. The second display control module is configured to read recorded settings of the retouching parameters of the selected image processing operation from the record file and to display the recorded settings in the dialog box.

The user selects a desired image processing operation from the input menu displayed by the first display control module and enters the settings of relevant retouching parameters in the dialog box opened by the second display control module. This arrangement readily enables re-execution of the efficient series of image processing operations on the input image data.

The first image retouching apparatus of the invention may further include a record file storage module that transfers the record file to a non-volatile memory to be stored in the non-volatile memory.

The details of the image processing operations performed on the input image data are stored in the form of a record file in a non-volatile memory. The efficient series of image processing operations performed on the input image data are thus kept even in a power-off state of the image retouching apparatus and are applicable to retouch any other image data at any time.

The first image retouching apparatus equipped with the record file storage module may further include an image processing application module that sequentially performs the multiple different image processing operations on newly input image data according to the record file stored in the non-volatile memory.

The image processing application module performs the efficient series of multiple different image processing operations on newly input image data.

In one preferable application of the first image retouching apparatus of this structure, the image processing application module includes: a first display control module that displays an input menu including multiple activation switches, which are arranged in the preset order to respectively correspond to the multiple different image processing operations recorded in the preset order in the record file and are operated to activate the corresponding image processing operations, on a display device; and a second display control module that, in response to operation of one of the multiple activation switches to select a corresponding image processing operation, opens a dialog box for entry of retouching parameters relevant to the selected image processing operation on the display device. The second display control module is configured to read recorded settings of the retouching parameters of the selected image processing operation from the record file and to display the recorded settings in the dialog box.

The user selects a desired image processing operation from the input menu displayed by the first display control module and enters the settings of relevant retouching parameters in the dialog box opened by the second display control module. This arrangement enables easy application of the efficient series of image processing operations to the newly input image data.

The technique of the invention is also actualized by a corresponding first image retouching method that sequentially performs plural image processing operations on input image data, so as to retouch the input image data. The first image retouching method includes the steps of: (a) in response to reception of a user's instruction, identifying each image processing operation to be performed on the input image data and specifying settings of retouching parameters relevant to the identified image processing operation; (b) in response to the identification and the specification of each image processing operation in the step (a), performing the identified image processing operation with the specified settings of the relevant retouching parameters, so as to sequentially implement the plural image processing operations for conversion of the input image data to final retouched image data; and (c) on completion of each image processing operation performed in the step (b), updating a record file having an efficiently configured record, based on the identification of the image processing operation and the specification of the settings of the relevant retouching parameters in the step (a), where the efficiently configured record of the record file includes results of the identification and the specification of the plural image processing operations grouped into multiple different image processing operations to be performed in a preset order for conversion of the input image data to the final retouched image data.

Another application of the invention is a corresponding first computer program product that causes a computer to sequentially perform plural image processing operations on input image data and thereby retouch the input image data. The first computer program product includes: a computer readable recording medium; and a computer program recorded in the recording medium.

The computer program has: a first program of, in response to reception of a user's instruction, identifying each image processing operation to be performed on the input image data and specifying settings of retouching parameters relevant to the identified image processing operation; a second program of, in response to the identification and the specification of each image processing operation by the first program, performing the identified image processing operation with the specified settings of the relevant retouching parameters, so as to sequentially implement the plural image processing operations for conversion of the input image data to final retouched image data; and a third program of, on completion of each image processing operation performed by the second program, updating a record file having an efficiently configured record, based on the identification of the image processing operation and the specification of the settings of the relevant retouching parameters by the first program, where the efficiently configured record of the record file includes results of the identification and the specification of the plural image processing operations grouped into multiple different image processing operations to be performed in a preset order for conversion of the input image data to the final retouched image data.

The first image retouching method and the first computer program product enable the user to readily refer to the efficient series of image processing operations performed on the input image data, like the effects of the first image retouching apparatus of the invention described above.

The present invention is also directed to a second image retouching apparatus that sequentially performs plural image processing operations on input image data, so as to retouch the input image data. The second image retouching apparatus includes: an image processing identification module that receives a user's instruction and identifies each of the plural image processing operations to be performed sequentially on the input image data; a parameter setting module that, in response to the identification of each image processing operation by the image processing identification module, receives the user's instruction and specifies settings of retouching parameters relevant to the identified image processing operation; an image processing module that, in response to the specification of settings of retouching parameters relevant to the identified image processing operation by the parameter setting module, performs the identified image processing operation with the specified settings of the relevant retouching parameters, so as to sequentially implement the plural image processing operations for conversion of the input image data to final retouched image data; a character input module that receives the user's instruction and entry of a character string in the course of the specification of settings of retouching parameters relevant to a certain image processing operation by the parameter setting module; and a data storage module that stores character data, which represents the user's entry of the character string received by the character input module, in relation to an identification result of the certain image processing operation with the settings of the relevant retouching parameters specified by the parameter setting module during the user's entry of the character string.

In the second image retouching apparatus of the invention, the character input module receives the user's entry of a character string while the parameter setting module specifies the settings of retouching parameters relevant to a certain image processing operation. The character data representing the user's entry of the character string is stored in relation to the identification result of the certain image processing operation by the data storage module. The second image retouching apparatus enables the user to refer to the stored character data and confirm the user's intentions of each image processing operation in later occasions.

The second image retouching apparatus enables the user to conveniently utilize the character data on the occasion of re-execution of the series of image processing operations performed on the input image data. This arrangement thus desirably enhances the quality of a resulting retouched image.

In one preferable embodiment of the invention, the second image retouching apparatus further includes a display control module that displays a record of the character data stored in the data storage module with the related identification result of the certain image processing operation on a display device.

The identification result of a certain image processing operation is displayed in combination with the user's entered character data on the display device. The user can thus be readily informed of the intentions of the identified image processing operation. This arrangement further ensures the better user friendliness.

It is preferable that the display control module opens a specific window on the display device to display a list of records of stored character data with related identification results of all the plural image processing operations performed on the input image data by the image processing module.

The user can instantly recognize the intentions of all the image processing operations sequentially performed on input image data. This arrangement ensures the better user friendliness.

In another preferable embodiment of the invention, the second image retouching apparatus further includes: an image processing recording module that, on completion of each of the plural image processing operations performed sequentially on the input image data by the image processing module for conversion of the input image data to the final retouched image data, records details of the performed image processing operation, which include the settings of the relevant retouching parameters specified by the parameter setting module, in a record file; and an image processing re-execution module that sequentially performs the plural image processing operations on the input image data according to the details of the image processing operations recorded in the record file.

The image processing re-execution module re-executes the plural image processing operations on the input image data according to the contents of the record file recorded by the image processing recording module. This arrangement ensures the user friendliness.

The object image data of the image processing operations performed by the image processing re-execution module may be newly input image data that is different from the input image data originally processed as the basis of the record file.

In the second image retouching apparatus equipped with the image processing recording module and the image processing re-execution module, it is preferable that the image processing recording module has: a record addition module that sequentially adds a record, which includes an identification result of each image processing operation, in relation to settings of retouching parameters of the identified image processing operation specified by the parameter specification module, to the record file; and a record overwrite module that, when the parameter specification module specifies new settings of retouching parameters relevant to one image processing operation that is identified to be identical with another image processing operation previously performed on the input image data and recorded in the record file, prohibits the record addition module from adding a new record and overwrites existing settings of the retouching parameters of the image processing operation previously performed and recorded in the record file with the new settings of the retouching parameters.

The record file of this arrangement informs the user of the required image processing operations in the required order to be performed on the input image data and of the latest settings of the retouching parameters relevant to each identified image processing operation.

In the second image retouching apparatus equipped with the image processing recording module that includes the record addition module and the record overwrite module, it is preferable that the data storage module stores the character data grouped into same identification results of the plural image processing operations in the record file.

The record file of this structure enables comprehensive management of the identification result of each image processing operation, the settings of relevant retouching parameters, and the user's entered character data.

In one preferable application, the second image retouching apparatus using the record file further includes: an additional character entry module that receives the user's instruction and entry of an additional character string in the course of recording the details of each image processing operation in the record file; and an additional character data storage module that stores additional character data, which represents the user's entry of the additional character string received by the additional character entry module, in the record file.

This arrangement enables the user to add a new character string to the record file.

The second image retouching apparatus equipped with the additional character data storage module may further include a display control module that displays the character data stored in the record file on a display device.

The character data displayed on the display device informs the user of the character string added to the record file. This arrangement ensures the better user friendliness.

The technique of the invention is also actualized by a corresponding second image retouching method that sequentially performs plural image processing operations on input image data, so as to retouch the input image data. The second image retouching method includes the steps of: (a) receiving a user's instruction and identifying each of the plural image processing operations to be performed sequentially on the input image data; (b) in response to the identification of each image processing operation in the step (a), receiving the user's instruction and specifying settings of retouching parameters relevant to the identified image processing operation; (c) in response to the specification of settings of retouching parameters relevant to the identified image processing operation in the step (b), performing the identified image processing operation with the specified settings of the relevant retouching parameters, so as to sequentially implement the plural image processing operations for conversion of the input image data to final retouched image data; (d) receiving the user's instruction and entry of a character string in the course of the specification of settings of retouching parameters relevant to a certain image processing operation in the step (b); and (e) storing character data, which represents the user's entry of the character string received in the step (d), in relation to an identification result of the certain image processing operation with the settings of the relevant retouching parameters specified in the step (b) during the user's entry of the character string.

Another application of the invention is a corresponding second computer program product that causes a computer to sequentially perform plural image processing operations on input image data and thereby retouch the input image data. The second computer program product includes: a computer readable recording medium; and a computer program recorded in the recording medium.

The computer program has: a first program of receiving a user's instruction and identifying each of the plural image processing operations to be performed sequentially on the input image data; a second program of, in response to the identification of each image processing operation by the first program, receiving the user's instruction and specifying settings of retouching parameters relevant to the identified image processing operation; a third program of, in response to the specification of settings of retouching parameters relevant to the identified image processing operation by the second program, performing the identified image processing operation with the specified settings of the relevant retouching parameters, so as to sequentially implement the plural image processing operations for conversion of the input image data to final retouched image data; a fourth program of receiving the user's instruction and entry of a character string in the course of the specification of settings of retouching parameters relevant to a certain image processing operation by the second program; and a fifth program of storing character data, which represents the user's entry of the character string received by the fourth program, in relation to an identification result of the certain image processing operation with the settings of the relevant retouching parameters specified by the second program during the user's entry of the character string.

The second image retouching method and the second computer program product allow for effective use of the user's entered character data and thus ensures the user friendliness, like the effects of the second image retouching apparatus of the invention described above.

The present invention is further directed to a third image retouching apparatus that sequentially performs plural image processing operations on input image data, so as to retouch the input image data. The third image retouching apparatus includes: a mask data setting module that sets mask data representing a mask, which is laid on the input image data to mask a specified area of an input image expressed by the input image data during execution of the selected image processing operation; an image processing setting module that, in response to reception of a user's instruction, identifies each image processing operation to be performed on the input image data and specifies settings of retouching parameters relevant to the identified image processing operation; and an image processing module that, in response to the identification and the specification of each image processing operation by the image processing setting module, performs the identified image processing operation with the mask data set by the mask data setting module and with the specified settings of the relevant retouching parameters, so as to sequentially implement the plural image processing operations for conversion of the input image data to final retouched image data.

The third image retouching apparatus of the invention applies the mask data set by the mask data setting module to each of the plural image processing operations performed sequentially by the image processing module. This arrangement ensures the high working efficiency in application of a mask to each image processing operation.

In one preferable embodiment of the invention, the third image retouching apparatus further includes: a mask data registration module that registers each mask data set by the mask data setting module in a mask table; and a mask data selection module that, in response to the user's instruction, selects the user's desired mask data out of available mask data registered in the mask table. The image processing module uses the user's desired mask data selected by the mask data selection module for the mask data set by the mask data setting module.

The mask data selection module selects any number of the user's desired mask data from the mask table to be applied on identical input image data. The user's desired mask data can thus be applied to each of the plural image processing operations sequentially performed by the image processing module. This arrangement ensures efficient application of multiple mask data.

In one preferable application of the third image retouching apparatus having the above structure, the mask data registration module registers each mask data with a name given to the mask data by the user's instruction, and the mask data selection module selects the user's desired mask data by specifying a corresponding name given to the mask data.

This arrangement ensures management of mask data with their names.

The third image retouching apparatus configured to manage the mask data with the names may further include: a recording module that, on completion of each image processing operation performed by the image processing module, sequentially adds a record, which includes an identification result of the image processing operation, specified settings of retouching parameters relevant to the identified image processing operation, and a name of mask data applied to the identified image processing operation, to a record file; and a record overwrite module that, when the image processing module re-executes an identical image processing operation in combination with identical mask data, which was performed previously on the input image data and was recorded in the record file, prohibits the recording module from adding a new record to the record file and overwrites existing settings of retouching parameters relevant to the identical image processing operation in the record file with new settings of the retouching parameters for re-execution.

The identification result of each image processing operation, the specified settings of the retouching parameters relevant to the identified image processing operation, and the name of the mask data applied to the identified image processing operation are stored in a correlated manner in the record file. A final retouched image can thus be reproduced from input image data according to the storage in the record file.

The third image retouching apparatus configured to have storage in the record file may further include a display control module that reads at least the identification result of each image processing operation and the name of mask data to be applied to the identified image processing operation from the record file and displays at least the identification result and the name of mask data on a display device.

This arrangement enables the user to visually confirm the contents of the record file, especially the name of the mask data.

The third image retouching apparatus may further include a mask data storage module that stores the mask data in a non-volatile memory.

The mask data is kept even in a power-off state of the image retouching apparatus and is thus reusable according to the requirements.

The technique of the invention is also actualized by a corresponding third image retouching method that sequentially performs plural image processing operations on input image data, so as to retouch the input image data. The third image retouching method includes the steps of: (a) setting mask data representing a mask, which is laid on the input image data to mask a specified area of an input image expressed by the input image data during execution of the selected image processing operation; (b) in response to reception of a user's instruction, identifying each image processing operation to be performed on the input image data and specifying settings of retouching parameters relevant to the identified image processing operation; and (c) in response to the identification and the specification of each image processing operation in the step (b), performing the identified image processing operation with the mask data set in the step (a) and with the specified settings of the relevant retouching parameters, so as to sequentially implement the plural image processing operations for conversion of the input image data to final retouched image data.

Another application of the invention is a corresponding third computer program product that causes a computer to sequentially perform plural image processing operations on input image data and thereby retouch the input image data. The third computer program product includes: a computer readable recording medium; and a computer program recorded in the recording medium.

The computer program has: a first program of setting mask data representing a mask, which is laid on the input image data to mask a specified area of an input image expressed by the input image data during execution of the selected image processing operation; a second program of, in response to reception of a user's instruction, identifying each image processing operation to be performed on the input image data and specifying settings of retouching parameters relevant to the identified image processing operation; and a third program of, in response to the identification and the specification of each image processing operation by the second program, performing the identified image processing operation with the mask data set by the first program and with the specified settings of the relevant retouching parameters, so as to sequentially implement the plural image processing operations for conversion of the input image data to final retouched image data.

The third image retouching method and the third computer program product ensure the high working efficiency in application of a mask to each image processing operation, like the effects of the third image retouching apparatus of the invention described above.

The technique of the invention may be actualized by diversity of other applications. A first available application is computer programs recorded in the first through the third computer program products discussed above. A second available application is a program supply device that supplies such computer programs via a communication line. In the second application, the computer may download the computer programs stored in, for example, a server on a computer network via the communication line and execute the downloaded computer programs to attain the image retouching apparatuses and the image retouching methods described above.

### BRIEF DESCRIPTION OF THE DRAWINGS

FIG. 1 is a block diagram schematically illustrating the hardware configuration of a computer system 10 in a first embodiment of the invention;

FIG. 2 is a block diagram showing a control flow according to photo retouching software 50 executed by a computer body 16;

FIG. 3 is a flowchart showing a routine of the control flow;

FIG. 4 shows the initial state of an application window WD;

FIG. 5 is a flowchart showing a first half of a retouching process;

FIG. 6 is a flowchart showing a latter half of the retouching process;

FIG. 7 shows the display of the application window WD for the retouching process;

FIG. 8 shows a dialog box DBX1 for an image processing option ‘hue/saturation/intensity’;

FIG. 9 shows one example of a retouching record file FL1;

FIG. 10 shows one example of a work memo file FL2;

FIG. 11 is a flowchart showing the details of the process of updating the work memo file FL2 at step S394 of the retouching process;

FIG. 12 shows the display of a work information display field WK corresponding to the contents of the retouching record file FL1 of FIG. 9;

FIG. 13 shows the display of the work information display field WK corresponding to the contents of the work memo file FL2 of FIG. 10;

FIG. 14 shows a change of the display in the work information display field WK for the parameters of ‘Work Memo’;

FIG. 15 shows the display of the work information display field WK under the selection of a tab TB13 ‘Work Note’;

FIG. 16 shows the display of the application window WD for the retouching process in response to selection of a group tab TB6 ‘Work Note’ on a tool bar BR2;

FIG. 17 is a block diagram showing a control flow executed in a second embodiment of the invention;

FIG. 18 is a flowchart showing a routine of the control flow;

FIG. 19 is a flowchart showing a first half of a retouching process;

FIG. 20 is a flowchart showing a latter half of the retouching process;

FIG. 21 shows a dialog box DBX2 for entry of operation comments;

FIG. 22 shows one example of a work memo file FL12;

FIG. 23 is a flowchart showing the details of the process of updating the work memo file FL2 at step S1394 of the retouching process;

FIG. 24 is a flowchart showing a work note file generation routine;

FIG. 25 shows a dialog box DBX3 for work note file generation;

FIG. 26 shows one example of a work note file FL3;

FIG. 27 shows the display of the work information display field WK under the selection of the tab TB13 ‘Work Note’;

FIG. 28 shows the display of the application window WD for the retouching process in response to selection of the group tab TB6 ‘Work Note’ on the tool bar BR2;

FIG. 29 shows a work note window WD2 opened in response to a click of an icon BT31 ‘Note Description’ on the tool bar BR2;

FIG. 30 is a block diagram showing a control flow executed in a third embodiment of the invention;

FIG. 31 is a flowchart showing a routine of the control flow;

FIG. 32 is a flowchart showing a first half of a retouching process;

FIG. 33 is a flowchart showing a latter half of the retouching process;

FIG. 34 shows the display of the application window WD for the retouching process;

FIG. 35 is a flowchart showing the details of a mask setting process;

FIG. 36 shows a ‘Mask Setting’ window WDm;

FIG. 37 shows a ‘New Mask Creation’ dialog box DBX21;

FIG. 38 shows the display of the ‘Mask Setting’ window WDm with a mask layer;

FIG. 39 shows a process of specifying a search range with a ‘Contour’ tool;

FIG. 40 shows the display of the ‘Mask Setting’ window WDm with mask data MDT1 after cutting;

FIG. 41 shows mask data MDT1 ‘Castle’;

FIG. 42 shows mask data MDT2 ‘Sky’

FIG. 43 shows the data structure of a mask table TBLm;

FIG. 44 shows the display of the application window WD for the retouching process with application of the mask data MDT1;

FIG. 45 shows a ‘Save As’ dialog box DBX22;

FIG. 46 shows an ‘Open File’ dialog box DBX2 3;

FIG. 47 shows a dialog box DBX24 for an image processing option ‘color balance’;

FIG. 48 shows one example of a retouching record file FL21;

FIG. 49 shows one example of a work memo file FL22;

FIG. 50 is a flowchart showing the details of the process of updating the work memo file FL22 at step S394 of the retouching process;

FIG. 51 shows the display of the work information display field WK corresponding to the contents of the retouching record file FL1 of FIG. 21;

FIG. 52 shows the display of the work information display field WK corresponding to the contents of the work memo file FL22 of FIG. 49;

FIG. 53 shows a change of the display in the work information display field WK for the parameters and the masks of ‘Work Memo’;

FIG. 54 shows the display of the work information display field WK under the selection of the tab TB13 ‘Work Note’; and

FIG. 55 shows the display of the application window WD for the retouching process in response to selection of the group tab TB6 ‘Work Note’ on the tool bar BR2.

### DESCRIPTION OF THE PREFERRED EMBODIMENTS

Some modes of carrying out the invention are described below as preferred embodiments in the following sequence:

1-1. First Embodiment

A. System Configuration

B. Computer Processing
B-1. General Processing Flow
B-2. Retouching Process

C. Functions and Effects

1-2. Modifications

2-1. Second Embodiment

A. System Configuration

B. Computer Processing
B-1. General Processing Flow
B-2. Retouching Process

C. Functions and Effects

2-2. Modifications

3-1. Third Embodiment

A. System Configuration

B. Computer Processing
B-1. General Processing Flow
B-2. Retouching Process
   B-2-1. Mask Setting Process
   B-2-2. Image Processing

C. Functions and Effects

3-2. Modifications

1-1. First Embodiment

A. System Configuration

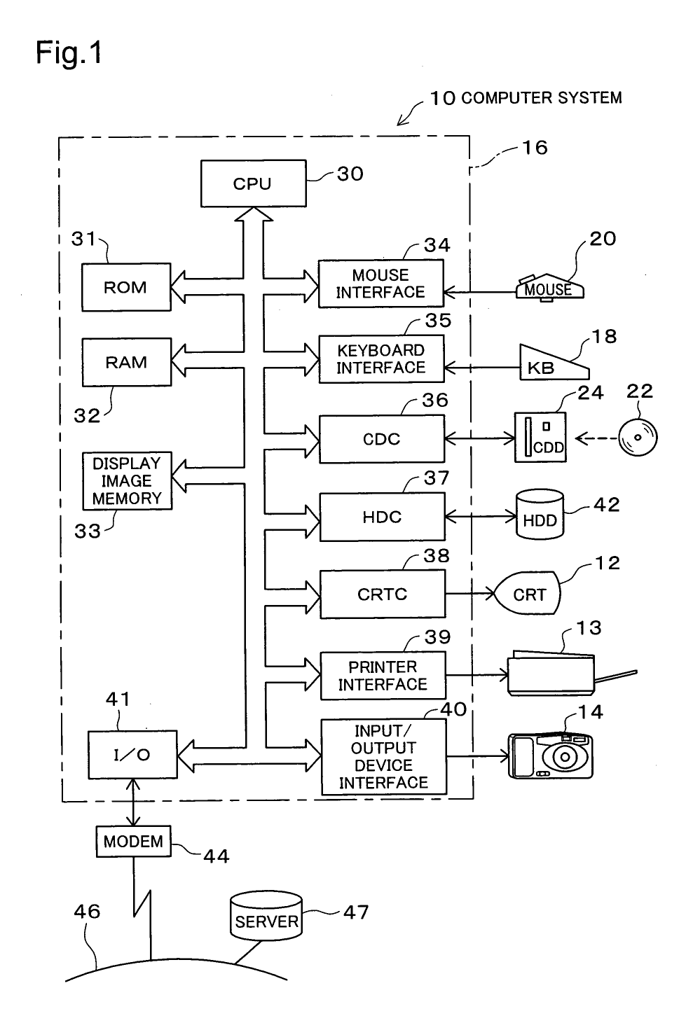

FIG. 1 is a block diagram schematically illustrating the hardware configuration of a computer system 10 in a first embodiment of the invention. This computer system 10 includes a personal computer (hereafter simply referred to as the computer), as well as a CRT display 12, a printer 13, and a digital camera 14 as peripheral devices. The computer has a computer body 16, a keyboard 18, and a mouse 20. A CD drive 24 is mounted on the computer body 16 to read a CD-ROM 22.

The computer body 16 includes a CPU 30, a ROM 31, a RAM 32, a display image memory 33, a mouse interface 34, a keyboard interface 35, a CDC 36, an HDC 37, a CRTC 38, a printer interface 39, an input/output device interface 40, and an I/O port 41, which are mutually connected via a bus. The ROM 31 stores various programs in a read-only manner, while the RAM 32 stores various data in a readable and writable manner. The display image memory 33 stores display image data representing images to be displayed on the CRT display 12.

The mouse interface 34 receives inputs from the mouse 20, and the keyboard interface 35 receives key inputs from the keyboard 18. The CDC 36 represents a CD controller to control the CD drive (CDD) 24, and the HDC 37 represents a hard disk controller to control a hard disk drive (HDD) 42 that has computer programs stored in advance.

The CRTC 38 represents a CRT controller to control display of images on the CRT display 12, based on the display image data stored in the display image memory 33. The printer interface 39 controls data input and output from and to the printer 13. The input/output device interface 40 controls data input and output from and to an externally connected input/output device, for example, the USB (Universal Serial Bus)-connected digital camera 14 in this embodiment. The I/O port 41 has a serial output port and is connected to a public telephone line 46 via a modem 44. The computer boy 16 is connected to an external network via the model 44 to be accessible to a particular server 47.

In this computer system 10, the operating system is stored in the HDD 42. In response to a power-on of the computer body 16, the operating system is loaded into a specific area in the RAM 32 according to a loader written in a boot block of the HDD 42. The CD-ROM 22 stores photo retouching software (computer program), which is used to retouch color photographic images taken with the digital camera 14. This computer program is read from the CD-ROM 22 set in the CD drive 24 and is installed in the computer body 16 by activation of a certain installation program. The installed computer program is stored in the HDD 42 and is loaded to a specific area in the RAM 32 in response to a preset start command.

The CPU 30 executes part of this computer program in the form of modules (described later) to actualize the functions of the invention. The computer program may be stored in a floppy disk, a magneto-optical disk, an IC card, or any other portable recording medium, instead of the CD-ROM 22. The computer program may alternatively be downloaded as program data from the particular server 47 connecting with the external network and transferred to the RAM 32 or the HDD 42. The external network may be the Internet, and the computer program may be downloaded from a particular homepage or may otherwise be supplied as an attachment file to an e-mail.

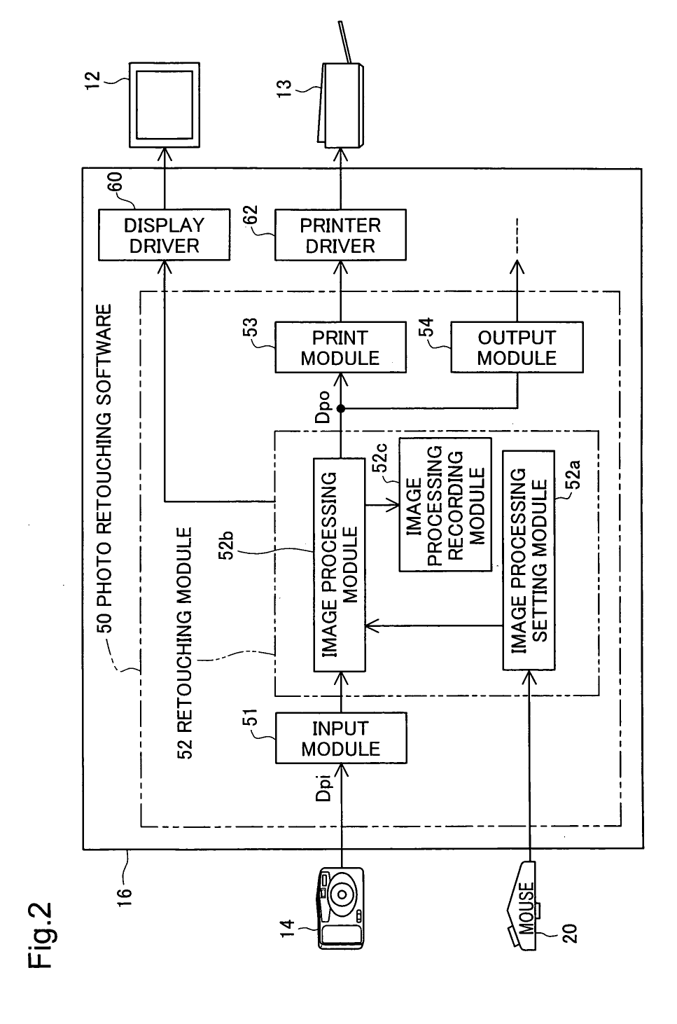

A series of control executed according to the photo retouching software in the computer system 10 of the above hardware configuration is described below. FIG. 2 is a block diagram showing a control flow according to this photo retouching software 50 executed by the computer body 16.

As shown in FIG. 2, according to the photo retouching software 50 activated in the computer body 16, an input module 51 first reads image data Dpi representing a photographic image from the digital camera 14. A retouching module 52 then retouches the image data Dpi read by the input module 51 (hereafter referred to as the input image data). The retouching module 52 retouches the photographic image expressed by the input image data Dpi through a series of image processing, for example, rotation and trimming (cutout) of the image, adjustment of the brightness, the contrast, and the saturation of the image, compensation of the exposure of the image, and cross filter effects on the image. The required series of image processing is sequentially performed in response to the user's instructions. The image under retouching by the retouching module 52 is sent to and displayed on the CRT display 12 via a display driver 60.

The retouching module 52 includes an image processing setting module 52a, an image processing module 52b, and an image processing recording module 52c. The functions of these modules 52a through 52c specify the optimum operating procedure of image processing and actually perform the specified series of image processing operations for image retouching. This arrangement is the main characteristics of the invention and will be described in detail later.

According to the photo retouching software 50, a print module 53 transmits the retouched image data Dpo via a printer driver 62 to the printer 13 for printing, while an output module 54 transmits the retouched image data Dpo to an external device.

B. Computer Processing

B-1. General Processing Flow

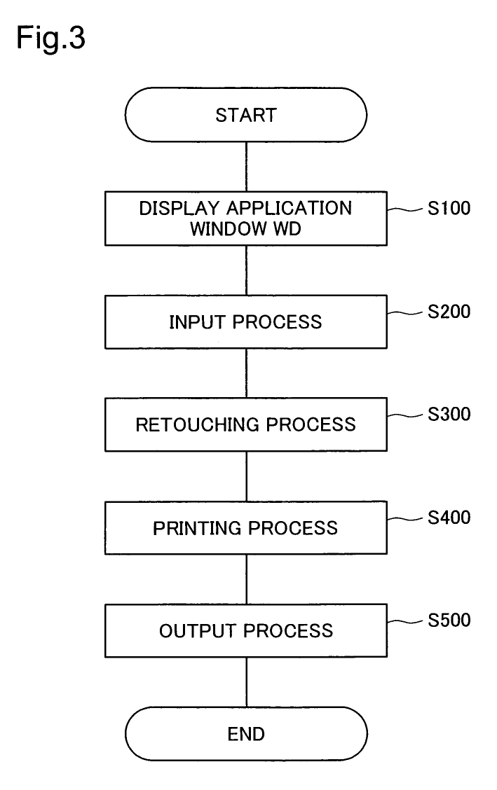

The CPU 30 of the computer body 16 executes the photo retouching software 50 to attain the functions of the input module 51, the retouching module 52, the print module 53, and the output module 54. The series of control according to the photo retouching software 50 is described in detail. FIG. 3 is a flowchart showing a control routine, which is triggered by a start instruction of the photo retouching software 50.

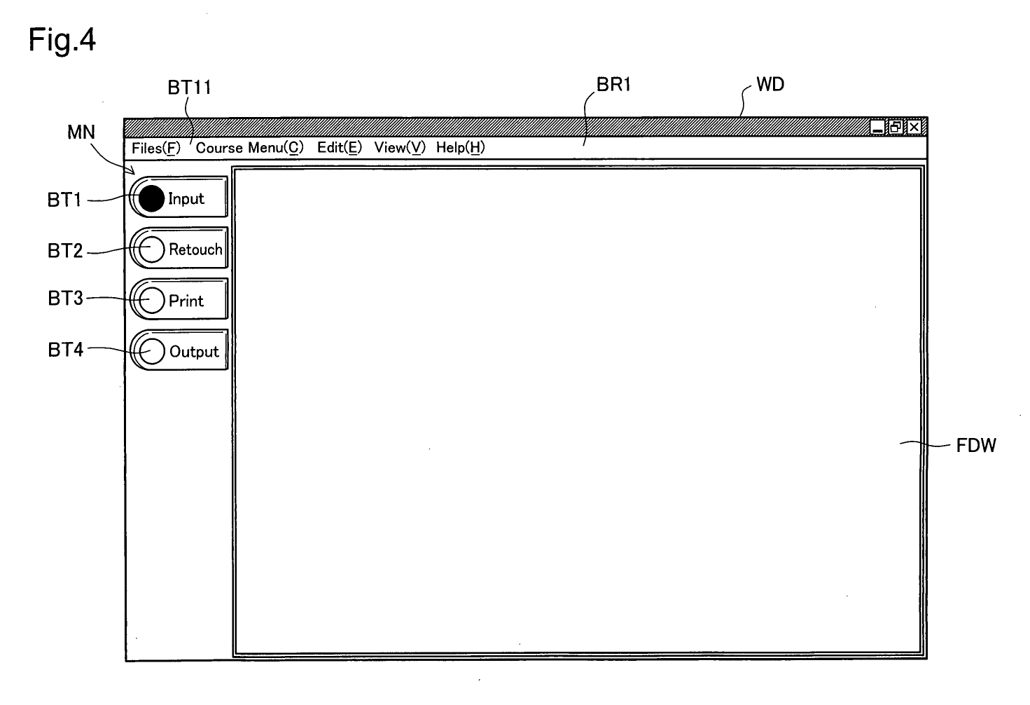

As illustrated, the CPU 30 first opens an application window WD on the CRT display 12 (step S100). FIG. 4 shows the initial state of this application window WD. The application window WD has four menu buttons BT1 to BT4 vertically aligned in a left processing menu field MN. The menu buttons BT1 to BT4 respectively represent ‘Input’, ‘Retouch’, ‘Print’, and ‘Output’. The user sequentially clicks these menu buttons BT1 to BT4 with the mouse 20 to retouch a photographic image taken with the digital camera 14 and output the retouched photographic image on the screen of the CRT display 12. The CPU 30 receives operation commands given by the user's clicks of the menu buttons BT1 to BT4 with the mouse 20 after execution of step S100 and sequentially executes an input process, a retouching process, a printing process, and an output process corresponding to the given operation commands (steps S200, S300, S400, and S500) in the flowchart of FIG. 3.

The input process executed at step S200 corresponds to the functions of the input module 51 (see FIG. 2) and reads image data Dpi representing a photographic image from the digital camera 14. The image data Dpi is input from the digital camera 14, when the user clicks with the mouse 20 a button BT11 ‘Files’ in a menu bar BR1 on the application window WD shown in FIG. 4 to open a pulldown menu (not shown) and sequentially selects a menu option ‘External Device Input’, a desired input device (the digital camera 14 in this embodiment), and a desired file name. The input image data Dpi is stored in a specific area on the RAM 32, while being displayed in a work field FDW on the application window WD.

The image data Dpi of each photographic image taken by the digital camera 14 may be accumulated in and read from the HDD 42, instead of being directly read from the digital camera 14. The procedure of this embodiment is applicable to process the image data of photographic images that may be read directly from a digital camera, may be accumulated in and read from memory means, such as the HDD 42, and may be read from an external device via a network.

The retouching process executed at step S300 retouches the input image data Dpi through a series of image processing. The retouching process of this embodiment adopts a ‘retouching parameter system’ for image processing, which stores image retouching information as settings of retouching parameters separately from an original image. The retouching process is the main characteristics of the invention and will be described in detail later. The retouched image data Dpo is stored in a preset folder provided in the HDD 42. The retouching process corresponds to the functions of the retouching module 52 (FIG. 2).

The printing process executed at step S400 outputs the retouched image data Dpo generated at step S300 as a print command to the printer driver. This printing process has the known configuration and is thus not specifically described here. The printer 13 then prints the retouched photographic image according to the retouched image data Dpo. This printing process corresponds to the functions of the print module 53 (FIG. 2).

The output process executed at step S500 outputs the retouched image data Dpo generated at step S300 to an external device. The retouched image data Dpo representing the retouched photographic image is accordingly output to any desired external device. This output process corresponds to the functions of the output module 54 (FIG. 2):

B-2. Retouching Process

The retouching process executed at step S300 is described in detail. The photo retouching software has functions to give photographing environment-changing effects to images (Photographing Environment), functions to give photographing settings-changing effects to images (Photographing Settings), functions to give effects of post processes in a darkroom to images (Darkroom), functions to give filter effects, for example, unsharp mask and blur, to images (Filters), and functions to give adjustment and compensation effects, for example, adjustment of the brightness and the contrast, red-eye reduction, and stain removal, to images (Tools). These functions are selectively performed in the retouching process.

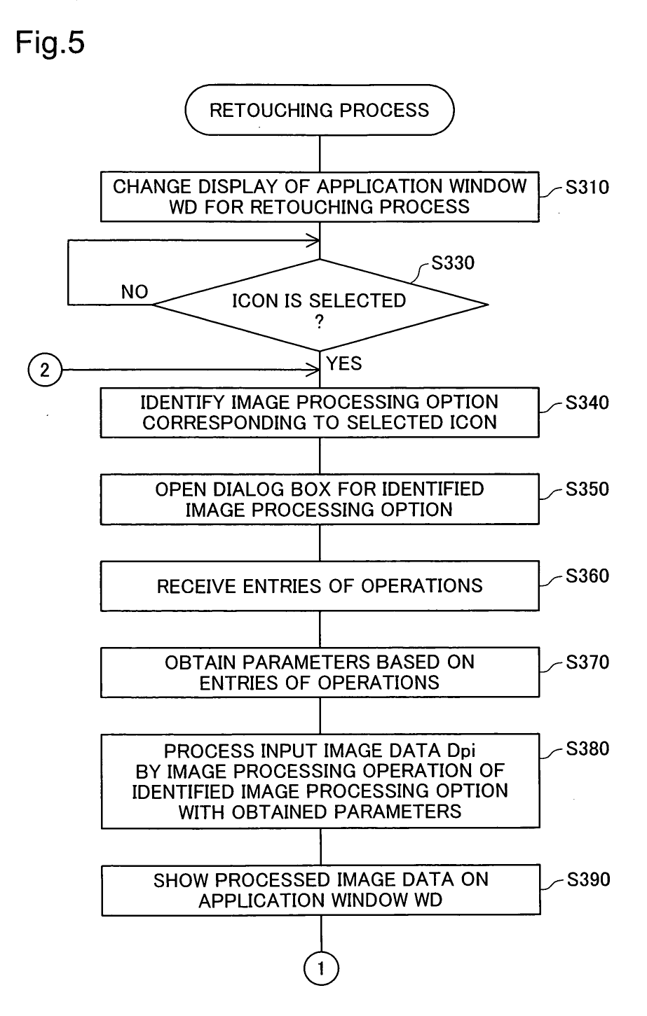

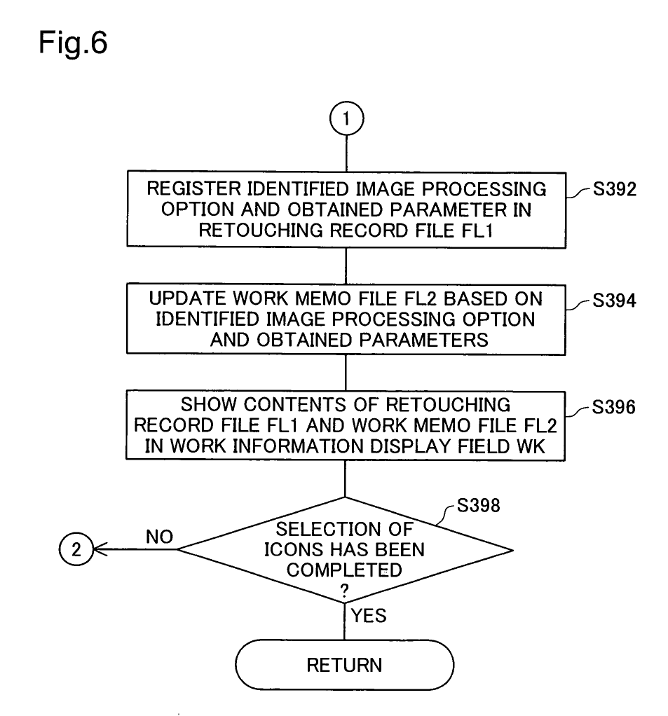

FIGS. 5 and 6 are flowcharts showing the details of the retouching process. The CPU 30 first changes the display of the application window WD for the retouching process on the CRT display 12 (step S310).

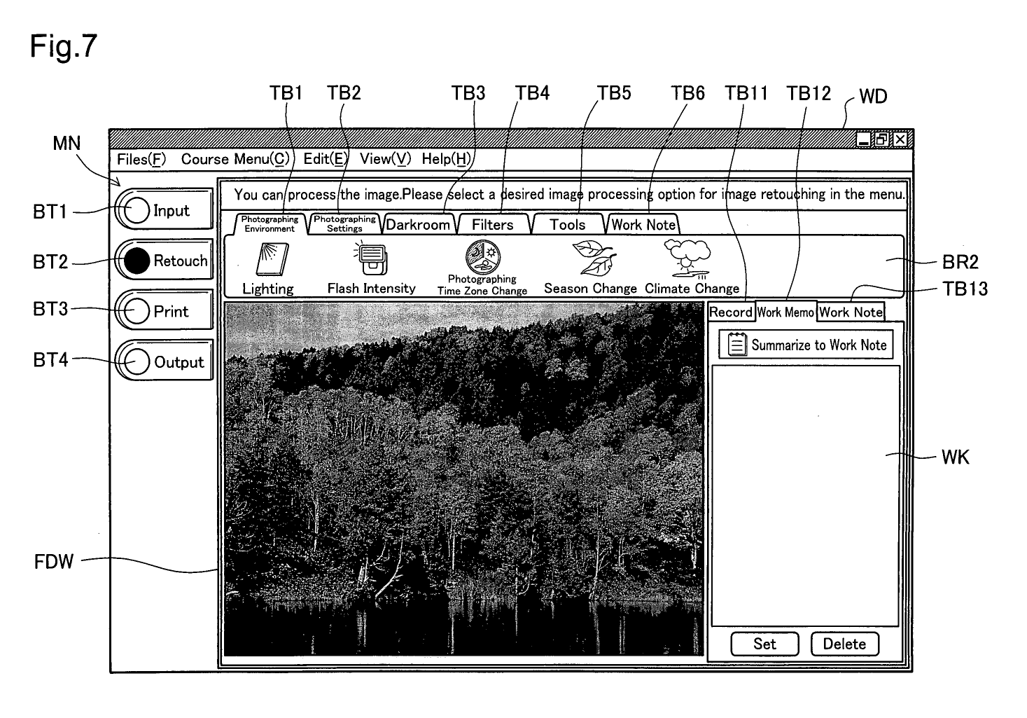

FIG. 7 shows the display of the application window WD for the retouching process. As illustrated, a tool bar BR2 on the application window WD for the retouching process shows multiple icons as start switches of frequently applied image processing options. Multiple group tabs TB1 to TB6 are shown above the tool bar BR2. The 1^{st} to the 5^{th} group tabs TB1 to TB5 respectively correspond to the above retouching functions of the photo retouching software 50, that is, ‘Photographing Environment’, ‘Photographing Settings’, ‘Darkroom’, ‘Filters’, and ‘Tools’. The 6^{th} group tab TB6 corresponds to the functions of ‘Work Note’, which will be described later.

The user clicks a desired group tab among the 1^{st} to the 6^{th} group tabs TB1 to TB6 with the mouse 20 to select a desired functions group among the possible options ‘Photographing Environment’, ‘Photographing Settings’, ‘Darkroom’, ‘Filters’, ‘Tools’, and ‘Work Note’. Each functions group is implemented not by one single cycle of retouching process but by multiple cycles of retouching process. For example, the functions group ‘Photographing Environment’ corresponding to the 1^{st} group tab TB1 include image processing options ‘lighting’, ‘flash intensity’, ‘photographing time zone change’, and ‘climate change’. The functions group ‘Tools’ corresponding to the 5^{th} group tab TB5 include retouching options ‘brightness’, ‘contrast’, ‘color balance’, ‘hue/saturation/intensity’, ‘tone curve’, and ‘histogram’. The user's mouse click of a desired group tab among the 1^{st} to the 6^{th} group tabs TB1 to TB6 selects a corresponding functions group of image processing options.

The tool bar BR2 shows multiple icons as start switches of image processing options included in a selected functions group, in response to the user's click of one of the 1^{st} to the 6^{th} group tabs TB1 to TB6. In the illustrated example of FIG. 7, in response to the user's click of the 1^{st} group tab TB1 corresponding to the functions group ‘Photographing Environment’, the display on the tool bar BR2 includes icons ‘Lighting’, ‘Flash Intensity’, ‘Photographing Time Zone Change’, ‘Season Change’, and ‘Climate Change’. In another example, in response to the user's click of the 5^{th} group tab TB5 corresponding to the functions group ‘Tools’, the display on the tool bar BR2 includes icons ‘Brightness’, ‘Contrast’, ‘Color Balance’, ‘Hue/Saturation/Intensity’, ‘Tone Curve’, and ‘Histogram’.

The user changes the selection among the group tabs TB1 to TB6 to change the display of icons on the tool bar BR2, and clicks one icon with the mouse 20 to select a desired image processing option. Referring back to the flowchart of FIG. 5, at step S330, the CPU 30 receives the user's mouse click and determines whether any icon of an image processing option is selected on the display of the tool bar BR2. The decision of step S330 is repeated until the user selects one icon.

In response to the user's selection of one icon on the display of the tool bar BR2 at step S330, the CPU 30 identifies the image processing option corresponding to the clicked icon at step S340. For example, a click of the ‘Hue/Saturation/Intensity’ icon under the 5^{th} group tab TB5 leads to identification of an image processing option ‘hue/saturation/intensity’.

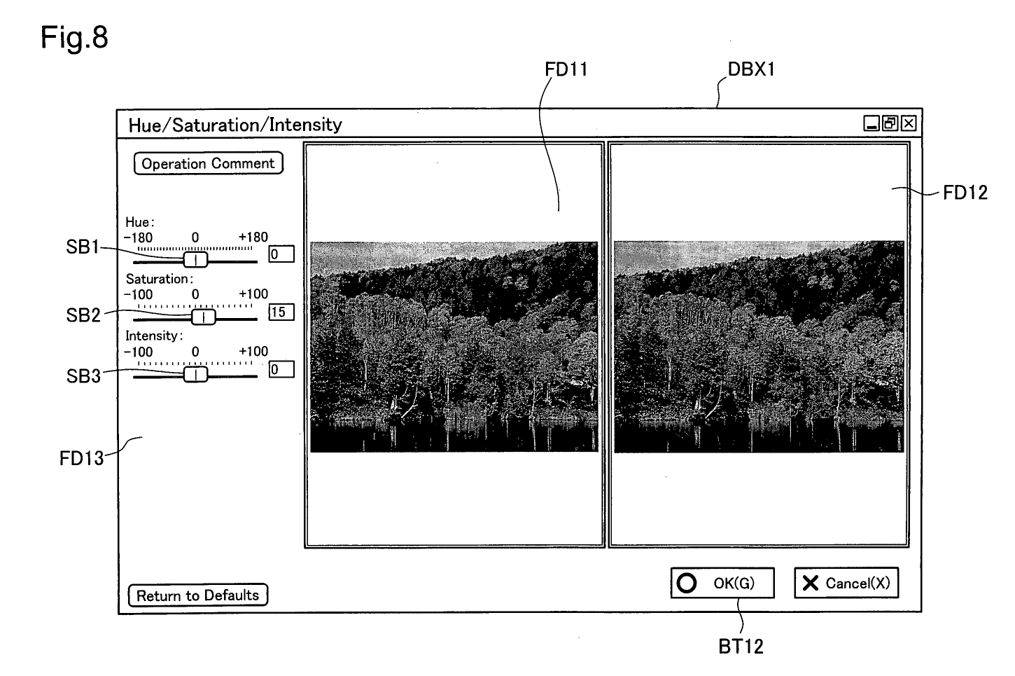

The CPU 30 subsequently opens a dialog box for the image processing option identified at step S340 (step S350). FIG. 8 shows a dialog box DBX1 for the image processing option ‘hue/saturation/intensity’ opened in response to the user's click of the ‘Hue/Saturation/Intensity’ icon. As illustrated, the dialog box DBX1 includes an original image display field FD11, a processed image display field FD12, and an operation field FD13.

The operation field FD13 has slider bars SB1, SB2, and SB3 for regulation of the ‘hue’, the ‘saturation’, and the ‘intensity’. The user manipulates these slider bars SB1 to SB3 to adjust the ‘hue’, the ‘saturation’, and the ‘intensity’ of the input image data Dpi. The display in the processed image display field FD12 reflects the results of adjustment. In response to a click of a button BT12 ‘OK’, the adjusted values on the slider bars SB1 to SB3 are stored as ‘hue/saturation/intensity’ parameters in the RAM 32 at steps S360 and S370.

The processing of steps S350 to S370 gives the ‘hue/saturation/intensity’ parameters in the above example. In a similar manner, each selected image processing option gives relevant parameters. For example, an image processing option ‘CC’ gives ‘hue’ and ‘density’ parameters representing the effects of color change of the photographic image. An image processing option ‘unsharp mask’ gives ‘radius’, ‘intensity’, and ‘threshold’ parameters representing the unsharp mask effects.

The CPU 30 then processes the input image data Dpi by an image processing operation of the selected image processing option identified at step S340 with the parameters obtained at step S370 (step S380). The procedure of image processing stores the settings of the image processing operation as parameters separately from the original image and does not directly change the input image data Dpi. The CPU 130 subsequently shows the processed image data obtained by the image processing operation of step S380 in the work field FDW on the application window WD (step S390) as shown in FIG. 7.

The CPU 30 then proceeds to step S392 in the flowchart of FIG. 6 to register the image processing option identified at step S340 and the parameters obtained at step S370 in a retouching record file FL1.

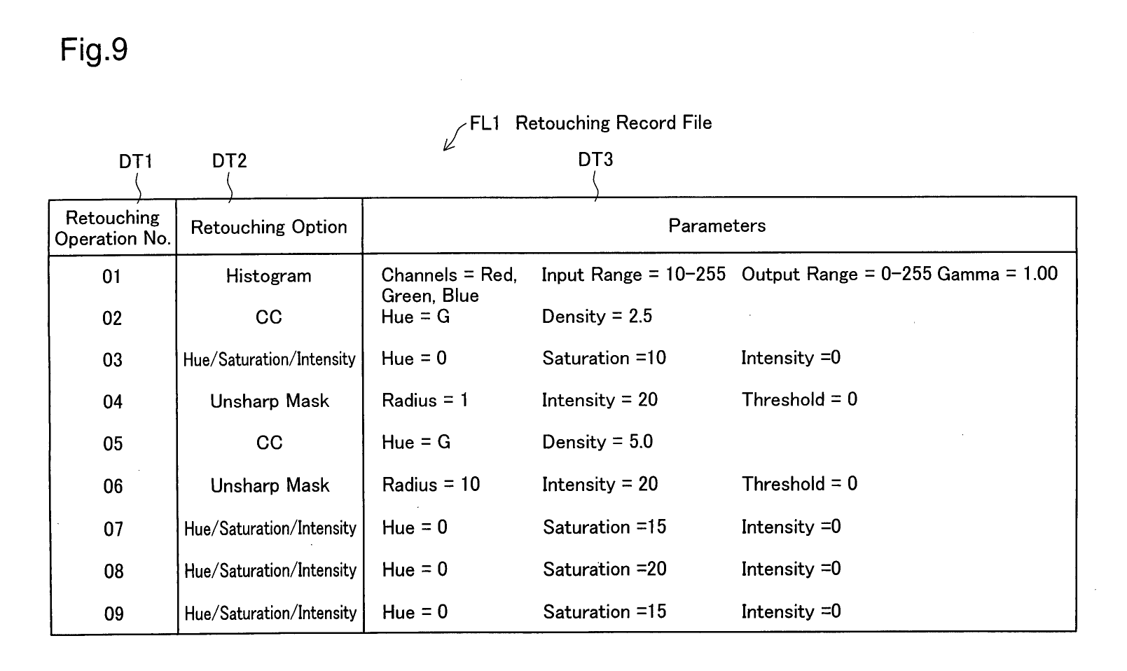

FIG. 9 shows one example of the retouching record file FL1. The retouching record file FL1 has a record of all the image processing operations performed with regard to the image data Dpi input at step S200 to give a current processed image. The retouching record file FL1 includes data DT1 ‘retouching operation No.’, data DT2 ‘retouching option’, and data DT3 ‘parameters’. The data DT1 ‘retouching operation No.’ shows numerals from one in an ascending order to represent the work sequence of image processing operations to be performed. The data DT2 ‘retouching option’ shows the image processing options identified at step S340 as the types of the respective image processing operations. The data DT3 ‘parameters’ shows the parameters of the respective image processing operations obtained at step S370.

In the illustrated example of FIG. 9, the user processed the input image data Dpi by image processing operations in the sequence of ‘histogram’, ‘CC’, ‘hue/saturation/intensity’, ‘unsharp mask’. The resulting processed image did not sufficiently reflect the user's requirements. The user then changed the filter parameters of the image processing option ‘CC’ once, the parameters of the image processing option ‘unsharp mask’ once, and the parameters of the image processing option ‘hue/saturation/intensity’ three times. In this illustrated example, the image processing operation performed at step S380 is the 9^{th} retouching operation applied on the input image data Dpi. Record data representing the results of the 9^{th} retouching operation is registered at step S392. This newly registered record data includes ‘09’ as the ‘retouching operation No.’, ‘hue/saturation/intensity’ as the ‘retouching option’, and ‘hue=0, saturation=15, and intensity=0’ as the ‘parameters’.

Referring back to the flowchart of FIG. 6, at subsequent step S394, the CPU 30 updates a work memo file FL2, based on the image processing option identified at step S340 and the parameters obtained at step S370.

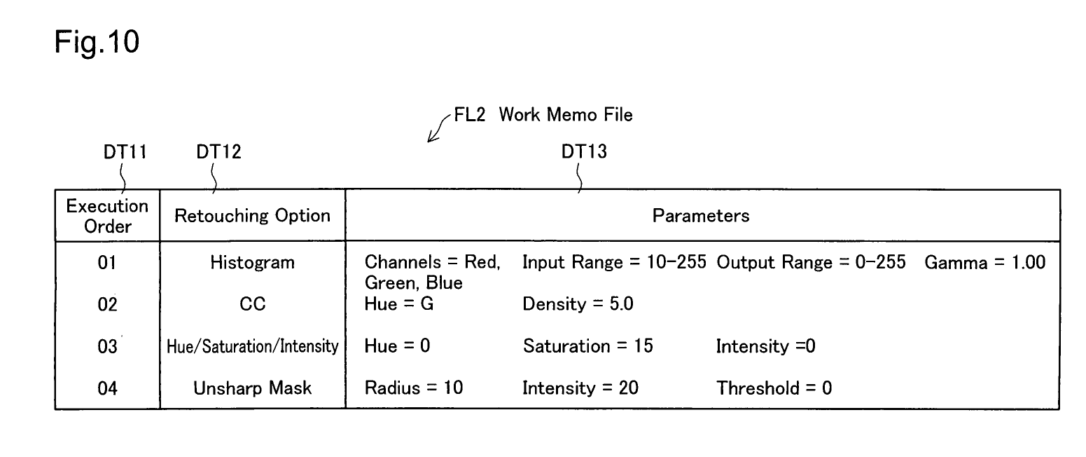

FIG. 10 shows one example of the work memo file FL2. The work memo file FL2 has a record of efficient image processing operations performed with regard to the image data Dpi input at step S200 to give a current processed image. The work memo file FL2 includes data DT11 ‘execution order’, data DT12 ‘retouching option’, and data DT13 ‘parameters’. The ‘efficient’ image processing operations change the parameters of the respective image processing options to efficient settings or more preferably optimum settings (optimization), for conversion of the original image expressed by the input image data Dpi into the current processed image. The concrete procedure of the embodiment for ‘efficiency’ updates the parameters of each image processing option to be performed multiple times to the latest settings, while maintaining the user's specified work sequence of the respective image processing options. This work memo file FL2 is equivalent to the record file of the invention.

The work memo file FL2 of FIG. 10 shows the image processing operations sequentially performed according to the contents of the retouching record file FL1 of FIG. 9. In this illustrated example, as shown in the retouching record file FL1 of FIG. 9, the image processing operations are performed in the sequence of the image processing options ‘histogram’, ‘CC’, ‘hue/saturation/intensity’, and ‘unsharp mask’ . In the work memo file FL2 of FIG. 10, the data DT12 ‘retouching option’ stores the types of the image processing operations in this sequence of ‘histogram’, ‘CC’, ‘hue/saturation/intensity’, and ‘unsharp mask’. As shown in the retouching record file FL1 of FIG. 9, the 5^{th} image processing operation changed the parameters of the image processing option ‘CC’ to ‘hue=G, density=5.0’. These latest settings of the parameters are accordingly stored in the data DT13 ‘parameters’ for the image processing option ‘CC’ in the work memo file FL2 of FIG. 10 (see record data of the execution order ‘02’).

In a similar manner, as shown in the retouching record file FL1 of FIG. 9, the 6^{th} image processing operation changed the parameters of the image processing option ‘unsharp mask’ to ‘radius=10’, intensity=20, threshold=0’. These latest settings of the parameters are accordingly stored in the data DT13 ‘parameters’ for the image processing option ‘unsharp mask’ in the work memo file FL2 of FIG. 10 (see record data of the execution order ‘04’). As shown in the retouching record file FL1 of FIG. 9, the last 9^{th} image processing operation changed the parameters of the image processing option ‘hue/saturation/intensity’ to ‘hue=0, saturation=15, intensity=0’. These latest setting of the parameters are accordingly stored in the data DT13 ‘parameters’ for the image processing option ‘hue/saturation/intensity’ in the work memo file FL2 of FIG. 10 (see record data of the execution order ‘03’). The parameters of the image processing option ‘histogram’ have not been changed from the original settings. The original settings of the parameters ‘channel=blue, green, blue, input range=10-255, output range=0-255, gamma=1.00’ are accordingly stored in the data DT13 ‘parameters’ for the image processing option ‘histogram’ in the work memo file FL2 of FIG. 10 (see record data of the execution order ‘01’).

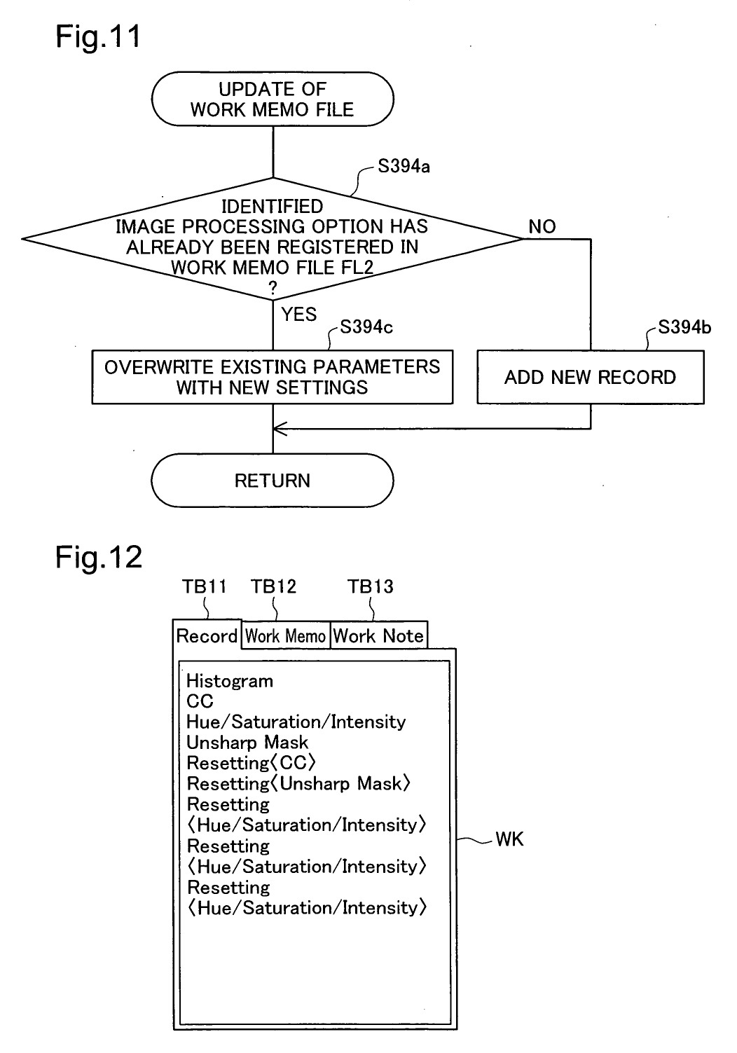

FIG. 11 is a flowchart showing the details of the process of updating the work memo file FL2 at step S394 of the retouching process. In this updating process, the CPU 30 first determines whether the image processing option identified at step S340 has already been registered in the work memo file FL2 (step S394a). When the identified image processing option has not yet been registered in the work memo file FL2, the CPU 30 adds new record data including the image processing option identified at step S340 and the parameters obtained at step S370 to the work memo file FL2 (step S394b). The new record data added to the work memo file FL2 includes registration of a next numeral as one increment of the last numeral in the data DT11 ‘execution order’, registration of the image processing option identified at step S340 in the data DT12 ‘retouching option’, and registration of the parameters obtained at step S370 in the data DT13 ‘parameters’.

When it is determined at step S394a that the identified image processing option has already been registered in the work memo file FL2, the CPU 30 selects an existing record corresponding to the image processing option identified at step S340 and overwrites the contents of the data DT13 ‘parameters’ of the selected record with the parameters newly obtained at step S370 (step S394c). After execution of either step S394b or step S394c, the program goes to ‘Return’ and proceeds to step S396 in the flowchart of FIG. 6.

At step S396, the CPU 30 shows the contents of the retouching record file FL1 registered at step S392 and the contents of the work memo file FL2 updated at step S394 in a work information display field WK on the application window WD. In the illustrated example of FIG. 7, the work information display field WK shows the work memo file FL2 in the null state. As illustrated, the work information display field WK has three tabs TB11 ‘Record’, TB12 ‘Work Memo’, and TB13 ‘Work Note’. A selection of one of the tabs TB11 to TB13 changes over the display in the work information display field WK.

FIG. 12 shows the display of the work information display field WK corresponding to the contents of the retouching record file FL1 of FIG. 9. In the illustrated state, the tab TB11 ‘Record’ is selected. The contents of the data DT2 ‘retouching option’ included in the retouching record file FL1 are displayed vertically in the order of the data DT1 ‘retouching operation No.’ in the work information display field WK. The second or the subsequent appearance of an identical image processing option is discriminated by the additional indication ‘Resetting’.

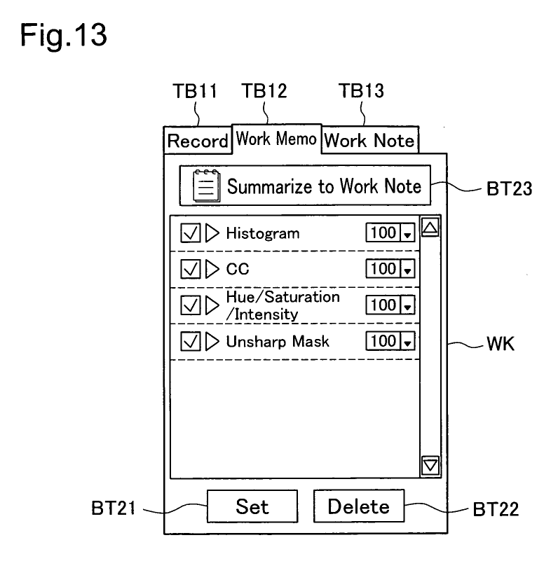

FIG. 13 shows the display of the work information display field WK corresponding to the contents of the work memo file FL2 of FIG. 10. In the illustrated state, the tab TB12 ‘Work Memo’ is selected. The contents of the data DT12 ‘retouching option’ included in the work memo file FL2 are displayed vertically in the order of the data DT11 ‘execution order’ in the work information display field WK.

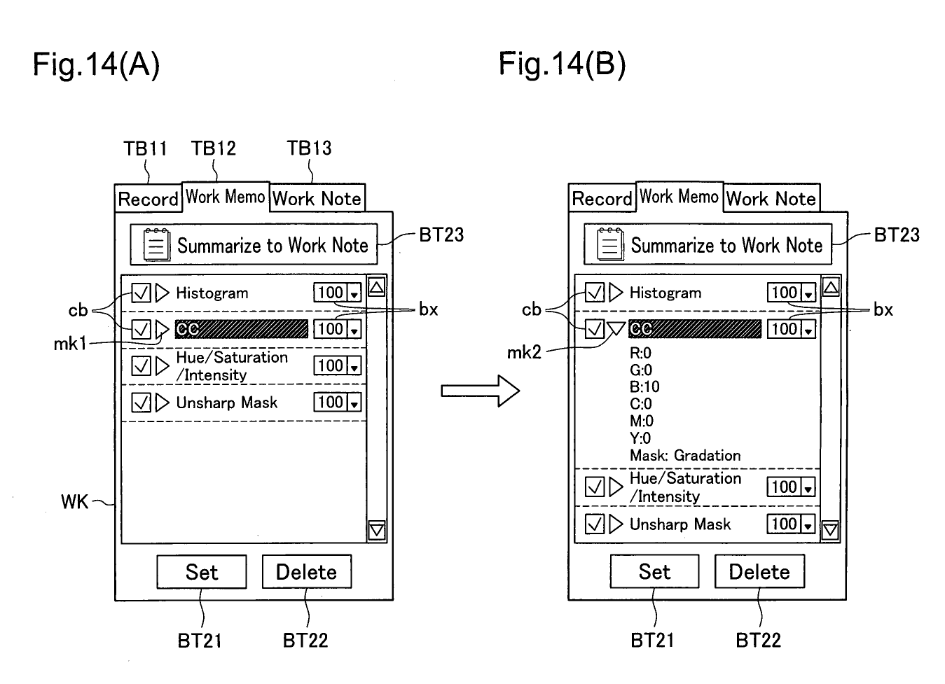

A click of a selected image processing option in the display on the work information display field WK with the mouse 20 (a click of an image processing option ‘CC’ in the illustrated example of FIG. 14(A)) and a subsequent click of a corresponding right arrow mk1 open the detailed settings of the parameters of the clicked image processing option as shown in FIG. 14(B). A click of a down arrow mk2 closes the display of the detailed settings of the parameters.

Checkboxes cb are provided on the left of the respective image processing options shown in the work information display field WK. Removal of the tick from a selected checkbox cb inactivates a corresponding image processing option for further retouching of the input image data Dpi. The temporary inactivation of the selected image processing option enables the user to check the effects of the image processing options on a resulting image.

A reflection factor (%) of each image processing option is adjustable as an intensity of retouching effect. The user may directly enter a desired numeral in a box bx on the right of each image processing option or may otherwise click a reverse triangle and shift a non-illustrated slider bar to specify the reflection factor in a range of 0 to 100%. The reflection factor of 100% means full reflection of the result of the image processing operation. A decrease in reflection factor reduces the reflection of the result of the image processing operation. The reflection factor of 0% means no reflection of the result of the image processing operation.

A button BT21 ‘Set’ and a button BT22 ‘Delete’ are also provided on the bottom of the work information display field WK. The user clicks a selected image processing option in the display on the work information display field WK and the button BT21 ‘Set’ with the mouse 20 to open a dialog box for entry of the detailed settings of the clicked image processing option. For example, the user's click of the selected icon ‘Hue/Saturation/Intensity’ opens the dialog box DBX1 as shown in FIG. 8. The current settings are displayed in parameter input boxes of the dialog box DBX1. In the illustrated example of FIG. 8, the slider bars SB1 to SB3 indicate the current settings of ‘hue=0, saturation=15, intensity=0’ in the parameter input boxes. The user may change the current settings of the parameters of the selected image processing option on the display of the dialog box DBX1.

This arrangement enables the user to readily change the current settings of the parameters of the selected image processing option and performs a required series of image processing of the input image data with the changed settings of the parameters.

The user clicks a selected image processing option in the display on the work information display field WK and the button BT22 ‘Delete’ with the mouse 20 to delete the clicked image processing option.

The display of the work information display field WK under the selection of the tab TB12 ‘Work Memo’ has a top button BT23 ‘Summarize to Work Note’. The contents of the work memory file FL2 represent the ‘procedure of completing a desired processed image’. Storage of the contents of the work memo file FL2 as a work note file allows for later application of the same procedure. The user clicks the button BT23 with the mouse 20 to store the contents of the work memo file FL2 displayed in the work information display field WK into the HDD 42 as a work note file. The user's click of the button BT23 with the mouse 20 opens a non-illustrated dialog box. The user enters the ‘file name’ and the ‘title’ in the dialog box. The contents of the work memory file FL2 with the entered ‘title’ are stored as a work note file under the entered ‘file name’ in the HDD 42.

The non-volatile memory of the HDD 42 maintains the storage of the contents of the work memo file FL2 in the form of the work note file even in a power-off state of the computer system 10. The effective and efficient settings of image retouching for certain input image data can thus be applicable to retouching of any other image data.

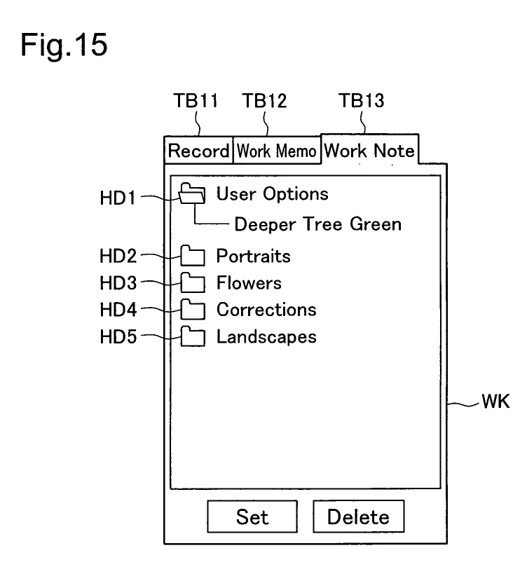

FIG. 15 shows the display of the work information display field WK under the selection of the tab TB13 ‘Work Note’. In this illustrated example, there are five folders HD1 to HD5 ‘User Options’ ‘Portraits’, ‘Flowers’, ‘Corrections’, and ‘Landscapes’. Each of the five folders HD1 to HD5 has storage of multiple work note files. For example, the ‘Landscapes’ folder HD5 has storage of seven work note files under the titles of ‘Sharper Distant View’, ‘Deeper Blue Sea’, ‘Brighter Autumn Tint’, ‘Clearer Sky Blue’, ‘Favorite Snowy Scenery’, ‘Night Scene’, and ‘More Impressive Sunset’. The work note files included in the four folders HD2 to HD5 ‘Portraits’, ‘Flowers’, ‘Corrections’, and ‘landscapes’ other than the folder HD1 ‘User Options’ are set as defaults by the software.

The folder HD1 ‘User Options’ is used to store the work note files. The user clicks the button BT23 ‘Summarize to Work Note’ to store a desired work note file in the folder HD1 ‘User Options’ provided in the HDD 42. In the illustrated example of FIG. 15, a work note file under the title of ‘Deeper Tree Green’ entered in the dialog box is registered in the folder HD1 ‘User Options’, in response to the user's click of the button BT23 ‘Summarize to Work Note’.

New work note files may be imported from an external device, for example, from the manufacturer of the photo retouch software, via the network into the folders HD2 to HD5 ‘Portraits’, ‘Flowers’, ‘Corrections’, and ‘Landscapes’. The work note files created by the user and stored in the folder HD1 ‘User Options’ may be exported to an external device via the network.

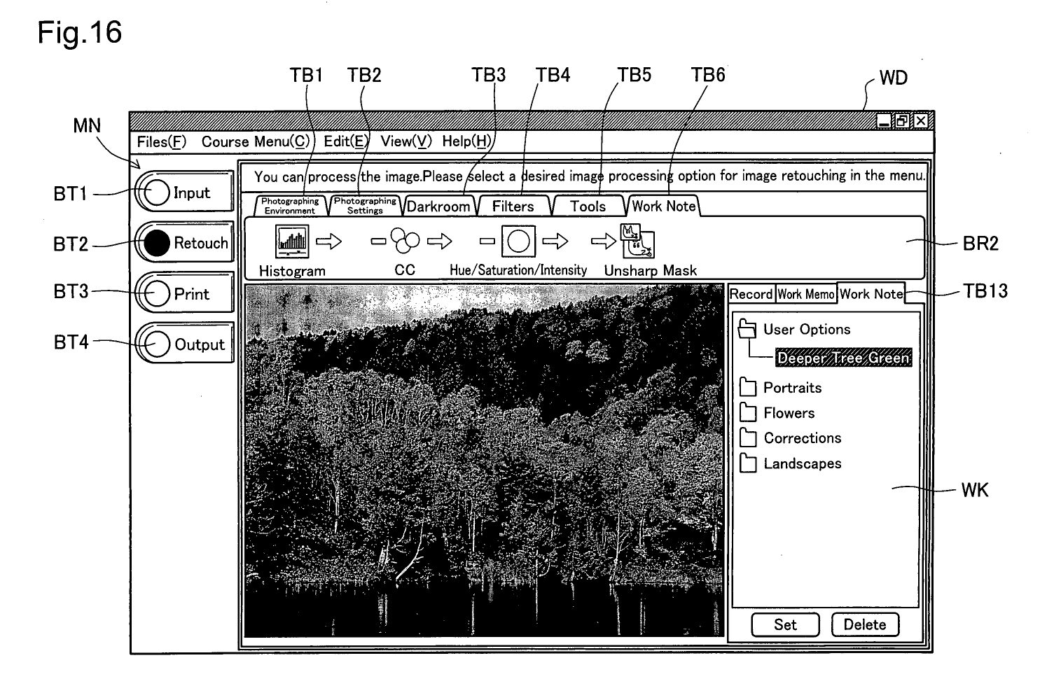

FIG. 16 shows the display of the application window WD for the retouching process in response to selection of the group tab TB6 ‘Work Note’ on the tool bar BR2. As described above, each selection of the tabs TB1 to TB6 changes the display of icons of image processing operations on the tool bar BR2. Under the selection of the tab TB6 ‘Work Note’, the display of icons on the tool bar BR2 depends on a selected work note file in the work information display field WK. In the illustrated example of FIG. 16, the work note file under the user's entered title of ‘Deeper Tree Green’ is selected. The tool bar BR2 under the selection of the tab TB6 ‘Work Note’ has the display of icons ‘Histogram’, ‘CC (Color)’, ‘Hue/Saturation/Intensity’, and ‘Unsharp Mask’ arranged horizontally from the left to the right.

The registration of the selected work note file with the title ‘Deeper Tree Green’ specifies the displayed icons ‘Histogram’ to ‘Unsharp Mask’. The work note file with the title ‘Deeper Tree Green’ is equivalent to the contents of the work memo file FL2 with the user's entered-title and accordingly has the registered details of the image processing operations shown in FIG. 10. According to the registered details of the image processing operations, the icons ‘Histogram’, ‘CC (Color)’, ‘Hue/Saturation/Intensity’, and ‘Unsharp Mask’ are selected and arranged in this order.

Namely the arrangement of icons displayed on the tool bar BR2 is based on the work note file selected in the display of the work information display field WK under the selection of the tab TB13 ‘Work Note’. The work note file represents the operating procedure of image processing. The details of the multiple image processing operations registered in the work note file thus specify the selection and the arrangement of the icons.

When the user selects the title of a desired work note file in the work information display field WK under the selection of the tab TB13 ‘Work Note’, a required series of image processing operations to obtain an object processed image are presented on the tool bar BR2. The user successively clicks the icons on the tool bar BR2 to sequentially perform the required series of image processing operations. The user's click of each icon opens a dialog box for entry of the settings of relevant parameters as described above with reference to FIG. 8. The current settings are shown in the parameter input boxes of the dialog box. For example, in the dialog box for the entry of ‘hue/saturation/intensity’ shown in FIG. 8, the slider bars SB1 to SB3 indicate the current settings of ‘hue=0, saturation=15, intensity=0’ in the parameter input boxes. The user clicks the button BT12 ‘OK’ without any change of the current settings in the parameter input boxes to execute the image processing operation according to the registration of the work note file. The user may regulate the settings in the parameter input boxes of the dialog box according to the requirements.

The image data newly input by the input module 51 then goes through the series of multiple image processing options registered in the selected work note file.

Referring back to the flowchart of FIG. 6, after execution of step S396, the CPU 30 determines whether the user's selection of the icons displayed on the tool bar BR2 has been completed (step S398). When the user enters a command other than selection of any of the icons on the tool bar BR2, the retouching flow gives an affirmative answer at step S398 and goes to ‘Return’. When it is determined at step S398 that the user's selection of the icons has not yet been completed, on the other hand, the retouching flow returns to step S340 in FIG. 5 to execute a next image processing operation corresponding to a newly selected icon.

The processing of steps S340 to S370, the arrangement of the icons on the tool bar BR2, and the dialog box DBX1 for the entry of each identified image processing option correspond to the functions of the image processing setting module 52a. The processing of step S380 corresponds to the functions of the image processing module 52b, and the processing of step S394 corresponds to the functions of the image processing recording module 52c.

C. Functions and Effects

As described above, the computer system of the first embodiment updates the work memo file FL2 representing a record of efficient image processing operations performed to generate retouched image data from input image data Dpi, based on latest selections and settings of image processing options and their related parameters. The user refers to the work memo file FL2 and readily studies the record of efficient image processing operations performed to generate retouched image data from input image data Dpi for application to retouching of other image data. This arrangement effectively shortens the total processing time to retouch newly input image data Dpi and improves the operation efficiency.

Each work memo file FL2 has a record of selected image processing options arranged in an execution sequence and final settings of relevant parameters with regard to input image data Dpi. The user can thus readily refer to the details of the efficient image processing operations performed with regard to the input image data Dpi.

1-2. Modifications

The arrangement of the first embodiment may be modified in various ways. Some examples of possible modification are given below.

(1) In the description of the embodiment, the input image data Dpi as the object of image processing is taken with the digital camera. The procedure of the embodiment is also applicable to image data of silver salt photos and color gravure pictures read by a color scanner or another equivalent means. Object image data to be processed may otherwise be read from the storage in a storage unit, for example the HDD 42 or read from an external device via the network. The object image data are not restricted to color image data but may be monochromatic color image data.

(2) The work note file including the contents of the work memo file FL2 is stored in the HDD 42 in the structure of the embodiment, but may be stored in another non-volatile memory separate from the computer body 16, for example, in a server on the computer network.

(3) In the structure of the embodiment, the activation switches of respective image processing options are displayed in the form of icons on the tool bar BR2. The activation switches may alternatively be given in the form of a pull-down menu.

(4) In the structure of the embodiment, the work memo file FL2 includes the data DT11 ‘execution order’, the data DT12 ‘retouching option’, and the data DT13 ‘parameters’. The work memo file FL2 may include comment data representing the user's comments with regard to the respective image processing options, in addition to the data DT11, DT12, and DT13. Another possible modification may omit the data DT11 ‘execution order’ and show the execution order by the sequence of the remaining data ‘retouching option’ and ‘parameters’.

2-1. Second Embodiment

A second embodiment of the invention is described below.

A. System Configuration

The computer system of the second embodiment has the identical hardware configuration with that of the computer system of the first embodiment shown in FIG. 1. The like elements to those of the first embodiment are expressed by the like numerals.

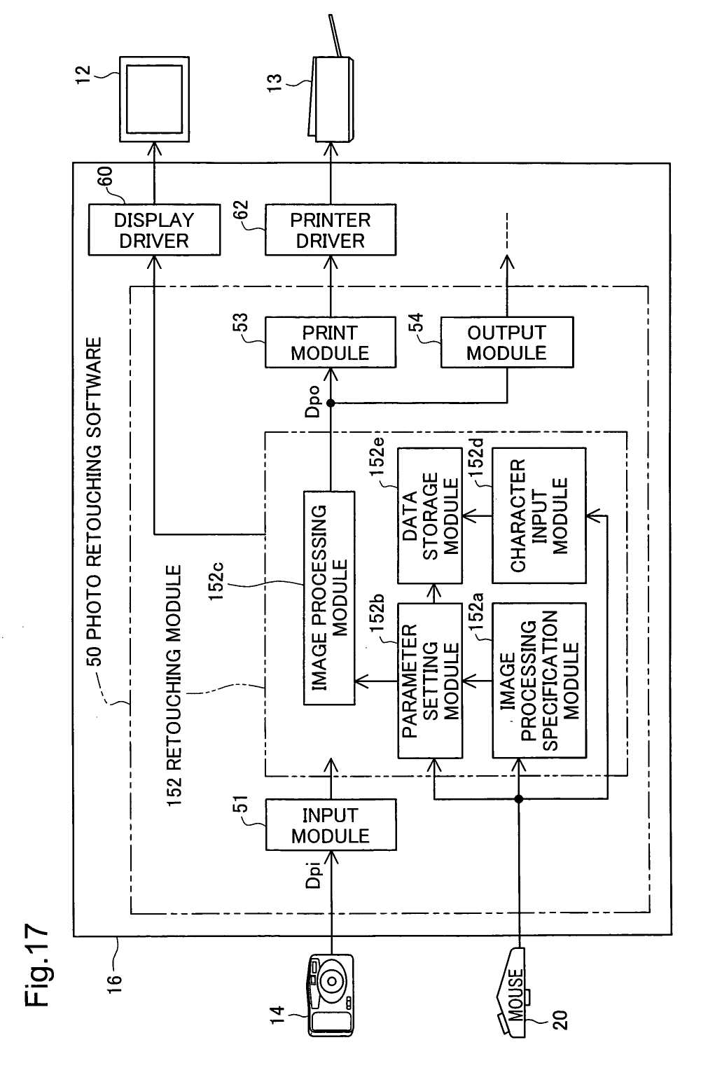

The second embodiment has partly different software configuration from that of the first embodiment. FIG. 17 is a block diagram showing a control flow according to the photo retouching software 50 executed by the computer body 16 in the second embodiment. The control flow in the photo retouching software 50 of the second embodiment is similar to that of the first embodiment shown in FIG. 2, except the constituents of a retouching module 152.

The retouching module 152 of the second embodiment includes an image processing specification module 152a, a parameter setting module 152b, an image processing module 152c, a character input module 152d, and a data storage module 152e. The functions of these modules 152a through 152e specify the optimum operating procedure of image processing and actually perform the specified series of image processing operations for image retouching. This arrangement is the main characteristics of the invention and will be described in detail later.

B. Computer Processing

B-1. General Processing Flow

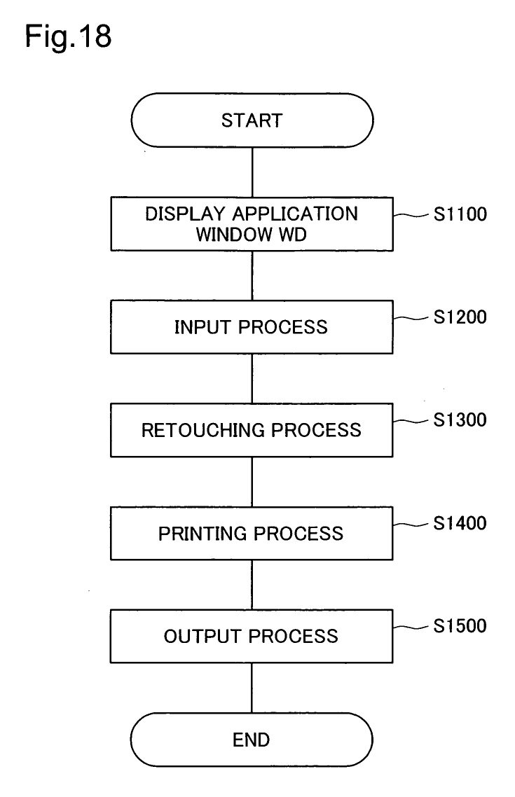

The CPU 30 of the computer body 16 executes the photo retouching software 50 to attain the functions of the input module 51, the retouching module 152, the print module 53, and the output module 54. The series of control according to the photo retouching software 50 is described in detail. FIG. 18 is a flowchart showing a control routine, which is triggered by a start instruction of the photo retouching software 50.

This control routine of this embodiment is similar to the control routine of the first embodiment shown in the flowchart of FIG. 3. The processing of step S1100 to open an application window WD on the CRT display 12 is identical with the processing of step S100 in FIG. 3. The input process of step S1200, the printing process of step S1400, and the output process of step S1500 are respectively identical with the input process of step S200, the printing process of step S400, and the output process of step S500 in FIG. 3.

Like the retouching process of step S300 in FIG. 3, the retouching process executed at step S1300 retouches the input image data Dpi through a series of image processing and adopts the ‘retouching parameter system’ for image processing. The retouching process is the main characteristics of this embodiment and corresponds to the functions of the retouching module 152 (FIG. 17). The details of the retouching process are described below.

B-2. Retouching Process

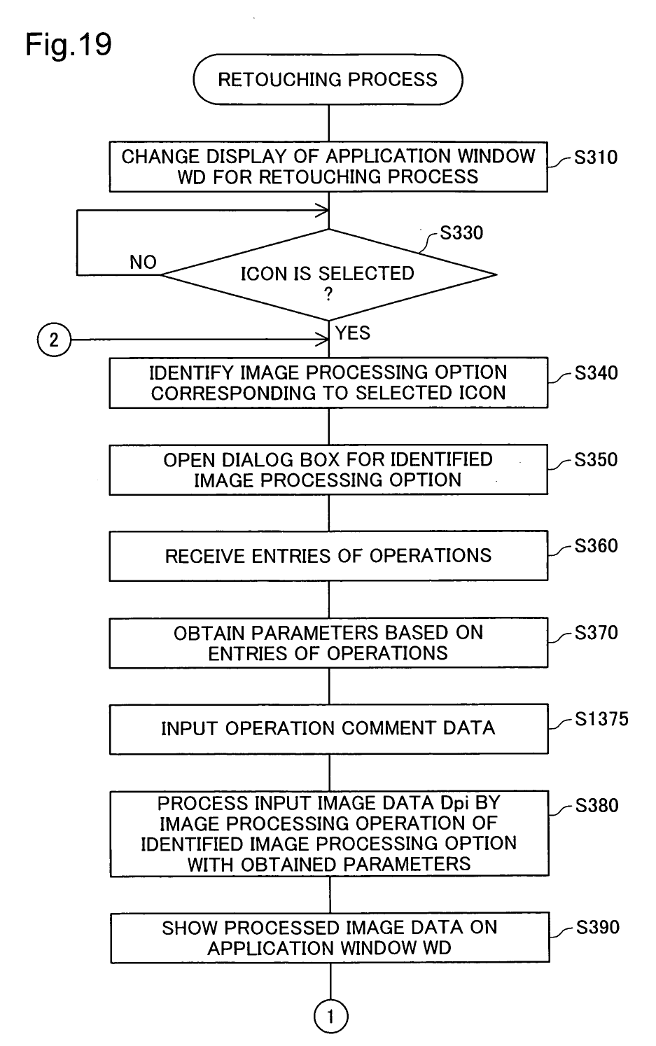

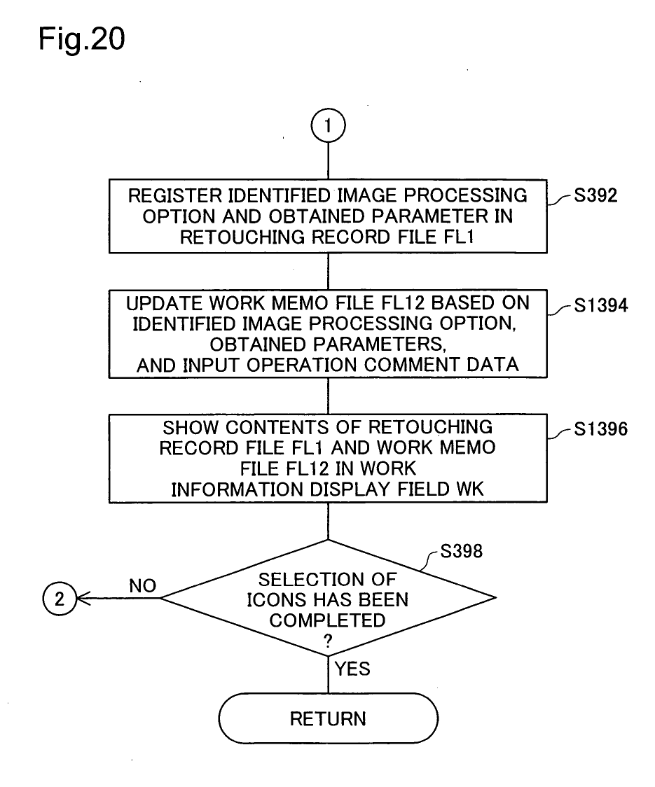

FIGS. 19 and 20 are flowcharts showing the details of the retouching process executed at step S1300. The differences between this retouching process routine and the retouching process routine of the first embodiment shown in FIGS. 5 and 6 are insertion of step S1375 between steps S370 and S380 and replacement of steps S394 and S396 with step S1394 and S1396. The other steps S310 to S370 and S380 to S392 in the retouching process routine of the second embodiment are identical with the corresponding steps of the first embodiment.

The dialog box DBX1 for the identified image processing option ‘hue/saturation/intensity’ is opened at step S350 as described in the first embodiment with reference to FIG. 8. The dialog box DBX1 has a button BT13 ‘Operation Comment’, although not being specifically mentioned in the first embodiment. The user's click of the button BT13 ‘Operation Comment’ with the mouse 20 opens a dialog box DBX2 for entry of operation comments.

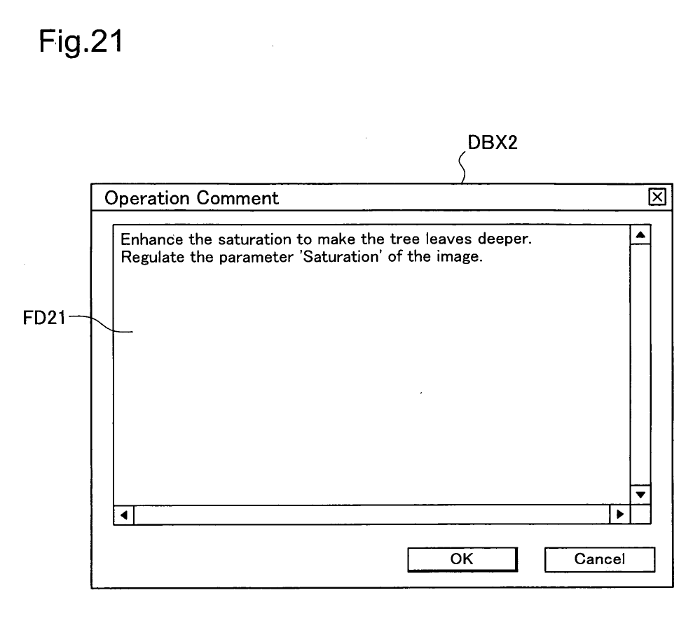

FIG. 21 shows the dialog box DBX2 for entry of operation comments. The dialog box DBX2 includes an input field FD21 for entry of text characters. The user manipulates the keyboard 18 to enter comments for parameter setting in the input field FD21 of the dialog box DBX2. The entered text characters are stored as operation comment data into the RAM 32 at step S1375 in the flowchart of FIG. 19.

The processing of steps S350 to S1375 gives the ‘hue/saturation/intensity’ parameters in the above example. In a similar manner, each selected image processing option gives relevant parameters. For example, the image processing option ‘CC’ gives ‘hue’ and ‘density’ parameters representing the effects of color change of the photographic image. The image processing option ‘unsharp mask’ gives ‘radius’, ‘intensity’, and ‘threshold’ parameters representing the unsharp mask effects. Similarly operation comment data given as the user's comments for parameter setting are input at step S1375 with regard to each selected image processing option as well as the image processing option ‘hue/saturation/intensity’.

The processing flow goes to step S1394 after execution of step S392 in the flowchart of FIG. 20. At step S1394, the CPU 30 updates a work memo file FL12, based on the image processing option identified at step S340, the parameters obtained at step S370, and the operation comment data input at step S1375.

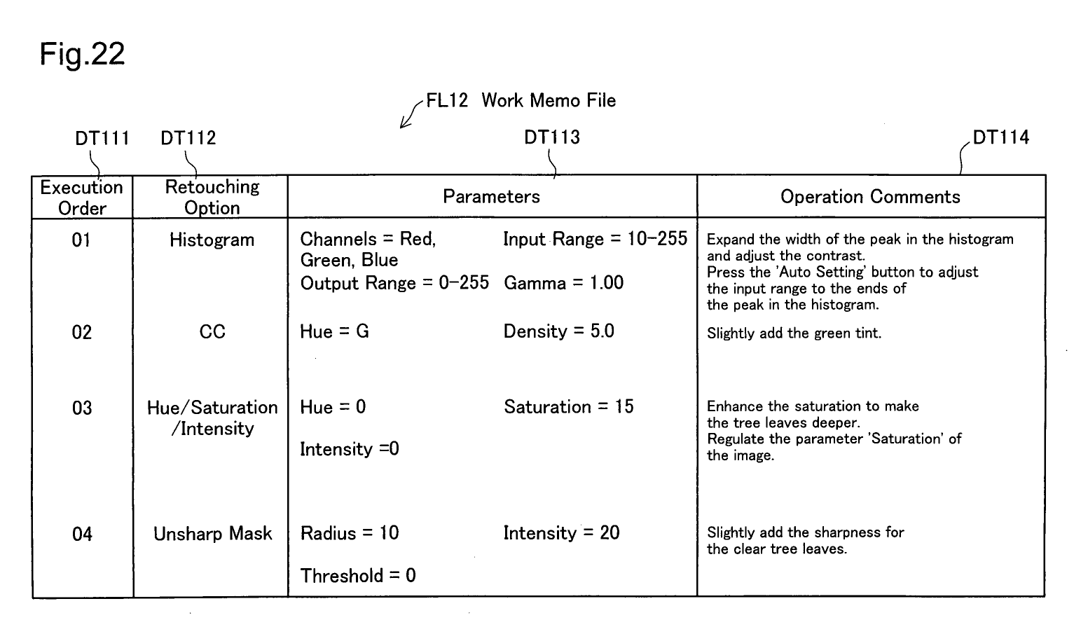

FIG. 22 shows one example of the work memo file FL12. As illustrated, the work memo file FL12 includes data DT111 ‘execution order’, data DT112 ‘retouching option’, data DT113 ‘parameters’, and DT114 ‘operation comments’. The data DT111 ‘execution order’, the data DT112 ‘retouching option’, and the data DT113 ‘parameters’ are identical with the data DT11 ‘execution order’, the data DT12 ‘retouching option’, and the data DT13 ‘parameters’ included in the work memo file FL12 of the first embodiment (see FIG. 10). The data DT114 ‘operation comments’ is characteristic of this embodiment.

The operation comment data input at step S1375 is registered in the data DT114 ‘operation comments’. In the illustrated example of FIG. 21, the user enters operation comments ‘Enhance the saturation to make the tree leaves deeper. Regulate the parameter ‘Saturation’ of the image’ in the input field FD21 of the dialog box DBX2 for entry of operation comments with regard to the image processing option ‘hue/saturation/intensity’. These operation comments are registered in the data DT114 ‘operation comments’ with regard to the image processing option ‘hue/saturation/intensity’ (see record data of the execution order ‘03’) shown in FIG. 22.

The contents of the data DT114 ‘operation comments’ are related to the settings of the data DT113 ‘parameters’. The operation comment data is entered with a click of the button BT13 ‘Operation Comment’ in the process of changing the current settings of the parameters of an image processing option and is registered in the data DT114 ‘operation comments’.

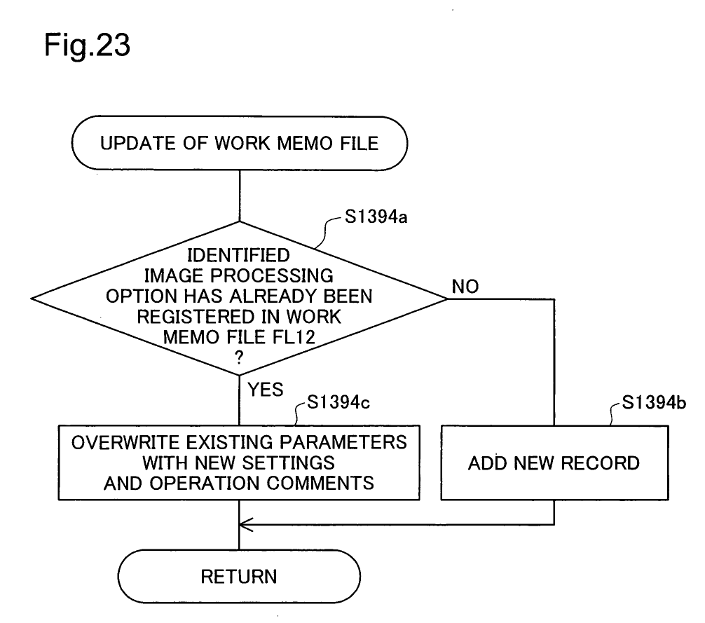

FIG. 23 is a flowchart showing the details of the process of updating the work memo file FL12 at step S1394 of the retouching process. In this updating process, the CPU 30 first determines whether the image processing option identified at step S340 has already been registered in the work memo file FL12 (step S1394a). When the identified image processing option has not yet been registered in the work memo file FL12, the CPU 30 adds new record data including the image processing option identified at step S340, the parameters obtained at step S370, and the operation comments input at step S1375 to the work memo file FL12 (step S1394b). The new record data added to the work memo file FL12 includes registration of a next numeral as one increment of the last numeral in the data DT111 ‘execution order’, registration of the image processing option identified at step S340 in the data DT112 ‘retouching option’, registration of the parameters obtained at step S370 in the data DT113 ‘parameters’, and registration of the operation comments input at step S1375 in the data DT114 ‘operation comments’.

When it is determined at step S1394a that the identified image processing option has already been registered in the work memo file FL12, the CPU 30 selects an existing record corresponding to the image processing option identified at step S340 and overwrites the contents of the data DT113 ‘parameters’ of the selected record with the parameters newly obtained at step S370 and the operation comments entered at step S1375 (step S1394c). After execution of either step S1394b or step S1394c, the program goes to ‘Return’ and proceeds to step S1396 in the flowchart of FIG. 20.

At step S1396, the CPU 30 shows the contents of the retouching record file FL1 registered at step S392 and the contents of the work memo file FL12 updated at step S1394 in a work information display field WK on the application window WD. The work information display field WK of this embodiment is identical with that of the first embodiment, so that the displays of the work information display field WK of the first embodiment shown in FIGS. 12 to 15 are also applicable to the second embodiment.

As shown in FIG. 13, the button BT23 ‘Summarize to Work Note’ is located on the top of the work information display field WK under the selection of the tab TB11 ‘Work Memo’. The following describes the series of processing executed in response to the user's click of this button BT23 with the mouse 23.

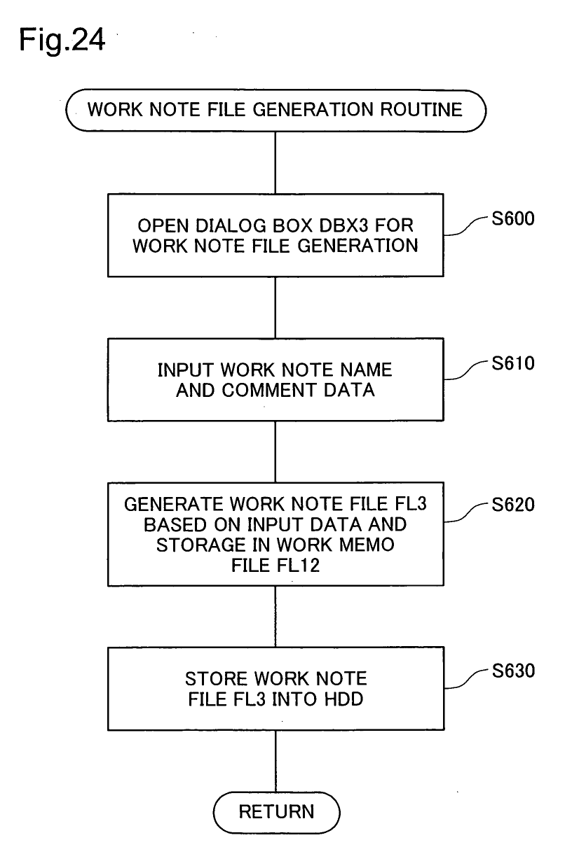

FIG. 24 is a flowchart showing a work note file generation routine executed in an interrupted manner by the CPU 30 in response to the user's click of the button BT23 ‘Summarize to Work Note’. The CPU 30 first opens a dialog box DBX3 for work note file generation on the CRT display 12 (step S600).

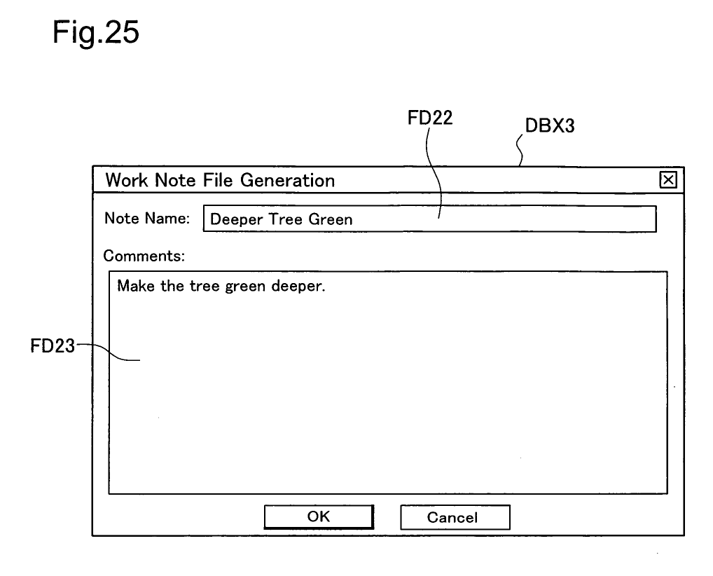

FIG. 25 shows the dialog box DBX3 for work note file generation. The dialog box DBX3 includes a ‘Note Name’ input field FD22 and a ‘Comment’ input field FD23. The user manipulates the keyboard 18 to enter the title of a work note in the ‘Note Name’ input field FD22 and object of the work note (comment) in the ‘Comment’ input field FD23.

The CPU 30 inputs the data ‘note name’ and ‘comment’ entered in the dialog box DBX3 for work note file generation (step S610), and generates a work note file FL3 based on the input data and the data stored in the work memo file FL12 (step S620). The storage in the work memo file FL12 is equivalent to the display in the work information display field WK with the button BT23 ‘Summarize to Work Note’ under the selection of the tab TB12 ‘Work Memo’.

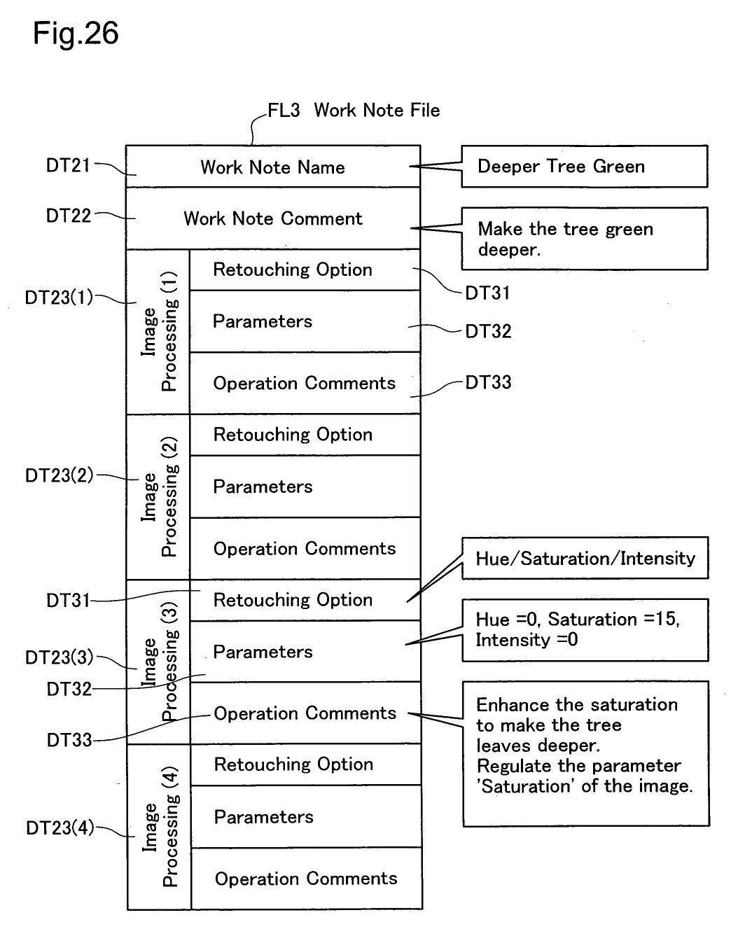

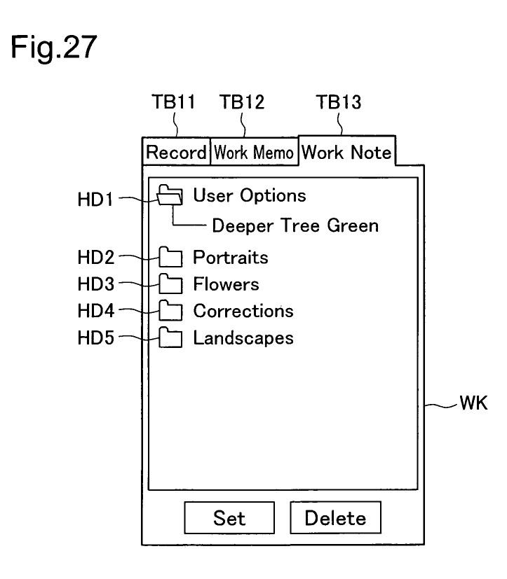

FIG. 26 shows one example of the work note file FL3. The work note file FL3 includes data DT21 ‘work note name’, data DT22 ‘work note comment’, and n sets of ‘image processing’ data DT23(1) to DT23(n), where n represents a positive number and is equal to 4 in the illustrated example.

The data DT21 ‘work note name’ and the data DT22 ‘work note comment’ respectively store the data ‘note name’ and ‘comment’ entered in the dialog box DBX3 for work note file generation. In the dialog box DBX3 of FIG. 25, the entered ‘note name’ and ‘comment’ are ‘Deeper Tree Green’ and ‘Make the tree green deeper’. The data DT21 ‘work note name’ and the data DT22 ‘work note comment’ accordingly store the ‘Deeper Tree Green’ and ‘Make the tree green deeper’ as shown in FIG. 26.

Each set of the ‘image processing’ data DT23(1) to DT23(n) corresponds to one retouching process. The n sets of the ‘image processing’ data DT23(1) to DT23(n) store the contents of the corresponding records of the work memo file FL12 in the sequence of the data. DT111 ‘execution order’. Each set of the ‘image processing’ data DT23(1) to DT23(n) includes sub-data DT31 ‘retouching option’, sub-data DT32 ‘parameters’, and sub-data DT33 ‘operation comments’. The data DT112 ‘retouching option’, the data DT113 ‘parameters’, and the DT114 ‘operation comments’ of the work memo file FL12 are respectively transferred to the sub-data DT31 ‘retouching option’, the sub-data DT32 ‘parameters’, and the sub-data DT33 ‘operation comments’.

The work note file FL3 of FIG. 26 has the contents of the work memo file FL12 shown in FIG. 22. As shown in FIG. 26, the sub-data DT31 to DT33 included in the 3^{rd} ‘image processing’ data DT23(3) respectively have the transferred data DT112 to DT114 ‘hue/saturation/intensity’, ‘hue=0, saturation=15, intensity=0’, and ‘Enhance the saturation to make the tree leaves deeper. Regulate the parameter ‘Saturation’ of the image.’ with regard to the image processing operation of the data DT111 ‘execution order=03’ in the work memo file FL12 of FIG. 22.

Referring back to the flowchart of FIG. 24, the work note file FL3 generated at step S620 is stored in the HDD 42 (step S630). The non-volatile memory of the HDD 42 maintains the storage of the contents of the work memo file FL12 in the form of the work note file even in a power-off state of the computer system 10. The effective and efficient settings of image retouching for certain input image data can thus be applicable to retouching of any other image data.

After execution of step S630, the work note generation routine goes to ‘Return’ and is terminated.

The display of the work information display field WK under the selection of the tab TB13 ‘Work Note’ is identical with that of the first embodiment shown in FIG. 15. In the illustrated example of FIG. 15, a work note file having the ‘note name’ of ‘Deeper Tree Green’ entered in the dialog box DBX3 for work note file generation is registered in the folder HD1 ‘User Options’.

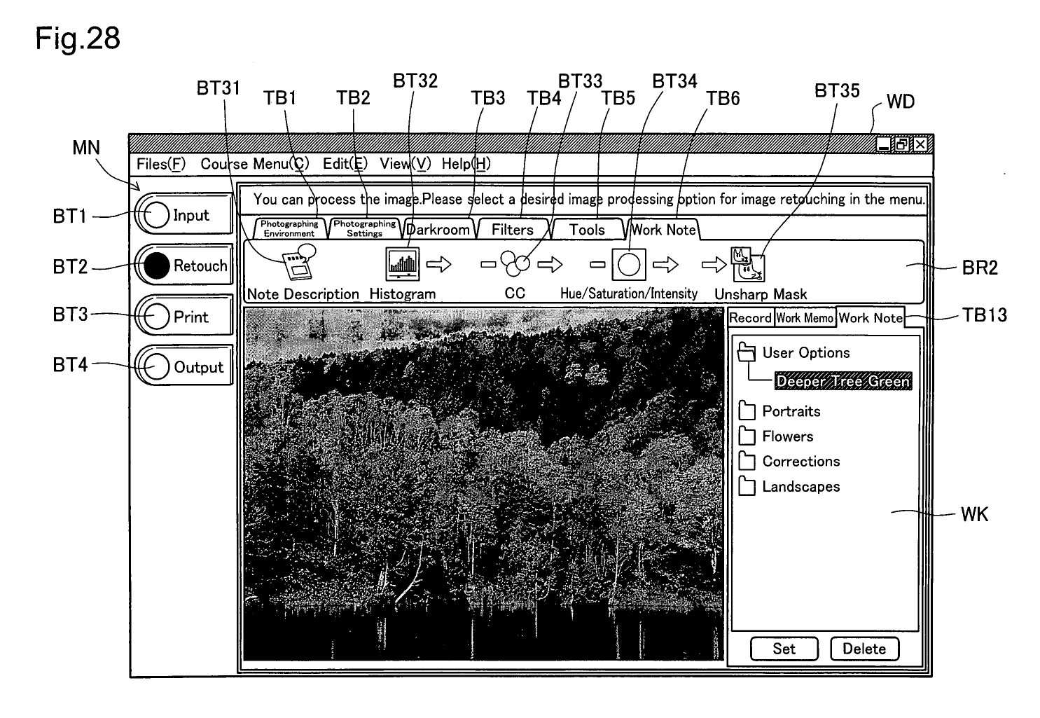

FIG. 28 shows the display of the application window WD for the retouching process in response to selection of the group tab TB6 ‘Work Note’ on the tool bar BR2. As described above, each selection of the tabs TB1 to TB6 changes the display of icons of image processing operations on the tool bar BR2. Under the selection of the tab TB6 ‘Work Note’, the display of icons on the-tool bar BR2 depends on a selected work note file in the work information display field WK. In the illustrated example of FIG. 28, the work note file under the user's entered title of ‘Deeper Tree Green’ is selected. The tool bar BR2 under the selection of the tab TB6 ‘Work Note’ has the display of icons BT31 ‘Note Description’, BT32 ‘Histogram’, BT33 ‘CC (Color)’, BT34 ‘Hue/Saturation/Intensity’, and BT35 ‘Unsharp Mask’. The icons BT32 ‘Histogram’ to BT35 ‘Unsharp Mask’ arranged horizontally from the left to the right show the sequential procedure of image processing operations registered in the selected work note file. The left-most icon BT31 ‘Note Description’ does not correspond to a retouching operation but is activated to open a work note window for describing the details of the selected work note file.

The registration of the selected work note file FL3 with the title ‘Deeper Tree Green’ specifies the displayed icons ‘Histogram’ to ‘Unsharp Mask’. According to the registered details of the image processing operations in the work note file FL3 with the title ‘Deeper Tree Green’ shown in FIG. 26, the icons ‘Histogram’, ‘CC (Color)’, ‘Hue/Saturation/Intensity’, and ‘Unsharp Mask’ are selected and arranged in this order. Namely the arrangement of icons displayed on the tool bar BR2 is based on the work note file selected in the display of the work information display field WK under the selection of the tab TB13 ‘Work Note’. The work note file represents the operating procedure of image processing. The details of the multiple image processing operations registered in the work note file thus specify the selection and the arrangement of the icons.

When the user selects the title of a desired work note file in the work information display field WK under the selection of the tab TB13 ‘Work Note’, a required series of image processing operations to obtain an object processed image are presented on the tool bar BR2. The user successively clicks the icons BT32 to BT35 from the left to the right on the tool bar BR2 to sequentially perform the required series of image processing operations. The user's click of each of the icons BT32 to BT35 opens a dialog box for entry of the settings of relevant parameters as described above with reference to FIG. 8. The current settings are shown in the parameter input boxes of the dialog box. For example, in the dialog box for the entry of ‘hue/saturation/intensity’ shown in FIG. 8, the slider bars SB1 to SB3 indicate the current settings of ‘hue=0, saturation=15, intensity=0’ in the parameter input boxes. The user clicks the button BT12 ‘OK’ without any change of the current settings in the parameter input boxes to execute the image processing operation according to the registration of the work note file. The user may regulate the settings in the parameter input boxes of the dialog box according to the requirements.

The image data newly input by the input module 51 then goes through the series of multiple image processing options registered in the selected work note file. The object image data of image processing operations is not restricted to the newly input image data but may be the existing image data used for generation of the retouching record file. The existing image data may go through again the series of multiple image processing operations, possibly with some change according to the requirements.

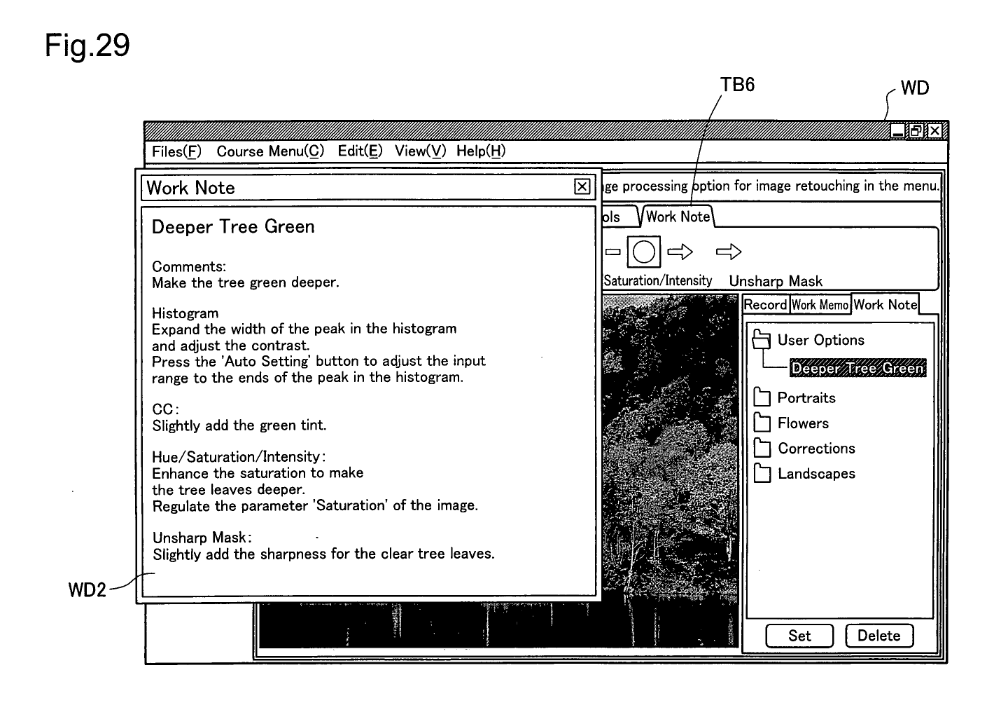

FIG. 29 shows a work note window WD2 opened in response to a click of the icon BT31 ‘Note Description’ on the tool bar BR2. The work note window WD2 is opened above the application window WD. As illustrated, the work note window WD2 has the note name ‘Deeper Tree Green’, the comment, and the notes of the respective image processing operations ‘histogram’, ‘CC’, ‘hue/saturation/intensity’, and ‘unsharp mask’.

The display of the work note window WD2 is based on the work note file FL3. The CPU 30 extracts the data DT21 ‘work note name’ and the data DT22 ‘work note comment’ from the work note file FL3 to be displayed on the work note window WD2. The CPU 30 also extracts the sub-data DT31 ‘retouching option’ and the sub-data DT33 ‘operation comments’ in the 1^{st} ‘image processing’ data DT23(1) to be displayed on the work note window WD2. The CPU 30 also extracts the sub-data DT31 ‘retouching option’ and the sub-data DT33 ‘operation comments’ in the 2^{nd} ‘image processing’ data DT23(2) through the last ‘image processing’ data DT23(n) to be displayed on the work note window WD2.

The user clicks the icon BT31 ‘Note Description’ to open the work note window WD2 on the CRT display 12, prior to sequential clicks of the icons BT32 to BT35 for the image processing operations. The display of the work note window WD2 informs the user of the name of the work note, the object of the work note (comment), and the notes for parameter setting of the respective image processing options ‘histogram’, ‘CC’, ‘hue/saturation/intensity’, and ‘unsharp mask’. The user refers to the display of the work note window WD2 and sequentially clicks the icons BT32 to BT35 to successively execute the corresponding image processing operations. The user may regulate the settings of the relevant parameters in a dialog box for each image processing operation, based on the display of the work note window WD2.

Referring back to the flowchart of FIG. 20, after execution of step S1396, the CPU 30 determines whether the user's selection of the icons displayed on the tool bar BR2 has been completed at step S398. In response to an affirmative answer, the retouching flow goes to ‘Return’. When it is determined at step S398 that the user's selection of the icons has not yet been completed, on the other hand, the retouching flow returns to step S340 to execute a next image processing operation corresponding to a newly selected icon.

The processing of step S340 and the arrangement of the icons on the tool bar BR2 correspond to the functions of the image processing specification module 152a. The processing of steps S350 to S370 and the dialog box DBX1 for the entry of each identified image processing option correspond to the functions of the parameter setting module 152b. The processing of step S380 corresponds to the functions of the image processing module 152c. The processing of step S1375 and the dialog box DBX2 for entry of operation comments correspond to the functions of the character input module 152d. The processing of step S1394 corresponds to the functions of the data storage module 152e.

C. Functions and Effects

As described above, the computer system of the second embodiment specifies the image processing operations performed to generate retouched image data from input image data Dpi, based on latest selections and settings of image processing options and their related parameters and stores the specified details in the work memo file FL12. The user refers to the work memo file FL12 and readily studies the record of efficient image processing operations performed to generate retouched image data from input image data Dpi for application to retouching of other image data.

The system of the second embodiment allows the user to refer to the display of the work note window WD2 opened in a click of the icon BT31 ‘Note Description’ and to regulate the settings of the relevant parameters of each image processing operation. This arrangement desirably enhances the convenience for re-execution of the series of multiple image processing operations and improves the quality of processed data.

2-2. Modifications

The arrangement of the second embodiment may be modified in various ways including the modified examples (1) through (3) of the first embodiment. Some other examples of possible modification are given below.

(1) In the structure of the second embodiment, the work note window WD2 displays the data ‘work note comment’ and the ‘retouching option’ and the ‘operation comments’ of the respective image processing operations, which are registered in the work note file FL3. The display of the work note window WD2 may, however, be not essential, and the only requirement is to allow the user to refer to the contents of the work note file FL3. The contents of the work note file FL3 may be printed out with the printer 13 or may be output as audio or voice data.

(2) In the structure of the second embodiment, the work note window WD2 enumerates the data ‘work note comment’ and the ‘retouching option’ and the ‘operation comments’ of the respective image processing operations in the same field. The data ‘work note comment’ may be displayed in a separate field, and the data ‘retouching option’ and the ‘operation comments’ of the respective image processing operations may be displayed individually in different fields.

(3) The second embodiment adopts the ‘retouching parameter system’, but a direct image processing system may be adopted to directly process original image data and enter the desired notes with regard to each image processing operation. A ‘layer system’ may otherwise be adopted to enter the desired notes on each layer. The layer represents a transparent sheet used to perform color correction and attachment of new images (character strings and image clips) without directly processing the original image data.

3-1. Third Embodiment

A third embodiment of the invention is described below.

A. System Configuration

The computer system of the third embodiment has the identical hardware configuration with that of the computer system of the first embodiment shown in FIG. 1. The like elements to those of the first embodiment are expressed by the like numerals.

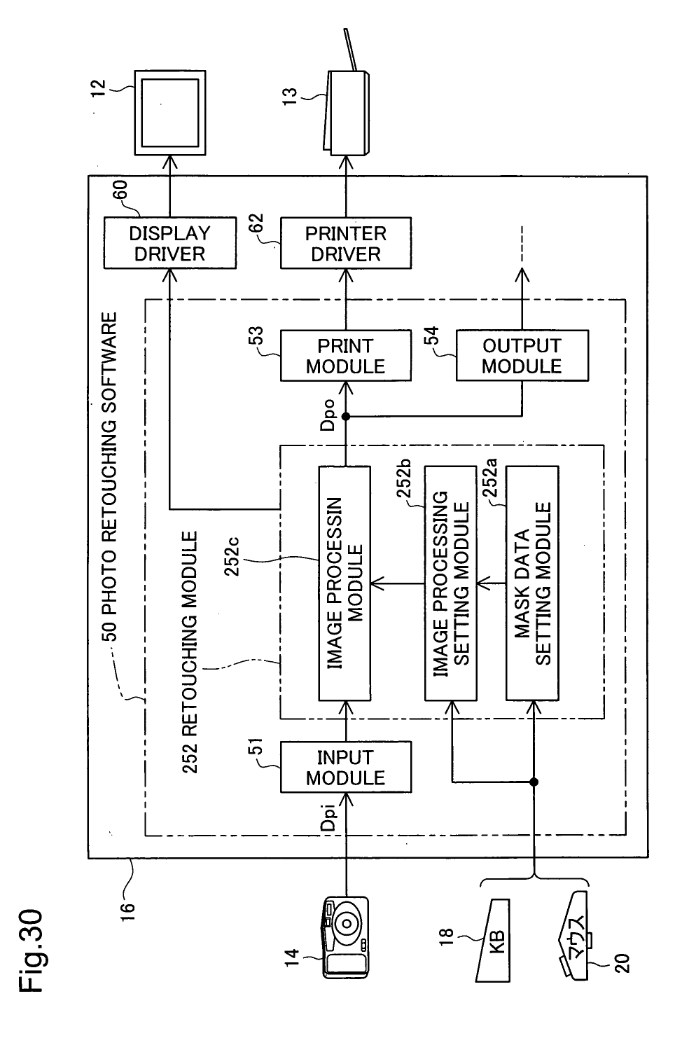

The third embodiment has partly different software configuration from that of the first embodiment. FIG. 30 is a block diagram showing a control flow according to the photo retouching software 50 executed by the computer body 16 in the third embodiment. The control flow in the photo retouching software 50 of the third embodiment is similar to that of the first embodiment shown in FIG. 2, except the constituents of a retouching module 252.

The retouching module 252 of the third embodiment includes a mask data setting module 252a, an image processing setting module 252b, and an image processing module 252c. The functions of these modules 252a through 252c enable input image data Dpi to go through a required series of image processing operations with appropriate masks. This arrangement is the main characteristics of the invention and will be described in detail later.

B. Computer Processing

B-1. General Processing Flow

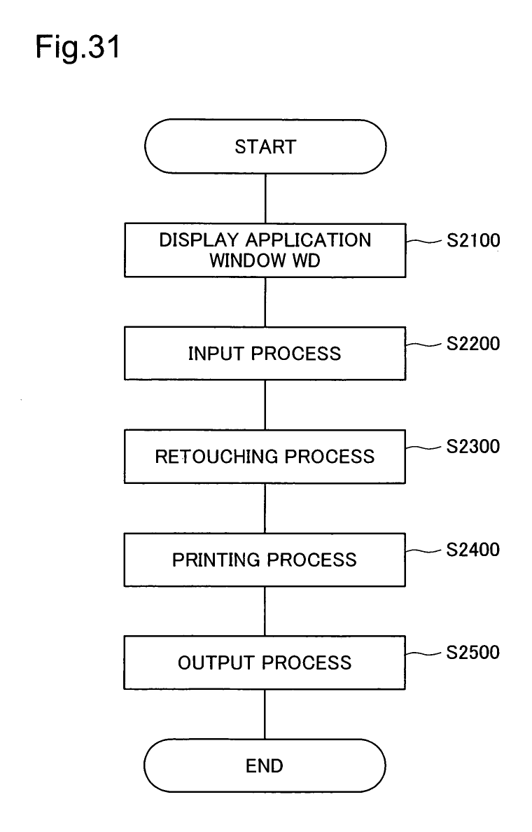

The CPU 30 of the computer body 16 executes the photo retouching software 50 to attain the functions of the input module 51, the retouching module 252, the print module 53, and the output module 54. The series of control according to the photo retouching software 50 is described in detail. FIG. 31 is a flowchart showing a control routine, which is triggered by a start instruction of the photo retouching software 50.

This control routine of this embodiment is similar to the control routine of the first embodiment shown in the flowchart of FIG. 3. The processing of step S2100 to open an application window WD on the CRT display 12 is identical with the processing of step S100 in FIG. 3. The input process of step S2200, the printing process of step S2400, and the output process of step S2500 are respectively identical with the input process of step S200, the printing process of step S400, and the output process of step S500 in FIG. 3.

Like the retouching process of step S300 in FIG. 3, the retouching process executed at step S2300 retouches the input image data Dpi through a series of image processing and adopts the ‘retouching parameter system’ for image processing. The retouching process is the main characteristics of this embodiment and corresponds to the functions of the retouching module 252 (FIG. 30). The details of the retouching process are described below.

B-2. Retouching Process

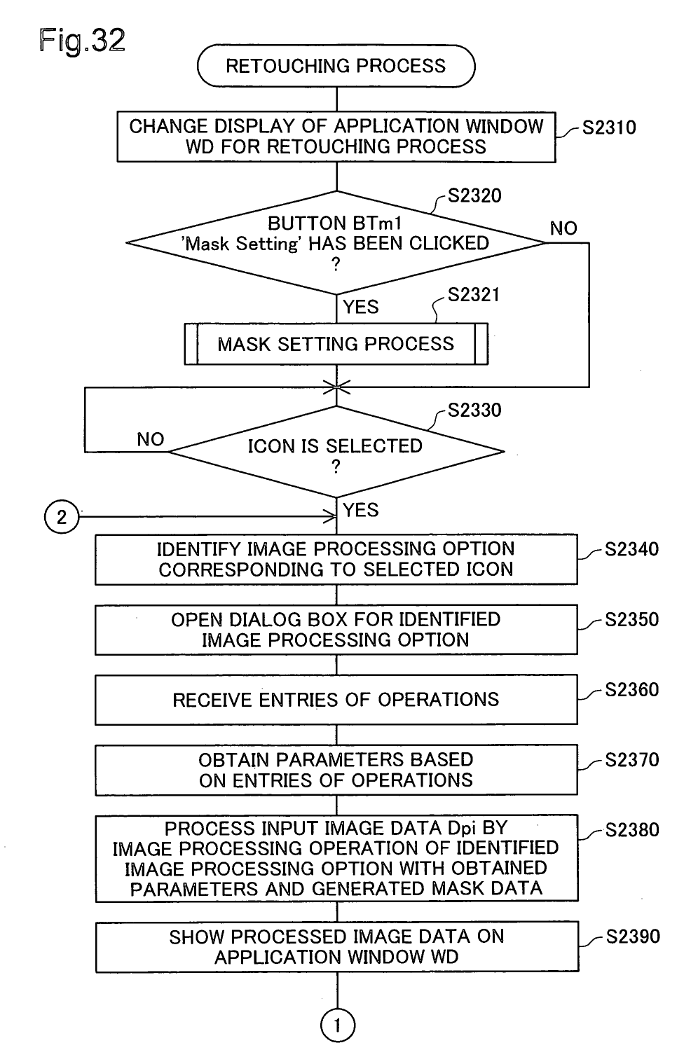

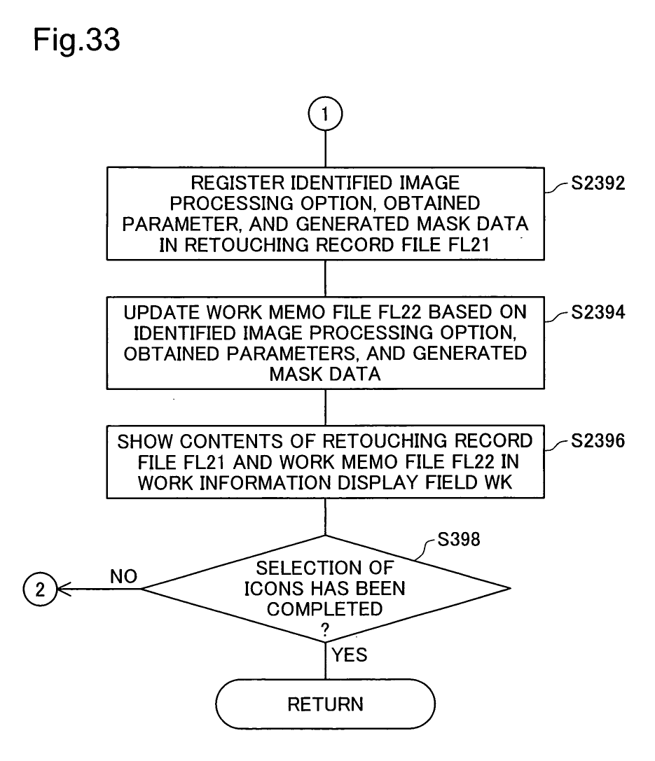

FIGS. 32 and 33 are flowcharts showing the details of the retouching process executed at step S2300. In the retouching process routine, the CPU 30 first changes the display of the application window WD for the retouching process on the CRT display 12 (step S2310).

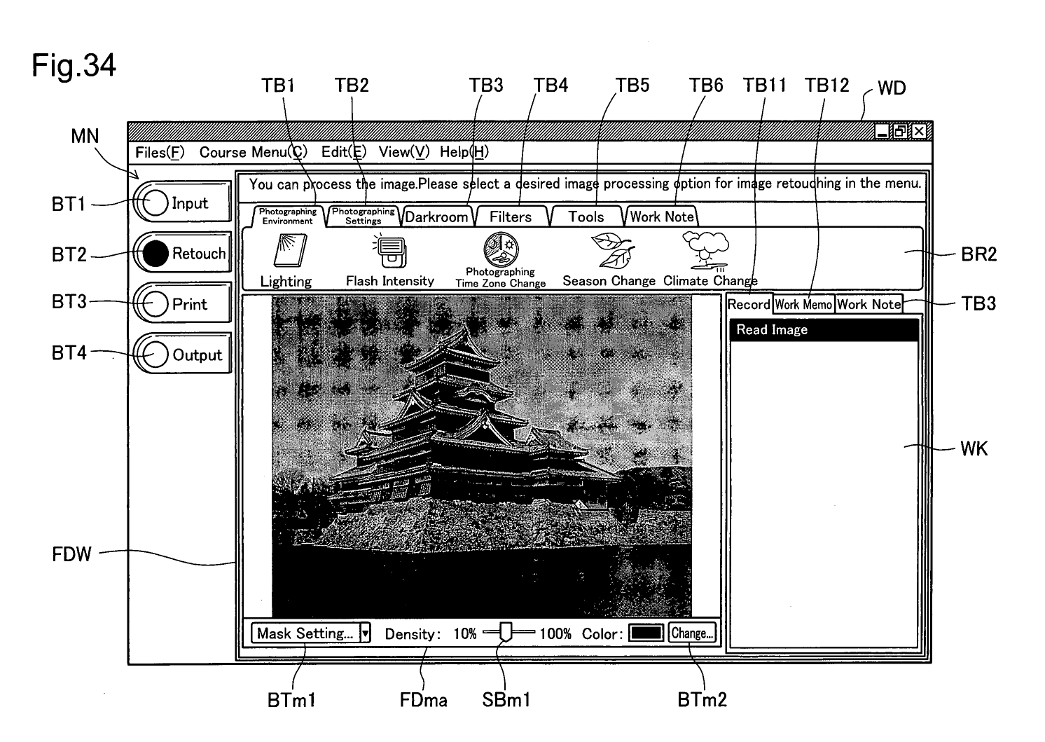

FIG. 34 shows the display of the application window WD for the retouching process in this embodiment. The display of the application window WD for the retouching process in this embodiment is mostly identical with the display of the first embodiment shown in FIG. 7. The user clicks a selected icon on the tool bar BR2 with the mouse 20 under the selection of one of the group tabs TB1 to TB6 to perform the corresponding image processing operation. The selected image processing operation may be executed over the whole image expressed by the image data Dpi input at step S200 or on only part of the image. In the latter case, a mask is laid on the image prior to execution of the selected image processing operation. The activation of such masked image processing is selectable in the application window WD for the retouching process. This is the main difference from the application window WD for the retouching process of the first embodiment.

As illustrated in FIG. 34, the bottom of the work field FDW has a mask setting field FDma for mask setting. The mask setting field FDma includes a button BTm1 ‘Mask Setting’, a density slider bar SBm1, and a color change button BTm2. The button BTm1 ‘Mask Setting’ is activated to open a ‘Mask Setting’ window for mask setting process. The density slider bar SBm1 is manipulated to set the desired transparency (density) of the display color of the mask on the application window WD. The color change button BTm2 is operated to select the display color of the mask. The mask represents gray tone paint to mask a specified area. The user's manipulation of the density slider bar SBm1 and the color change button BTm2 varies the settings of the transparency and the display color of the mask on the application window WD.

Referring back to the flowchart of FIG. 32, after execution of step S2310, the CPU 30 determines whether the user has clicked the button BTm1 ‘Mask Setting’ in the mask setting field FDma with the mouse 20 at step S2320. In response to the user's click, the retouching flow executes a mask setting process (step S2321) and goes to step S2330. When it is determined at step S2320 that the user has not clicked the button BTm1 ‘Mask Setting’, on the other hand, the retouching flow skips the processing of step S2321 and directly goes to step S2330.

B-2-1. Mask Setting Process

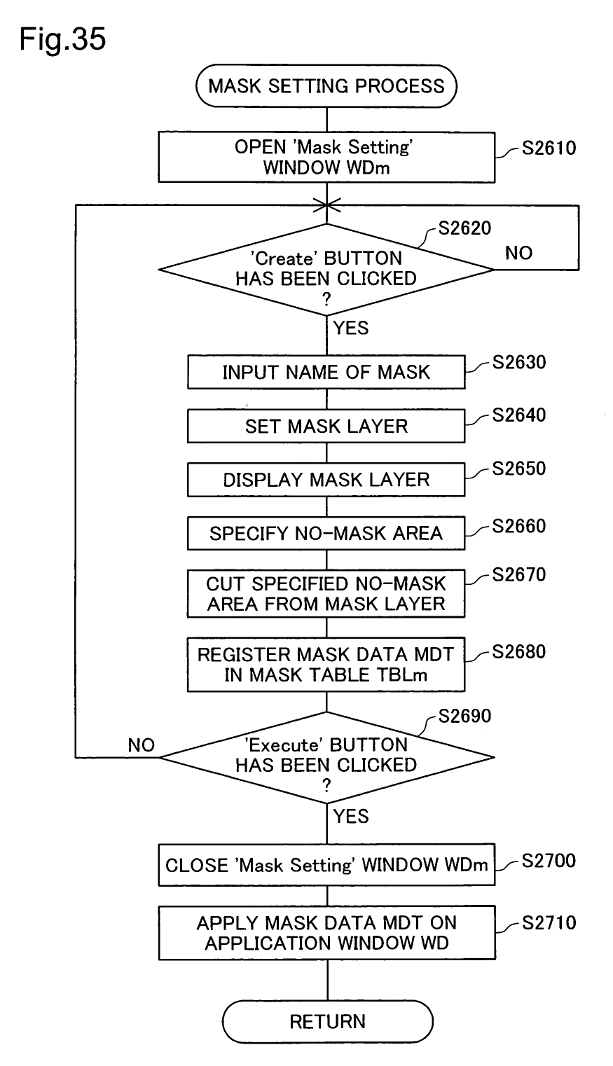

The details of the mask setting process are described below. FIG. 35 is a flowchart showing the details of the mask setting process executed at step S321. In the mask setting process, the CPU 30 first opens a ‘Mask Setting’ window WDm on the CRT display 12 (step S2610).

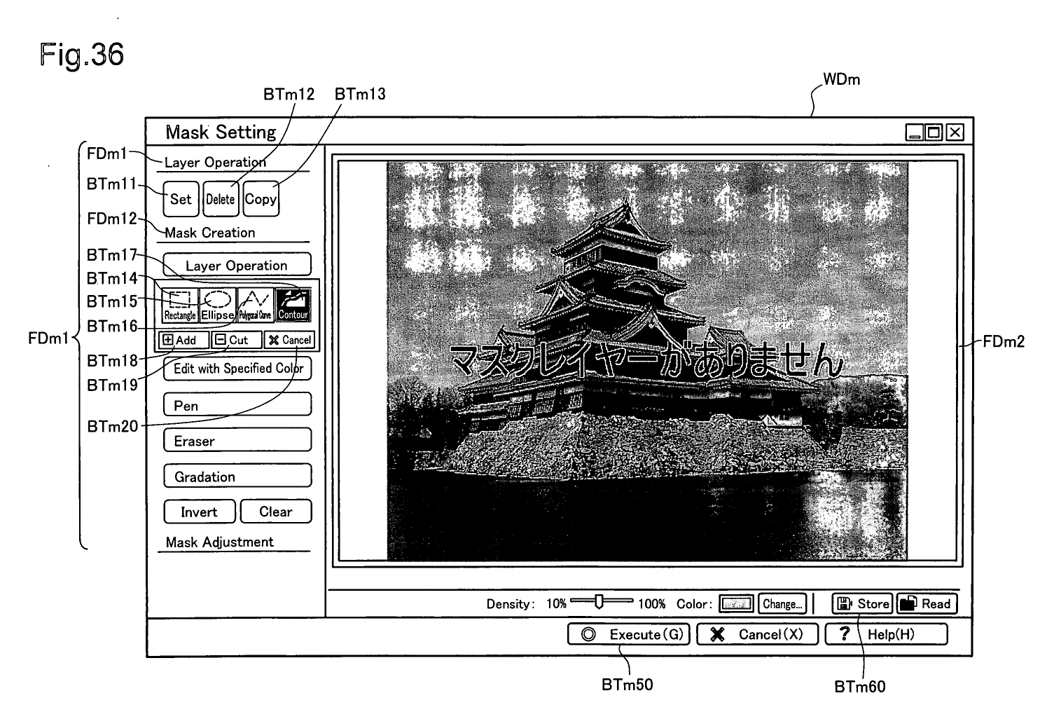

FIG. 36 shows the ‘Mask Setting’ window WDm, which includes an operation field FDm1 and a work field FDm2. The operation field FDm1 has a ‘Layer Operation’ field FDm11 and a ‘Mask Creation’ field FDm12. The ‘Layer Operation’ field FDm11 has three buttons BTm11 ‘Set’, BTm12 ‘Delete’, and BTm13 ‘Copy’.

The ‘Mask Creation’ field FDm12 has tool buttons BTm14 to BTm17 for setting a no-mask area and buttons BTm18 ‘Add’, BTm19 ‘Cut’, and BTm20 ‘Cancel’, as well as other diverse tool buttons.

The illustration of FIG. 36 shows the initial state of the ‘Mask Setting’ window WDm. The input image data Dpi is displayed in the work field FDm2. There is no mask layer provided for creation of a mask in this initial stage, so that a message of ‘There is no mask layer’ appears over the input image data Dpi. A mask is created on the layer, which is a transparent sheet used to perform color correction and attachment of new images (character strings and image clips) without directly processing original image data. In this embodiment, a gray tone sheet is provided as a mask layer in response to the user's click of the ‘Set’ button BTm11.

Referring back to the flowchart of FIG. 35, the CPU 30 determines whether the user has clicked the ‘Set’ button BTm11 with the mouse 20 (step S2620). In the case of a negative answer, the mask setting process routine repeats the processing of step S2620 and waits for the user's click of the ‘Set’ button BTm11. In response to an affirmative answer at step S2620, on the other hand, the CPU 30 opens a ‘New Mask Creation’ dialog box DBX21 for the user's entry of the name of a mask at step S2630.

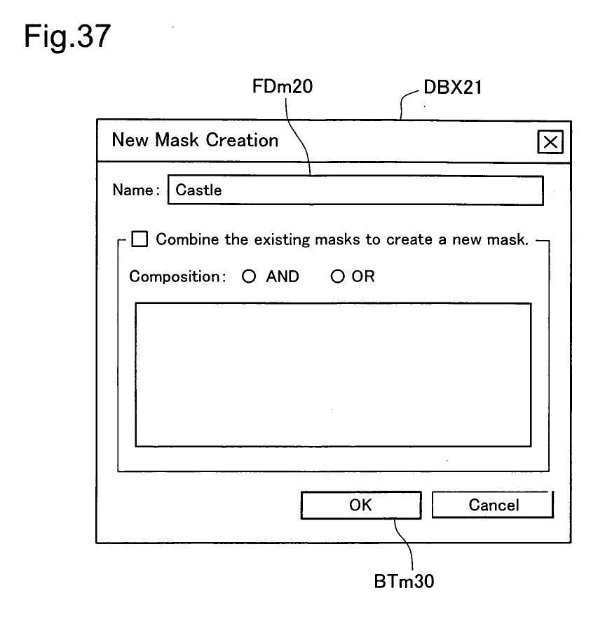

FIG. 37 shows the ‘New Mask Creation’ dialog box DBX21. The ‘New Mask Creation’ dialog box DBX21 has a ‘Name’ input field FDm20. The user manipulates the mouse 20 and the keyboard 18 to enter the name of the mask in the input field FDm20 and clicks an ‘OK’ button BTm30. The CPU 30 then inputs the entered name of the mask. In this illustrated example, ‘Castle’ is the entered name of the mask.

Referring back to the flowchart of FIG. 35, the CPU 30 sets a mask layer with the name input at step S2630 (step S2640) and displays the mask layer on the ‘Mask Setting’ window WDm (step S2650).

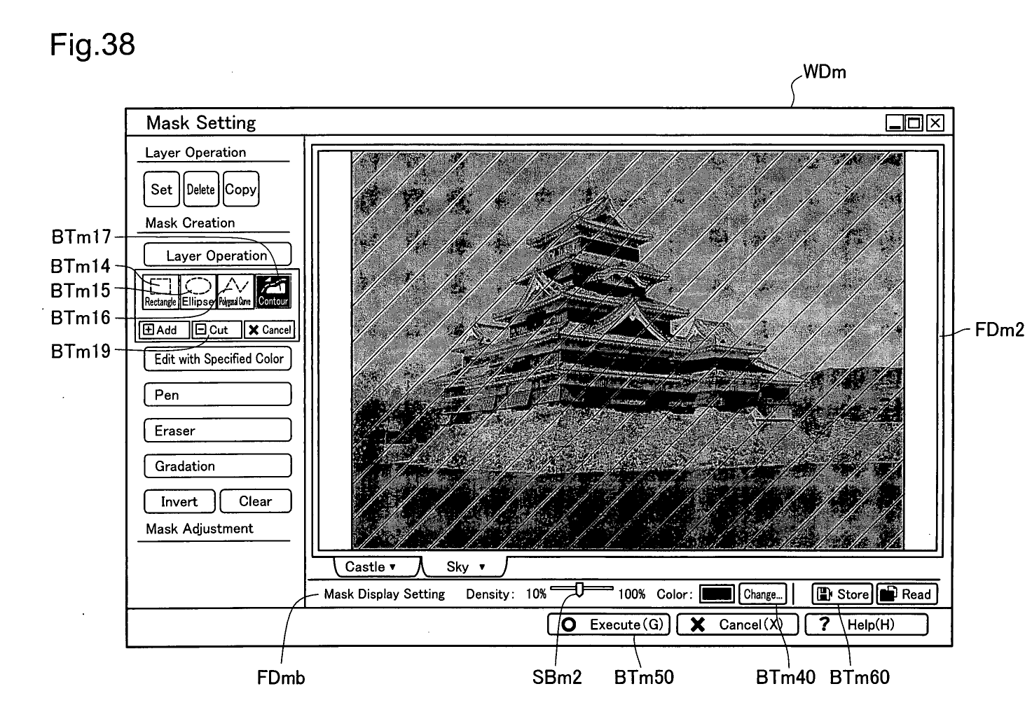

FIG. 38 shows the display of the ‘Mask Setting’ window WDm with a mask layer. In the illustrated example, the processing of steps S2620 to S2650 is repeated twice to set two mask layers with the names ‘Castle’ and ‘Sky’. There are accordingly two tabs TBm1 and TBm2 in the work field FDm2. Selection of the tabs TBm1 and TBm2 changes the display between the ‘Castle’ mask layer and the ‘Sky’ mask layer. These mask layers have identical dimensions with those of the input image data Dpi and are gray tone sheets. All the pixels in the image have the tone value of 255 in the 256-tone, 8-bit gray scale.

The bottom of the work field FDm2 has a mask display setting field FDmb, which includes a density slider bar SBm2 and a color change button BTm40. The density slider bar SBm2 specifies the transparency (density) of the display color of the mask on the ‘Mask Setting’ window WDm. The color change button BTm40 specifies the display color of the mask. The user's manipulation of the density slider bar SBm2 and the color change button BTm40 regulates the densities and the display colors of the ‘Castle’ mask layer and the ‘Sky’ mask layer. In the illustration of FIG. 38, each mask layer is expressed by a hatched area. This expression is only for the purpose of clear illustration and does not mean the actual hatching. In other drawings, hatched areas represent masks.

The original mask layer set at step S2640 in the flowchart of FIG. 35 completely masks (covers) the whole image as shown in FIG. 38. A no-mask area is then specified on the mask layer by a cutting operation and may be expanded or reduced with a virtual pen and a virtual eraser. The mask setting process specifies a no-mask area and cuts the specified no-mask area from the mask layer at steps S2660 and S2670 as described below.

As shown in FIG. 38, the user's clicks of the tool buttons BTm14 to BTm17 activate the corresponding tools ‘Rectangle’, ‘Ellipse’, ‘Polygonal Curve’, and ‘Contour’ for specifying a desired no-mask area. The ‘Rectangle’ tool draws a rectangle to specify the no-mask area. The ‘Ellipse’ tool draws an ellipse to specify the no-mask area. The ‘Polygonal Curve’ tool draws a polygonal curve to specify the no-mask area. The ‘Contour’ tool traces and extracts the contour of an object image.

The ‘Rectangle’, the ‘Ellipse’, the ‘Polygonal Curve’ and the ‘Contour’ tools directly set the user's specified rectangular, ellipsoidal, and polygonal areas with the mouse 20 to the no-mask areas. The ‘Contour’ tool automatically extracts the contour of an object image on the basis of the user's specified points with the mouse 20 to set the no-mask area.

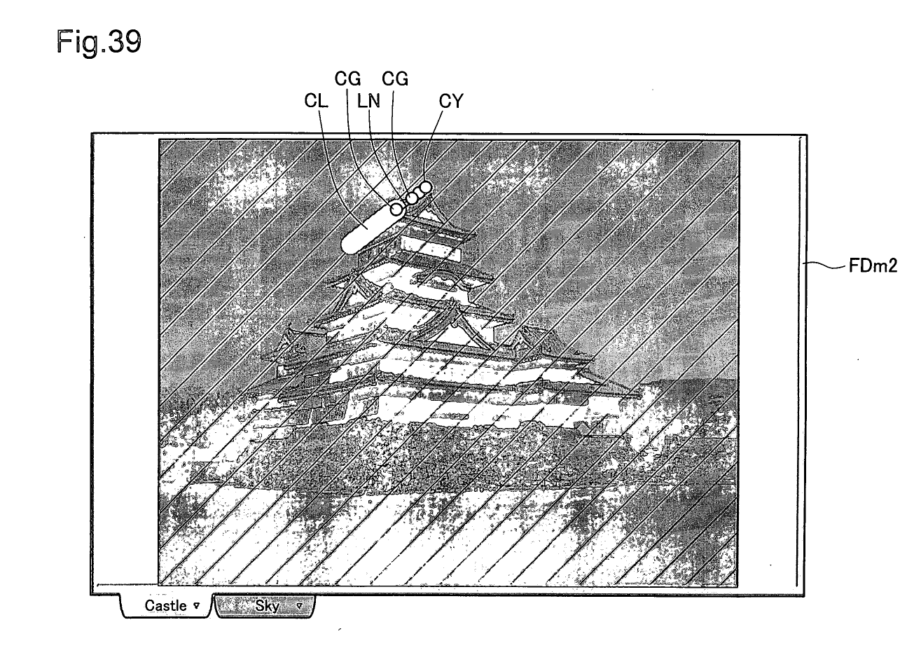

FIG. 39 shows a process of specifying a search range with a ‘Contour’ tool. The user clicks an appropriately selected point on the contour of an image displayed in the ‘Mask Setting’ window WDm. A yellow circle CY as a starting point then appears at the clicked point. The user's drag of the mouse 20 from the clicked point draws a contour line. A thick line CL starting from the yellow circle CY (or from a handle described below) then appears to specify a search range for the contour. In this search range, the CPU 30 automatically detects the contour of the displayed image and shows the detected contour by a purple contour line LN and multiple green circles (handles) CG. The user draws the contour line of the image in each specified search range with the auto extraction function. In the illustrated example, the contour line of a castle is drawn for the mask ‘Castle’.

At step S2670 in the flowchart of FIG. 35, the CPU 30 cuts the no-mask area specified at step S2660 from the mask layer. In response to the user's click of the button BTm19 ‘Cut’ on the ‘Mask Setting’ window WDm with the mouse 20, the no-mask area specified at step S2660 is cut from the mask layer. The mask layer after the cutting gives mask data MDT representing a mask of a desired shape.

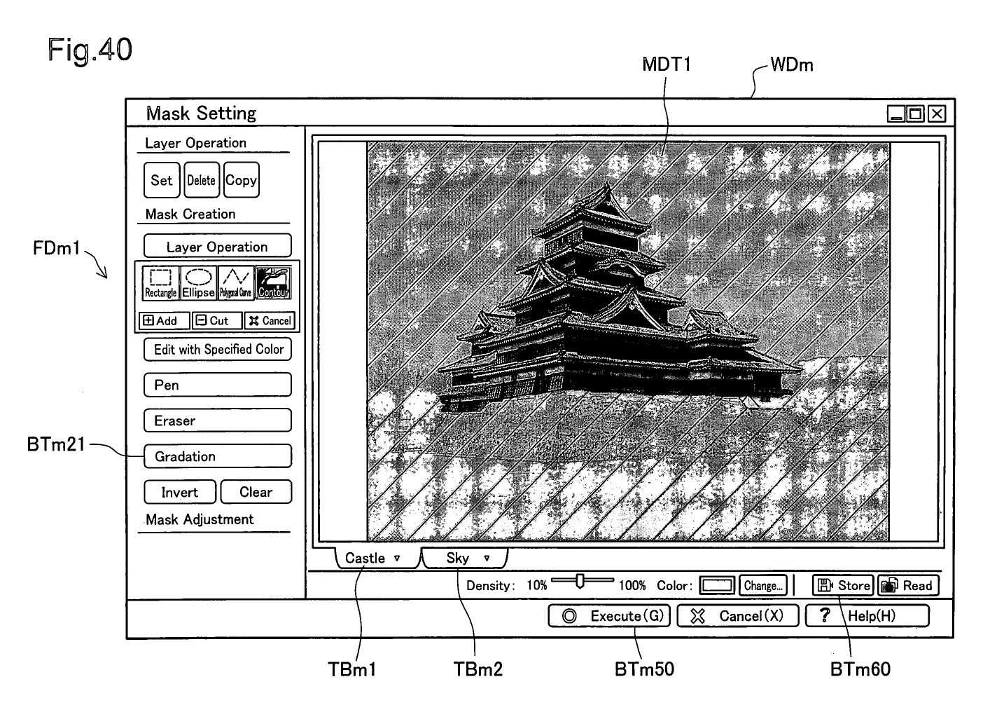

FIG. 40 shows the display of the ‘Mask Setting’ window WDm with the mask layer (mask data MDT1) after cutting. In this illustrated example, mask data MDT1 ‘Castle’ (hatched area) excluding a castle image area is displayed on the ‘Mask Setting’ window WDm.

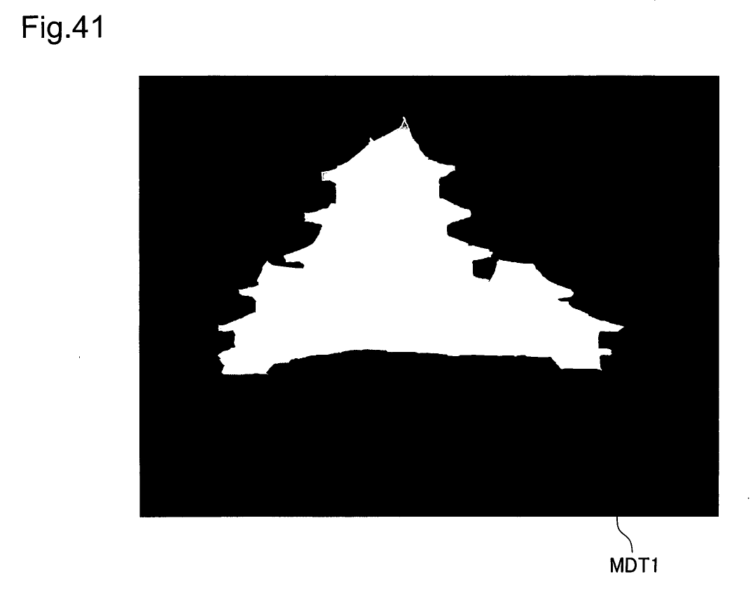

FIG. 41 shows the mask data MDT1 ‘Castle’. The mask data MDT1 is bitmap image data expressing a castle image area in white and a residual area in black.

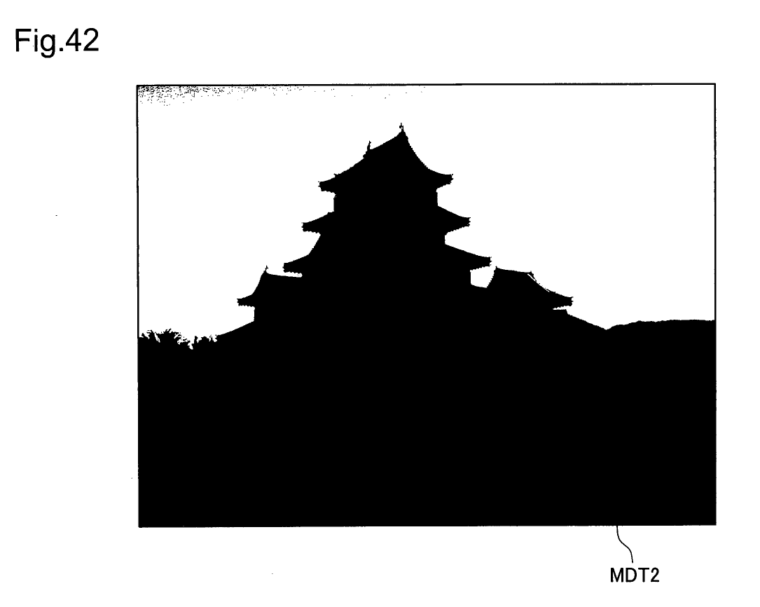

FIG. 42 shows mask data MDT2 ‘Sky’. The mask data MDT2 ‘Sky’ is generated by cutting a sky image area from the mask layer by the procedure discussed above. The mask data MDT2 is bitmap image data expressing a sky image area in white and a residual area in black.

The mask data is not restricted to black and white binary image data like the examples of FIGS. 41 and 42. The mask data is gray tone data as mentioned above, and may thus have some gradation. As shown in FIG. 40, a button BTm21 ‘Gradation’ is provided in the operation field FDm1 of the ‘Mask Setting’ window WDm. In response to the user's click of the button Bum21 ‘Gradation’, a non-illustrated tool option is activated to give gradation to the mask layer. The decreasing image processing effects from the higher sky to the ground generally give a clearer sky image. Application of gradation on the mask data MDT2 ‘Sky’ shown in FIG. 42 ensures the better effects of image processing.

Referring back to the flowchart of FIG. 35, the CPU 30 registers the mask data MDT generated by the processing of steps S2620 to S2670 in a mask table TBLm at step S2680.

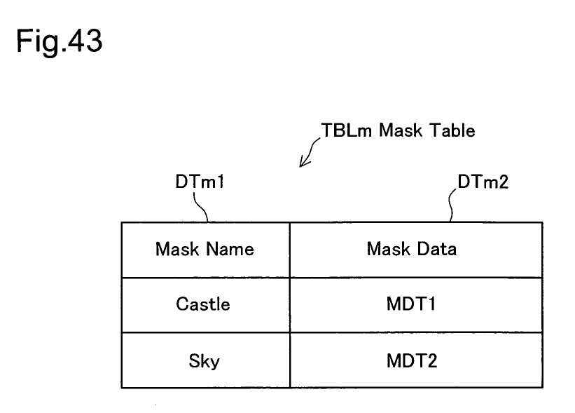

FIG. 43 shows the data structure of the mask table TBLm, which includes data DTm1 ‘mask name’ and data DTm2 ‘mask data’. The data DTm1 ‘mask name’ stores the name of the mask input at step S2630, and the data DTm2 ‘mask data’ stores the mask data MDT generated at step S2670.

At subsequent step S2690 in the flowchart of FIG. 35, the CPU 30 waits for the user's click of a button BTm50 ‘Execute’ on the ‘Mask Setting’ window WDm (see FIG. 40). Unless the button BTm50 ‘Execute’ is clicked, the mask setting routine goes back to step S2620 to repeat the series of mask setting process in response to another click of the ‘Set’ button. In response to the user's click of the button BTm50 ‘Execute’ at step S2690, on the other hand, the CPU 30 closes the ‘Mask Setting’ window WDm (step S2700).

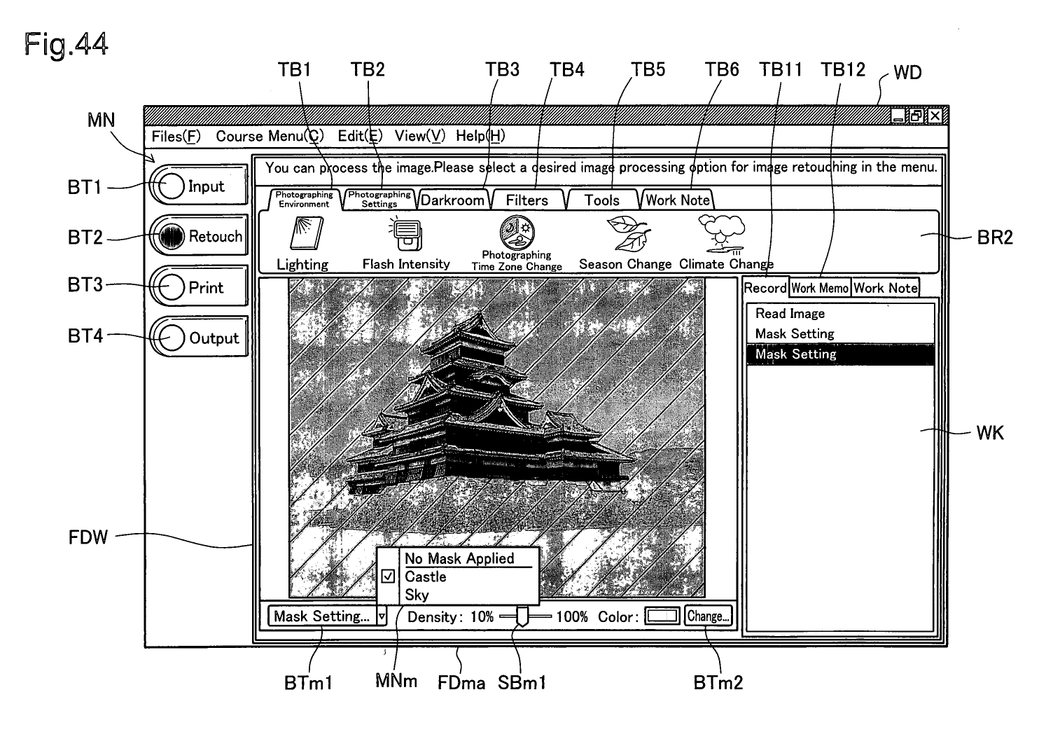

The CPU 30 then applies the generated mask data MDT on the image displayed on the application window WD for the retouching process (step S2710). FIG. 44 shows the display of the application window WD for the retouching process with application of the mask data MDT. The input image data Dpi combined with the mask data MDT1 ‘Castle’ is displayed in the work field FDW of the application window WD. The mask data laid over the input image data Dpi is the active mask data selected between the generated mask data MDT1 and MDT2 at the time of the user's click of the button BTm50 ‘Execute’ on the ‘Mask Setting’ window WDm.

The user's click of a reverse triangle on the right side of the button BTm1 ‘Mask Setting’ opens a pull-up menu MNm, which includes ‘No Mask Applied’ and the names of the generated masks as possible options. The user clicks one of the options to change the active mask data laid over the input image data Dpi or to cancel the application of the mask data.

After execution of step S2710, the CPU 30 goes to return and exits from the mask setting routine.

According to this mask setting process, the mask data MDT is generated corresponding to the user's instructions and is registered with the user's entered name in the mask table TBLm, which is stored in the RAM 32. This mask setting process corresponds to the functions of the mask data setting module 252a (see FIG. 30). The mask table TBLm is deleted from the RAM 32 at the termination of the application program, but the mask data MDT may be stored in a non-volatile memory, such as the HDD 42, in response to the user's request as described below.

In the illustrated example of FIG. 40, a button BTm60 ‘Store’ is provided at the lower right corner of the work field FDm2 on the ‘Mask Setting’ window WDm. The user clicks one of the tabs TBm1 and TBm2 corresponding to a desired mask layer for storage and the button BTm60 ‘Store’. This opens a ‘Save As’ dialog box DBX22.

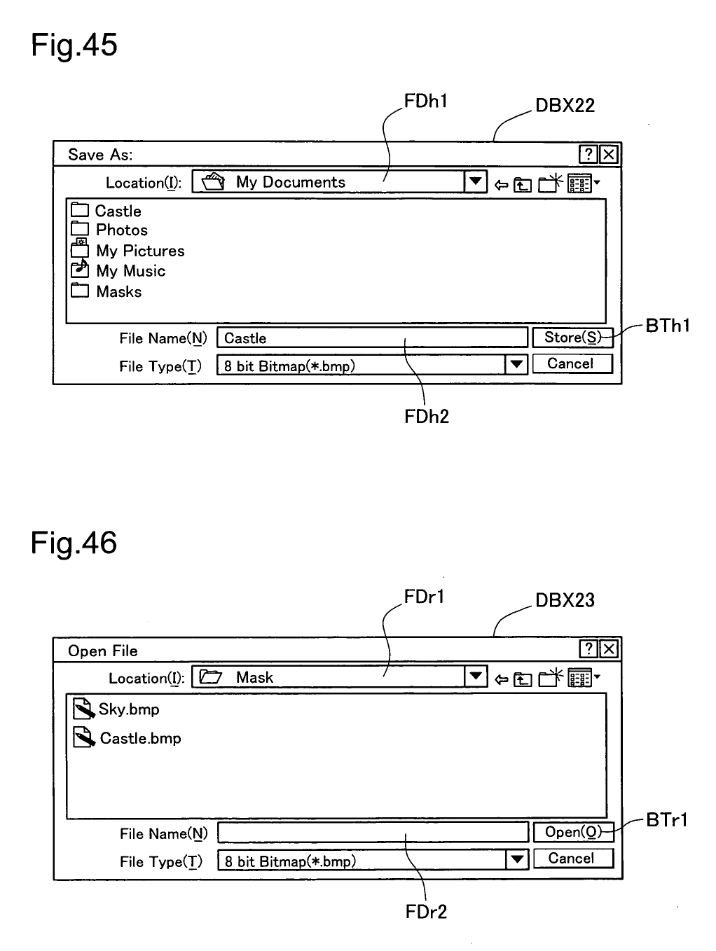

FIG. 45 shows the ‘Save As’ dialog box DBX22, which includes data input boxes FDh1 ‘Location’ and FDh2 ‘File Name’. The user manipulates the mouse 20 and the keyboard 18 to specify the location and the file name for storage in the data input boxes FDh1 and FDh2 and clicks a button BTh1 ‘Store’. The selected mask data MDT is then stored as 8-bit bit map data under the specified file name in the specified location.

The user may read out the stored mask data for application to another image processing operation. FIG. 46 shows an ‘Open File’ dialog box DBX23, which includes data input boxes FDr1 and FDr2 ‘Location’ and ‘File Name’. The user manipulates the mouse 20 and the keyboard 18 to specify the location and the file name in the data input boxes FDr1 and FDr2 and clicks a button BTr1 ‘Open’. The mask data MDT is then read from the storage for application to another image processing operation and is displayed in the work field FDm2 on the ‘Mask Setting’ window WDm.

The mask data used in this embodiment is not restricted to the mask data MDT generated corresponding to the user's instructions. The application program may store plurality of reference mask data prepared in advance and read appropriate reference mask data in response to the user's request.

B-2-2. Image Processing

On completion of the mask setting process, the retouching process goes to step S2330 in the flowchart of FIG. 32. At step S2330, the CPU 30 receives the user's mouse click and determines whether any icon of an image processing option is selected on the display of the tool bar BR2. The decision of step S2330 is repeated until the user selects one icon.

In response to the user's selection of one icon on the display of the tool bar BR2 at step S2330, the CPU 30 identifies the image processing option corresponding to the clicked icon at step S2340. For example, a click of the ‘Color Balance’ icon under the 5^{th} group tab TB5 leads to identification of an image processing option ‘color balance’.

The CPU 30 subsequently opens a dialog box for the image processing option identified at step S2340 (step S2350).

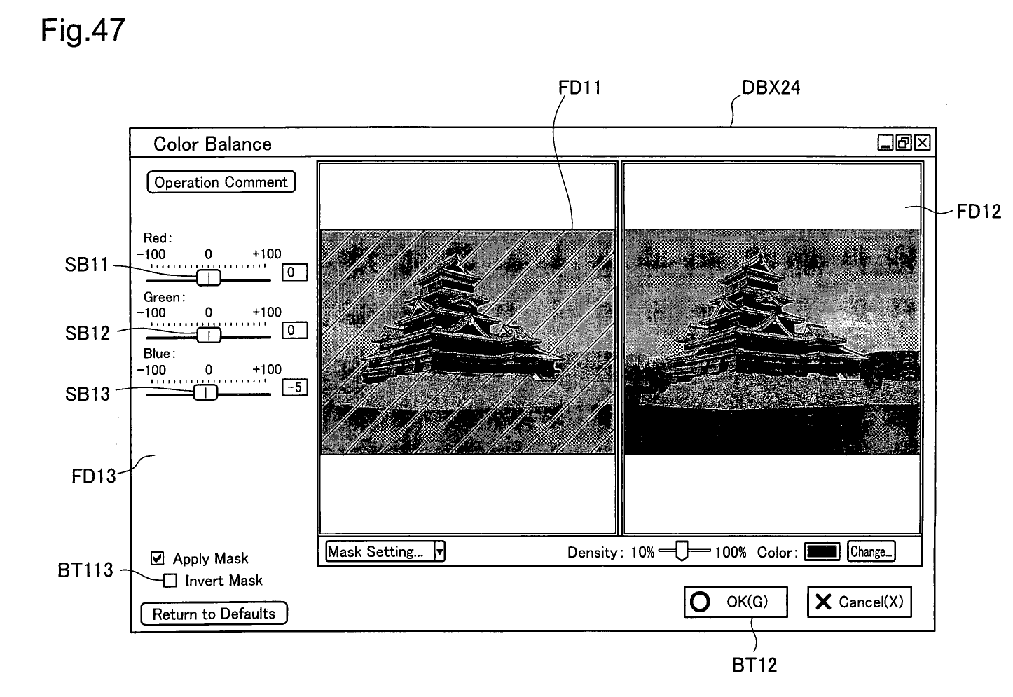

FIG. 47 shows a dialog box DBX24 for the image processing option ‘color balance’ opened in response to the user's click of the ‘Color Balance’ icon. As illustrated, the dialog box DBX24 includes an original image display field FD11, a processed image display field FD12, and an operation field FD13.

The operation field FD13 has slider bars SB11, SB12, and SB13 for regulation of the three primary colors ‘red’, ‘green’, and ‘blue’. The user manipulates these slider bars SB11 to SB13 to adjust the color balances of ‘red’, ‘green’, and ‘blue’ of the input image data Dpi. The display in the processed image display field FD12 reflects the results of adjustment. In response to a click of a button BT12 ‘OK’, the adjusted values on the slider bars SB11 to SB13 are stored as ‘color balance’ parameters in the RAM 32 at steps S2360 and S2370.

The processing of steps S2350 to S2370 gives the ‘color balance’ parameters in the above example. In a similar manner, each selected image processing option gives relevant parameters. For example, the image processing option ‘CC’ gives ‘hue’ and ‘density’ parameters representing the effects of color change of the photographic image. The image processing option ‘unsharp mask’ gives ‘radius’, ‘intensity’, and ‘threshold’ parameters representing the unsharp mask effects. The processing of steps S2330 to S2370 corresponds to the functions of the image processing setting module 252b (see FIG. 30).

The CPU 30 then processes the input image data Dpi by an image processing operation of the selected image processing option identified at step S2340 with the parameters obtained at step S2370 and the currently selected mask data MDT generated in the mask setting process (in the illustrated example of FIG. 47, the mask data MDT1 ‘Castle’) (step S2380). Namely the image processing operation of the identified image processing option with the obtained parameters is executed on a non-covered area of the image with the mask data MDT1. Under application of the gradation effects, the degree of image processing on the masked image depends upon the rate of gradation. The procedure of image processing stores the settings of the image processing operation as parameters separately from the original image and does not directly change the input image data Dpi as mentioned previously. The processing of step S2380 corresponds to the functions of the image processing module 252c (see FIG. 30).

The CPU 30 subsequently shows the processed image data obtained by the image processing operation of step S2380 in the work field FDW on the application window WD (step S2390).

The CPU 30 then proceeds to step S2392 in the flowchart of FIG. 33 to register the image processing option identified at step S2340, the parameters obtained at step S2370, and the currently selected mask data MDT generated in the mask setting process in a retouching record file FL21.

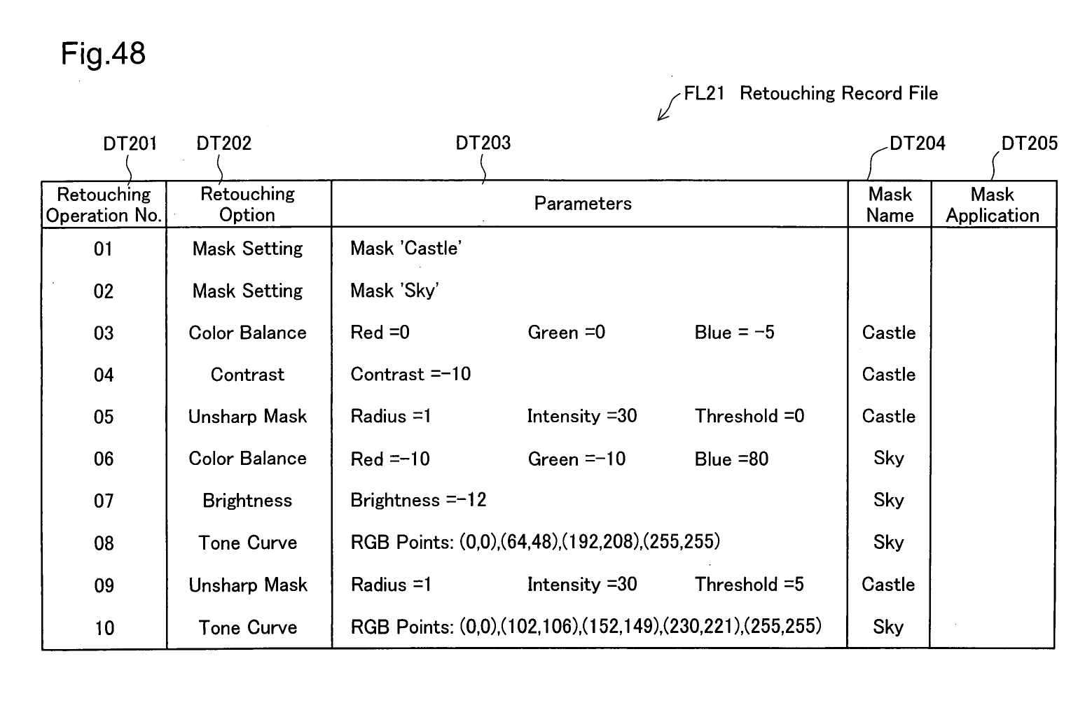

FIG. 48 shows one example of the retouching record file FL21. The retouching record file FL21 has a record of all the image processing operations performed with regard to the image data Dpi input at step S200 to give a current processed image. The retouching record file FL21 includes data DT201 ‘retouching operation No.’, data DT202 ‘retouching option’, data DT203 ‘parameters’, data DT204 ‘mask name’, and data DT205 ‘mask application’. The data DT201 ‘retouching operation No.’ shows numerals in an ascending order to represent the work sequence of image processing operations to be performed. The data DT202 ‘retouching option’ shows the image processing options identified at step S330 as the types of the respective image processing operations. The data DT203 ‘parameters’ shows the parameters of the respective image processing operations obtained at step S360.

The data DT204 ‘mask name’ shows the names of the currently selected mask data MDT generated in the mask setting process, and has registration of one of ‘Castle’, ‘Sky’ and null data (vacancy) representing no mask application in each record in the illustrated example.

The data DT205 ‘mask application’ shows either ‘inversion’ data to invert the currently selected mask data MDT or null data (vacancy) to apply the currently selected mask data MDT in the normal orientation As shown in FIG. 47, the dialog box DBX24 for entry of the image processing option ‘color balance’ has a button BT113 ‘Invert Mask’. In response to the user's click of this button BT113, the currently selected mask data MDT is applied in the inverted orientation and the ‘inversion’ data is registered in the corresponding record of the data DT205 ‘mask application’.

In the illustrated example of FIG. 48, the user processed the input image data Dpi first with the mask data MDT1 ‘Castle’ by image processing operations in the sequence of ‘color balance’, ‘contrast’, ‘unsharp mask’ and then with the mask data MDT2 ‘Sky’ by image processing operations in the sequence of ‘color balance’, ‘brightness’, ‘tone curve’. The resulting processed image did not sufficiently reflect the user's requirements. The user then changed the parameters of the image processing option ‘unsharp mask’ with the mask data MDT1 ‘Castle’ and the parameters of the image processing option ‘color balance’ with the mask data MDT2 ‘Sky’. In this illustrated example, the image processing operation performed at step S2380 is the 10^{th} retouching operation applied on the input image data Dpi. Record data representing the results of the 10^{th} retouching operation is registered at step S2392. This newly registered record data includes ‘10’ as the ‘retouching operation No.’, ‘tone curve’ as the ‘retouching option’, and ‘RGB Points: (0,0), (102,106), (152,149), (230,221), (255,255)’ as the ‘parameters’.

Referring back to the flowchart of FIG. 33, at subsequent step S2394, the CPU 30 updates a work memo file FL22, based on the image processing option identified at step S2340, the parameters obtained at step S2370, and the currently selected mask data MDT generated in the mask setting process.

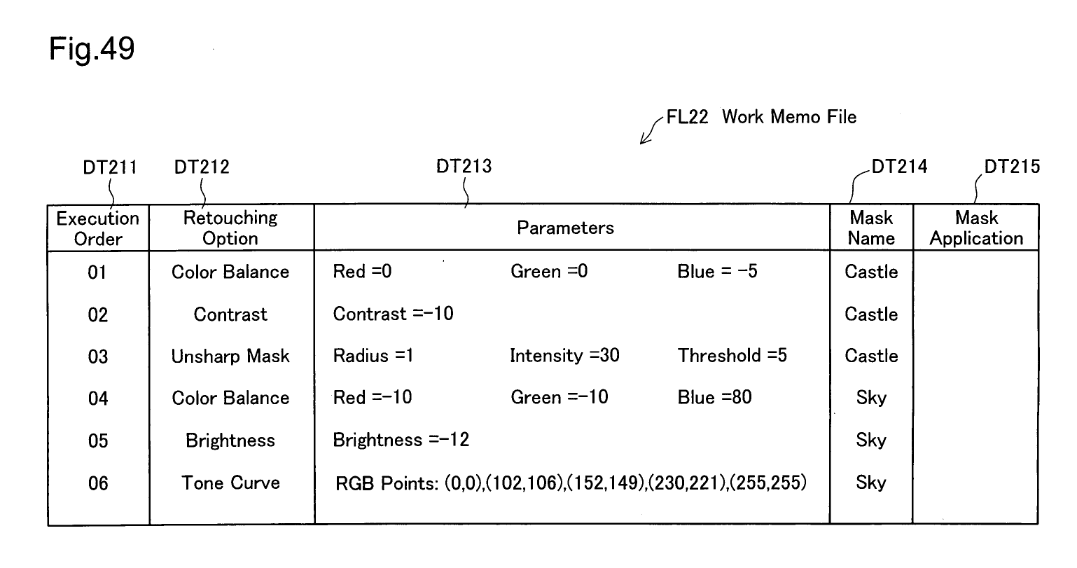

FIG. 49 shows one example of the work memo file FL22. The work memo file FL22 has a record of efficient image processing operations performed with regard to the image data Dpi input at step S2200 to give a current processed image. The work memo file FL22 includes data DT211 ‘execution order’, data DT212 ‘retouching option’, data DT213 ‘parameters’, data DT214 ‘mask name’, and data DT215 ‘mask application’. The terminology ‘efficient’ has been defined in the first embodiment. The concrete procedure of the embodiment for ‘efficiency’ updates the parameters of each image processing option (each image processing option with an identical mask when applied) to be performed multiple times to the latest settings, while maintaining the user's specified work sequence of the respective image processing options.

The work memo file FL22 of FIG. 49 shows the image processing operations sequentially performed according to the contents of the retouching record file FL21 of FIG. 48. In this illustrated example, as shown in the retouching record file FL21 of FIG. 48, the image processing operations are performed in the sequence of the image processing options ‘color balance’, ‘contrast’, and ‘unsharp mask’ with the mask data MDT1 ‘Castle’ and in the sequence of ‘color balance’, ‘brightness’, and ‘tone curve’ with the mask data MDT2 ‘Sky’. In the work memo file FL22 of FIG. 49, the data DT212 ‘retouching option’ stores the types of the image processing operations in this sequence of ‘color balance’, ‘contrast’, and ‘unsharp mask’ with the mask data ‘Castle’ and in the sequence of ‘color balance’, ‘brightness’, and ‘tone curve’ with the mask data ‘Sky’.

As shown in the retouching record file FL21 of FIG. 48, the 9^{th} image processing operation changed the parameters of the image processing option ‘unsharp mask’ with the mask data ‘Castle’ to ‘radius=1, intensity=30, threshold=5’. These latest settings of the parameters are accordingly stored in the data DT113 ‘parameters’ for the image processing option ‘unsharp mask’ with the mask data ‘Castle’ in the work memo file FL22 of FIG. 49 (see record data of the execution order ‘03’).

In a similar manner, as shown in the retouching record file FL21 of FIG. 48, the 10^{th} image processing operation changed the parameters of the image processing option ‘tone curve’ with the mask data ‘Sky’ to ‘RGB Points: (0,0), (102,106), (152,149), (230,221), (255,255)’. These latest settings of the parameters are accordingly stored in the data DT113 ‘parameters’ for the image processing option ‘tone curve’ with the mask data ‘Sky’ in the work memo file FL22 of FIG. 49 (see record data of the execution order ‘06’).

The parameters of the image processing options ‘color balance’ and ‘contrast’ with the mask data ‘Castle’ and the image processing options ‘color balance’ and ‘brightness’ with the mask data ‘Sky’ have not been changed from the original settings. The original settings of the parameters are thus stored in the work memo file FL22.

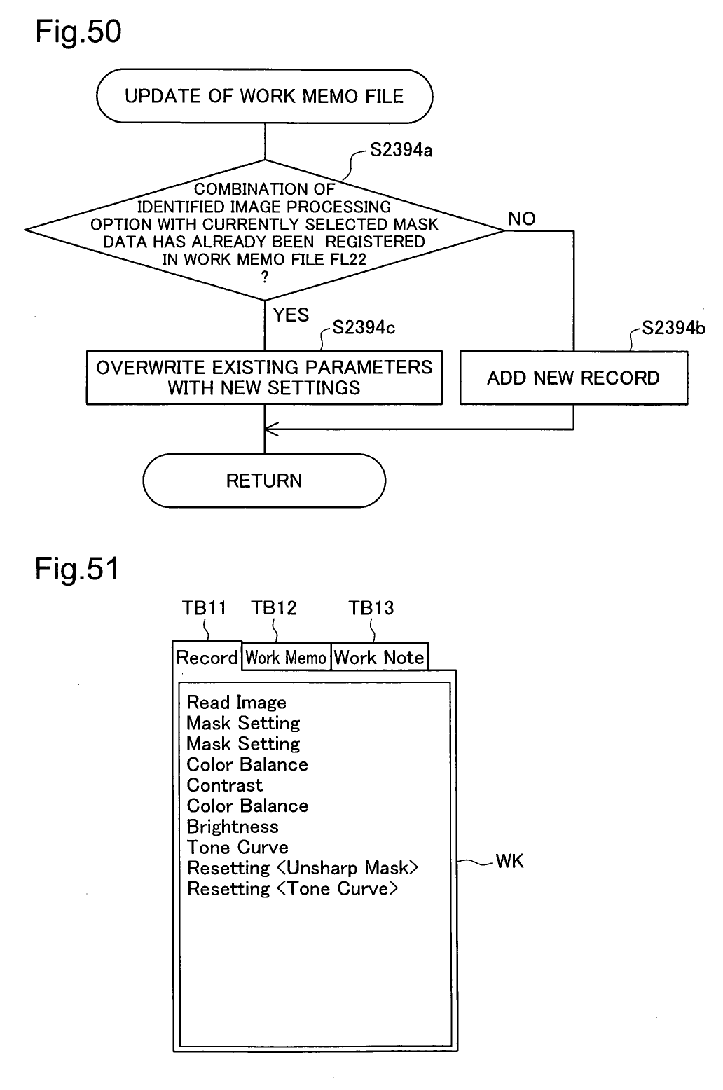

FIG. 50 is a flowchart showing the details of the process of updating the work memo file FL22 at step S2394 of the retouching process. In this updating process, the CPU 30 first determines whether the combination of the image processing option identified at step S2340 with the currently selected mask data generated in the mask setting process has already been registered in the work memo file FL22 (step S2394a). When the combination has not yet been registered in the work memo file FL22, the CPU 30 adds new record data including the image processing option identified at step S2340, the parameters obtained at step S2370, and the currently selected mask data MDT generated in the mask setting process to the work memo file FL22 (step S2394b). The new record data added to the work memo file FL22 includes registration of a next numeral as one increment of the last numeral in the data DT211 ‘execution order’, registration of the image processing option identified at step S2340 in the data DT212 ‘retouching option’, registration of the parameters obtained at step S2370 in the data DT213 ‘parameters’, registration of the name of the currently selected mask data MDT generated in the mask setting process in the data DT214 ‘mask name’, and registration of a value corresponding to a click of the button BT113 ‘Invert Mask’ entered at step S2360 in the data DT215 ‘mask application’.

When it is determined at step S2394a that the combination of the image processing option and the mask data has already been registered in the work memo file FL22, the CPU 30 selects an existing record corresponding to the combination of the image processing option identified at step S2340 and the name of the currently selected mask data MDT generated in the mask setting process and overwrites the contents of the data DT213 ‘parameters’ of the selected record with the parameters newly obtained at step S2370 (step S2394c). After execution of either step S2394b or step S2394c, the program goes to ‘Return’ and proceeds to step S2396 in the flowchart of FIG. 33.

At step S2396, the CPU 30 shows the contents of the retouching record file FL21 registered at step S2392 and the contents of the work memo file FL22 updated at step S2394, in the work information display field WK on the application window WD. As shown in FIG. 24, the work information display field WK has the three tabs TB11 ‘Record’, TB12 ‘Work Memo’, and TB13 ‘Work Note’. A selection of one of the tabs TB11 to TB13 changes over the display in the work information display field WK.

FIG. 51 shows the display of the work information display field WK corresponding to the contents of the retouching record file FL21 of FIG. 48. In the illustrated state, the tab TB11 ‘Record’ is selected. The contents of the data DT102 ‘retouching option’ included in the retouching record file FL21 are displayed vertically in the order of the data DT101 ‘retouching operation No.’ in the work information display field WK. The second or the subsequent appearance of an identical image processing option is discriminated by the additional indication ‘Resetting’.

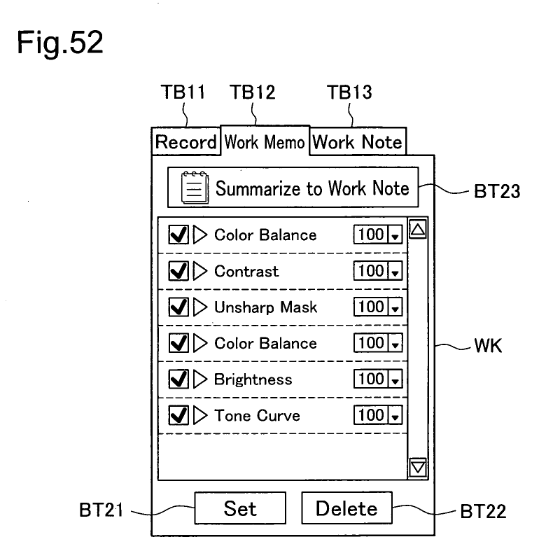

FIG. 52 shows the display of the work information display field WK corresponding to the contents of the work memo file FL22 of FIG. 49. In the illustrated state, the tab TB12 ‘Work Memo’ is selected. The contents of the data DT212 ‘retouching option’ included in the work memo file FL22 are displayed vertically in the order of the data DT211 ‘execution order’ in the work information display field WK.

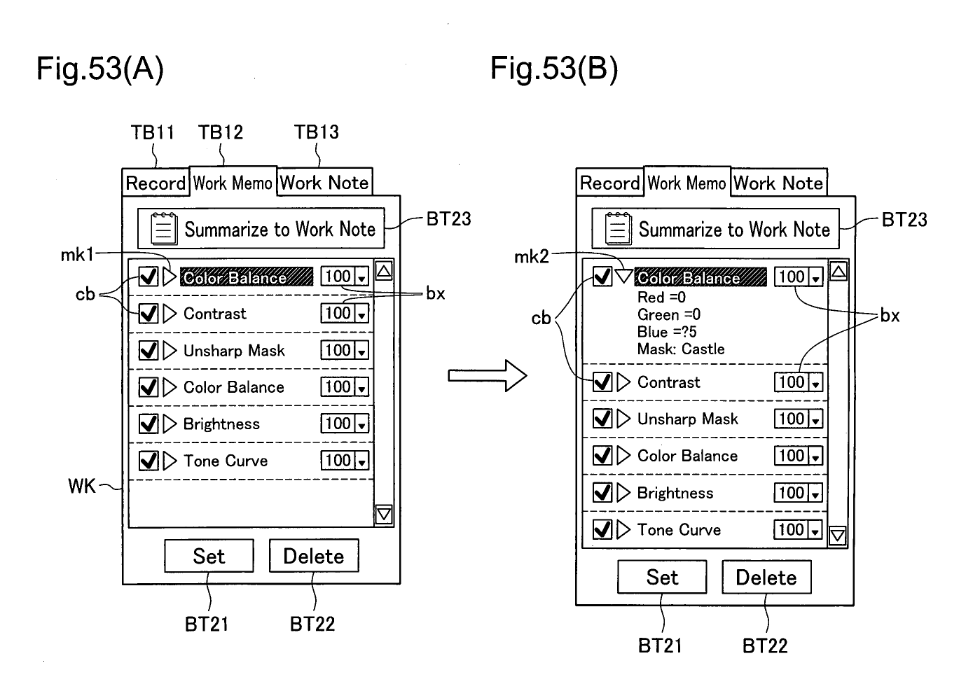

A click of a selected image processing option in the display on the work information display field WK with the mouse 20 (a click of the first image processing option ‘color balance’ in the illustrated example of FIG. 53(A)) and a subsequent click of a corresponding left arrow mk1 open the detailed settings of the parameters of the clicked image processing option and the name of the mask data as shown in FIG. 53(B). In the illustrated example, the display is changed to show the parameters ‘red=0, green=0, blue=−5’ as the parameters of ‘color balance’ and the name of the mask data ‘Castle’. A click of a down arrow mk2 closes the display of the detailed settings of the parameters.

The initial display of only the image processing options may be replaced by the initial display of the name of the mask data MDT with the image processing options. Any technique is applicable to ensure display of at least the image processing options and the mask data.

Checkboxes cb are provided on the left of the respective image processing options shown in the work information display field WK. Removal of the tick from a selected checkbox cb inactivates a corresponding image processing option for further retouching of the input image data Dpi. The temporary inactivation of the selected image processing option enables the user to check the effects of the image processing options on a resulting image.

A button BT21 ‘Set’ and a button BT22 ‘Delete’ are also provided on the bottom of the work information display field WK. The user clicks a selected image processing option in the display on the work information display field WK and the button BT21 ‘Set’ with the mouse 20 to open a dialog box for entry of the detailed settings of the clicked image processing option. For example, the user's click of the selected image processing option ‘color balance’ opens the dialog box DBX24 as shown in FIG. 47. The current settings are displayed in parameter input boxes of the dialog box DBX24. In the illustrated example of FIG. 47, the slider bars SB11 to SB13 indicate the current settings of ‘red=0, green=0, blue=−5’ in the parameter input boxes, although the indication of −5 on the ‘Blue’ slider bar SB13 may not be clearly visible. The user may change the current settings of the parameters of the selected image processing option on the display of the dialog box DBX1.

This arrangement enables the user to readily change the current settings of the parameters of the selected image processing option and performs a required series of image processing of the input image data with the changed settings of the parameters.

The user clicks a selected image processing option in the display on the work information display field WK and the button BT22 ‘Delete’ with the mouse 20 to delete the clicked image processing option.

The display of the work information display field WK under the selection of the tab TB12 ‘Work Memo’ has a top button BT23 ‘Summarize to Work Note’. The contents of the work memory file FL22 represent the ‘procedure of completing a desired processed image’. Storage of the contents of the work memo file FL22 as a work note file allows for later application of the same procedure. The user clicks the button BT23 with the mouse 20 to store the contents of the work memo file FL22 displayed in the work information display field WK into the HDD 42 as a work note file. The user's click of the button BT23 with the mouse 20 opens a non-illustrated dialog box. The user enters the ‘file name’ and the ‘title’ in the dialog box. The contents of the work memory file FL22 with the entered ‘title’ are stored as a work note file under the entered ‘file name’ in the HDD 42.

The non-volatile memory of the HDD 42 maintains the storage of the contents of the work memo file FL22 in the form of the work note file even in a power-off state of the computer system 10. The effective and efficient settings of image retouching for certain input image data can thus be applicable to retouching of any other image data.

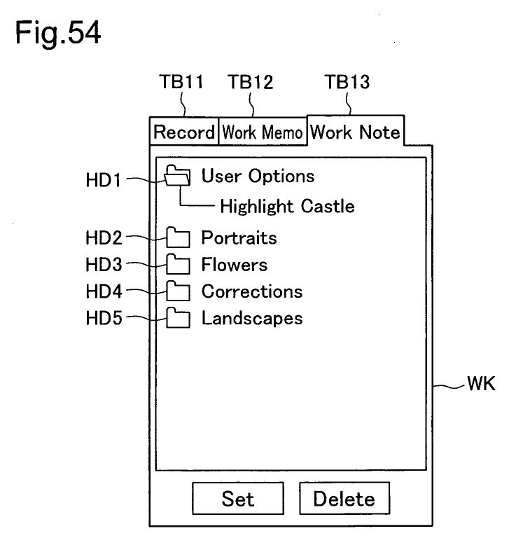

The display of the work information display field WK under the selection of the tab TB13 ‘Work Note’ in the third embodiment is shown in FIG. 54, which is similar to the display in the first embodiment shown in FIG. 15.

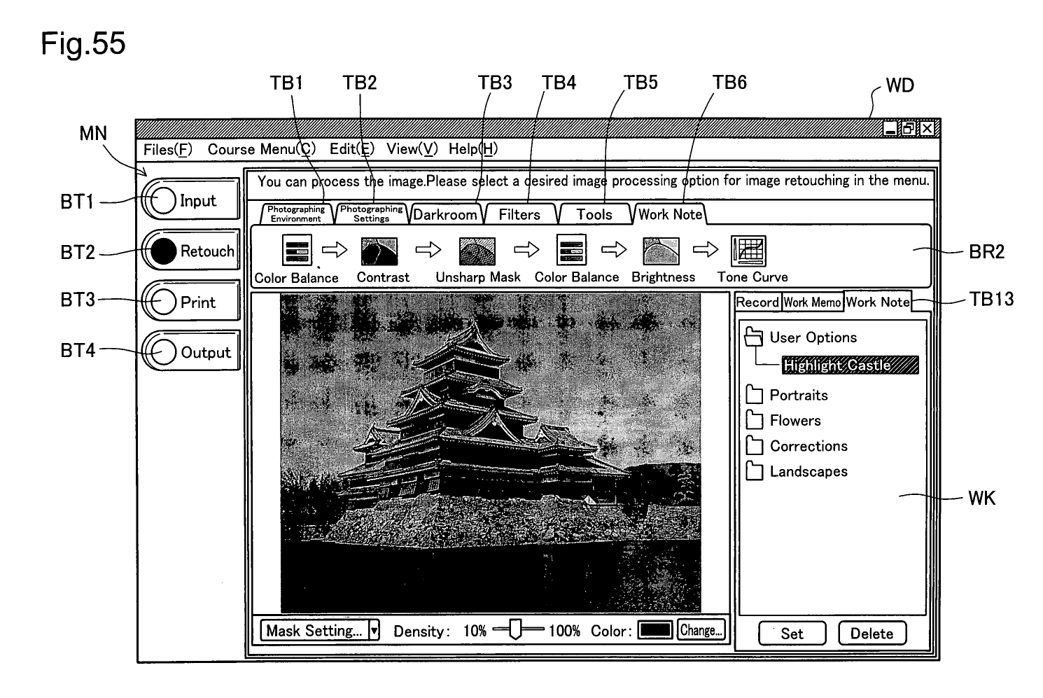

FIG. 55 shows the display of the application window WD for the retouching process in response to selection of the group tab TB6 ‘Work Note’ on the tool bar BR2. As described above, each selection of the tabs TB1 to TB6 changes the display of icons of image processing operations on the tool bar BR2. Under the selection of the tab TB6 ‘Work Note’, the display of icons on the tool bar BR2 depends on a selected work note file in the work information display field WK. In the illustrated example of FIG. 55, the work note file under the user's entered title of ‘Highlight Castle’ is selected. The tool bar BR2 under the selection of the tab TB6 ‘Work Note’ has the display of icons ‘Color Balance’, ‘Contrast’, ‘Unsharp Mask’, ‘Color Balance’, ‘Brightness’, and ‘Tone Curve’ arranged horizontally from the left to the right.

The registration of the selected work note file with the title ‘Highlight Castle’ specifies the displayed icons ‘Color Balance’ to ‘Tone Curve’. The work note file with the title ‘Highlight Castle’ is equivalent to the contents of the work memo file FL22 with the user's entered title and accordingly has the registered details of the image processing operations shown in FIG. 49. According to the registered details of the image processing operations, the icons ‘Color Balance’, ‘Contrast’, ‘Unsharp Mask’, ‘Color Balance’, ‘Brightness’, and ‘Tone Curve’ are selected and arranged in this order.

Namely the arrangement of icons displayed on the tool bar BR2 is based on the work note file selected in the display of the work information display field WK under the selection of the tab TB13 ‘Work Note’. The work note file represents the operating procedure of image processing. The details of the multiple image processing operations registered in the work note file thus specify the selection and the arrangement of the icons.

When the user selects the title of a desired work note file in the work information display field WK under the selection of the tab TB13 ‘Work Note’, a required series of image processing operations to obtain an object processed image are presented on the tool bar BR2. The user successively clicks the icons from the left to the right on the tool bar BR2 to sequentially perform the required series of image processing operations. The user's click of each icon opens a dialog box for entry of the settings of relevant parameters as described above with reference to FIG. 47. The current settings are shown in the parameter input boxes of the dialog box. For example, in the dialog box for the entry of ‘color balance’ shown in FIG. 47, the slider bars SB11 to SB13 indicate the current settings of ‘red=0, green=0, blue=−5’ in the parameter input boxes. The user clicks the button BT12 ‘OK’ without any change of the current settings in the parameter input boxes to execute the image processing operation according to the registration of the work note file. The user may regulate the settings in the parameter input boxes of the dialog box according to the requirements.

The image data newly input by the input module 51 then goes through the series of multiple image processing options registered in the selected work note file.

Referring back to the flowchart of FIG. 33, after execution of step S2396, the CPU 30 determines whether the user's selection of the icons displayed on the tool bar BR2 has been completed (step S2398). When the user enters a command other than selection of any of the icons on the tool bar BR2, the retouching flow gives an affirmative answer at step S2398 and goes to ‘Return’. When it is determined at step S2398 that the user's selection of the icons has not yet been completed, on the other hand, the retouching flow returns to step S2340 to execute a next image processing operation corresponding to a newly selected icon.

C. Functions and Effects

As described above, the computer system of the third embodiment enables mask data generated in the mask setting process to be applied to multiple different image processing operations of input image data Dpi. This arrangement thus ensures the high working efficiency in application of masks to image processing operations. Generated mask data are registered in the mask table TBLm in a selectable manner. This arrangement enables plurality of desired mask data to be efficiently applicable to multiple different image processing operations of the input image data Dpi.

The prior art technique applies mask data representing each mask to only one specified image processing operation and does not store the mask data alone. The mask data generated for one image processing operation is thus not reusable for other image processing operations. The arrangement of this embodiment, however, enables the same mask data to be conveniently applied to multiple different image processing operations.

The structure of this embodiment uses the mask names for management of the mask data stored in the mask table TBLm and for correlation of the mask data with the work memo file FL22.

Each work memo file FL22 has a record of selected image processing options with selected masks arranged in an execution sequence and final settings of relevant parameters with regard to input image data Dpi. The user can thus readily refer to the details of the efficient image processing operations performed with regard to the input image data Dpi. The structure of this embodiment displays the contents of the work memo file FL22 in the work information display field WK. This enables the user to visually confirm the name of the selected mask data.

3-2. Modifications

The arrangement of the third embodiment may be modified in various ways including the modified examples (1) through (3) of the first embodiment. Another example of possible modification is given below.

(1) The mask data, as well as the work note file including the contents of the work memo file FL22 may be stored in another non-volatile memory separate from the computer body 16, instead of the HDD 42, for example, in a server of the computer network.

1. An image retouching apparatus that sequentially performs plural image processing operations on input image data, so as to retouch the input image data, said image retouching apparatus comprising:
an image processing setting module that, in response to reception of a user's instruction, identifies each image processing operation to be performed on the input image data and specifies settings of retouching parameters relevant to the identified image processing operation;
an image processing module that, in response to the identification and the specification of each image processing operation by said image processing setting module, performs the identified image processing operation with the specified settings of the relevant retouching parameters, so as to sequentially implement the plural image processing operations for conversion of the input image data to final retouched image data; and
an image processing recording module that, on completion of each image processing operation performed by said image processing module, updates a record file having an efficiently configured record, based on the identification of the image processing operation and the specification of the settings of the relevant retouching parameters by said image processing setting module, where the efficiently configured record of the record file includes results of the identification and the specification of the plural image processing operations grouped into multiple different image processing operations to be performed in a preset order for conversion of the input image data to the final retouched image data.

2. An image retouching apparatus in accordance with claim 1, wherein said image processing recording module comprises:
a record addition module that sequentially adds record data, which includes results of the identification and the specification of each image processing operation by said image processing setting module, to the record file; and
a record overwrite module that, when an identification result of one image processing operation currently identified and specified by said image processing setting module is identical with an identification result of another image processing operation previously performed on the input image data and recorded in the record file, prohibits said record addition module from adding new record data and overwrites existing settings of retouching parameters of the image processing operation previously performed and recorded in the record file with new settings of the retouching parameters of the currently identified image processing operation.

3. An image retouching apparatus in accordance with claim 2, said image retouching apparatus further comprising:
an image processing selection module that selects one of the multiple different image processing operations recorded in the record file;
a settings rewrite module that rewrites existing settings of retouching parameters of the selected image processing operation in the record file; and
an image processing re-execution module that performs the multiple different image processing operations in the preset order on the input image data according to the rewritten record file.

4. An image retouching apparatus in accordance with claim 3, wherein said image processing re-execution module comprises:
a first display control module that displays an input menu including multiple activation switches, which are arranged in the preset order to respectively correspond to the multiple different image processing operations recorded in the preset order in the record file and are operated to activate the corresponding image processing operations, on a display device; and
a second display control module that, in response to operation of one of the multiple activation switches to select a corresponding image processing operation, opens a dialog box for entry of retouching parameters relevant to the selected image processing operation on the display device,
said second display control module being configured to read recorded settings of the retouching parameters of the selected image processing operation from the record file and to display the recorded settings in the dialog box.

5. An image retouching apparatus in accordance with claim 1, said image retouching apparatus further comprising:
a record file storage module that transfers the record file to a non-volatile memory to be stored in the non-volatile memory.

6. An image retouching apparatus in accordance with claim 5, said image retouching apparatus further comprising:
an image processing application module that sequentially performs the multiple different image processing operations on newly input image data according to the record file stored in the non-volatile memory.

7. An image retouching apparatus in accordance with claim 6, wherein said image processing application module comprises:
a first display control module that displays an input menu including multiple activation switches, which are arranged in the preset order to respectively correspond to the multiple different image processing operations recorded in the preset order in the record file and are operated to activate the corresponding image processing operations, on a display device; and
a second display control module that, in response to operation of one of the multiple activation switches to select a corresponding image processing operation, opens a dialog box for entry of retouching parameters relevant to the selected image processing operation on the display device,
said second display control module being configured to read recorded settings of the retouching parameters of the selected image processing operation from the record file and to display the recorded settings in the dialog box.

8. An image retouching apparatus that sequentially performs plural image processing operations on input image data, so as to retouch the input image data, said image retouching apparatus comprising:
an image processing identification module that receives a user's instruction and identifies each of the plural image processing operations to be performed sequentially on the input image data;
a parameter setting module that, in response to the identification of each image processing operation by said image processing identification module, receives the user's instruction and specifies settings of retouching parameters relevant to the identified image processing operation;
an image processing module that, in response to the specification of settings of retouching parameters relevant to the identified image processing operation by said parameter setting module, performs the identified image processing operation with the specified settings of the relevant retouching parameters, so as to sequentially implement the plural image processing operations for conversion of the input image data to final retouched image data;
a character input module that receives the user's instruction and entry of a character string in the course of the specification of settings of retouching parameters relevant to a certain image processing operation by said parameter setting module; and
a data storage module that stores character data, which represents the user's entry of the character string received by said character input module, in relation to an identification result of the certain image processing operation with the settings of the relevant retouching parameters specified by said parameter setting module during the user's entry of the character string.

9. An image retouching apparatus in accordance with claim 8, said image retouching apparatus further comprising:
a display control module that displays a record of the character data stored in said data storage module with the related identification result of the certain image processing operation on a display device.

10. An image retouching apparatus in accordance with claim 9, wherein said display control module opens a specific window on the display device to display a list of records of stored character data with related identification results of all the plural image processing operations performed on the input image data by said image processing module.

11. An image retouching apparatus in accordance with claim 8, said image retouching apparatus further comprising:
an image processing recording module that, on completion of each of the plural image processing operations performed sequentially on the input image data by said image processing module for conversion of the input image data to the final retouched image data, records details of the performed image processing operation, which include the settings of the relevant retouching parameters specified by said parameter setting module, in a record file; and
an image processing re-execution module that sequentially performs the plural image processing operations on the input image data according to the details of the image processing operations recorded in the record file.

12. An image retouching apparatus in accordance with claim 11, wherein said image processing recording module comprises:
a record addition module that sequentially adds a record, which includes an identification result of each image processing operation, in relation to settings of retouching parameters of the identified image processing operation specified by said parameter specification module, to the record file; and
a record overwrite module that, when said parameter specification module specifies new settings of retouching parameters relevant to one image processing operation that is identified to be identical with another image processing operation previously performed on the input image data and recorded in the record file, prohibits said record addition module from adding a new record and overwrites existing settings of the retouching parameters of the image processing operation previously performed and recorded in the record file with the new settings of the retouching parameters.

13. An image retouching apparatus in accordance with claim 12, wherein said data storage module stores the character data grouped into same identification results of the plural image processing operations in the record file.

14. An image retouching apparatus in accordance with claim 11, said image retouching apparatus further comprising:
an additional character entry module that receives the user's instruction and entry of an additional character string in the course of recording the details of each image processing operation in the record file; and
an additional character data storage module that stores additional character data, which represents the user's entry of the additional character string received by said additional character entry module, in the record file.

15. An image retouching apparatus in accordance with claim 14, said image retouching apparatus further comprising:
a display control module that displays the character data stored in the record file on a display device.

16. An image retouching apparatus that sequentially performs plural image processing operations on input image data, so as to retouch the input image data, said image retouching apparatus comprising:
a mask data setting module that sets mask data representing a mask, which is laid on the input image data to mask a specified area of an input image expressed by the input image data during execution of the selected image processing operation;
an image processing setting module that, in response to reception of a user's instruction, identifies each image processing operation to be performed on the input image data and specifies settings of retouching parameters relevant to the identified image processing operation; and
an image processing module that, in response to the identification and the specification of each image processing operation by said image processing setting module, performs the identified image processing operation with the mask data set by said mask data setting module and with the specified settings of the relevant retouching parameters, so as to sequentially implement the plural image processing operations for conversion of the input image data to final retouched image data.

17. An image retouching apparatus in accordance with claim 16, said image retouching apparatus further comprising:
a mask data registration module that registers each mask data set by said mask data setting module in a mask table; and
a mask data selection module that, in response to the user's instruction, selects the user's desired mask data out of available mask data registered in the mask table,
wherein said image processing module uses the user's desired mask data selected by said mask data selection module for the mask data set by said mask data setting module.

18. An image retouching apparatus in accordance with claim 17, wherein said mask data registration module registers each mask data with a name given to the mask data by the user's instruction, and
said mask data selection module selects the user's desired mask data by specifying a corresponding name given to the mask data.

19. An image retouching apparatus in accordance with claim 18, said image retouching apparatus further comprising:
a recording module that, on completion of each image processing operation performed by said image processing module, sequentially adds a record, which includes an identification result of the image processing operation, specified settings of retouching parameters relevant to the identified image processing operation, and a name of mask data applied to the identified image processing operation, to a record file; and
a record overwrite module that, when said image processing module re-executes an identical image processing operation in combination with identical mask data, which was performed previously on the input image data and was recorded in the record file, prohibits said recording module from adding a new record to the record file and overwrites existing settings of retouching parameters relevant to the identical image processing operation in the record file with new settings of the retouching parameters for re-execution.

20. An image retouching apparatus in accordance with claim 19, said image retouching apparatus further comprising:
a display control module that reads at least the identification result of each image processing operation and the name of mask data to be applied to the identified image processing operation from the record file and displays at least the identification result and the name of mask data on a display device.

21. An image retouching apparatus in accordance with claim 16, said image retouching apparatus further comprising:
a mask data storage module that stores the mask data in a non-volatile memory.

22. An image retouching method that sequentially performs plural image processing operations on input image data, so as to retouch the input image data, said image retouching method comprising the steps of:
(a) in response to reception of a user's instruction, identifying each image processing operation to be performed on the input image data and specifying settings of retouching parameters relevant to the identified image processing operation;
(b) in response to the identification and the specification of each image processing operation in said step (a), performing the identified image processing operation with the specified settings of the relevant retouching parameters, so as to sequentially implement the plural image processing operations for conversion of the input image data to final retouched image data; and
(c) on completion of each image processing operation performed in said step (b), updating a record file having an efficiently configured record, based on the identification of the image processing operation and the specification of the settings of the relevant retouching parameters in said step (a), where the efficiently configured record of the record file includes results of the identification and the specification of the plural image processing operations grouped into multiple different image processing operations to be performed in a preset order for conversion of the input image data to the final retouched image data.

23. An image retouching method in accordance with claim 22, wherein said step (c) comprises the steps of:
(c-1) sequentially adding record data, which includes results of the identification and the specification of each image processing operation in said step (a), to the record file; and
(c-2) when an identification result of one image processing operation currently identified and specified in said step (a) is identical with an identification result of another image processing operation previously performed on the input image data and recorded in the record file, prohibiting addition of new record data in said step (c-1) and overwriting existing settings of retouching parameters of the image processing operation previously performed and recorded in the record file with new settings of the retouching parameters of the currently identified image processing operation.

24. An image retouching method that sequentially performs plural image processing operations on input image data, so as to retouch the input image data, said image retouching method comprising the steps of:
(a) receiving a user's instruction and identifying each of the plural image processing operations to be performed sequentially on the input image data;
(b) in response to the identification of each image processing operation in said step (a), receiving the user's instruction and specifying settings of retouching parameters relevant to the identified image processing operation;
(c) in response to the specification of settings of retouching parameters relevant to the identified image processing operation in said step (b), performing the identified image processing operation with the specified settings of the relevant retouching parameters, so as to sequentially implement the plural image processing operations for conversion of the input image data to final retouched image data;
(d) receiving the user's instruction and entry of a character string in the course of the specification of settings of retouching parameters relevant to a certain image processing operation in said step (b); and
(e) storing character data, which represents the user's entry of the character string received in said step (d), in relation to an identification result of the certain image processing operation with the settings of the relevant retouching parameters specified in said step (b) during the user's entry of the character string.

25. An image retouching method in accordance with claim 24, said image retouching method further comprising the step of:
(f) displaying a record of the character data stored in said step (e) with the related identification result of the certain image processing operation on a display device.

26. An image retouching method that sequentially performs plural image processing operations on input image data, so as to retouch the input image data, said image retouching method comprising the steps of:
(a) setting mask data representing a mask, which is laid on the input image data to mask a specified area of an input image expressed by the input image data during execution of the selected image processing operation;
(b) in response to reception of a user's instruction, identifying each image processing operation to be performed on the input image data and specifying settings of retouching parameters relevant to the identified image processing operation; and
(c) in response to the identification and the specification of each image processing operation in said step (b), performing the identified image processing operation with the mask data set in said step (a) and with the specified settings of the relevant retouching parameters, so as to sequentially implement the plural image processing operations for conversion of the input image data to final retouched image data.

27. An image retouching method in accordance with claim 26, said image retouching method further comprising the steps of:
(d) registering each mask data set in said step (a) in a mask table; and
(e) in response to the user's instruction, selecting the user's desired mask data out of available mask data registered in the mask table, wherein said step (c) uses the user's desired mask data selected in said step (e) for the mask data set in said step (a).

28. A computer program product that causes a computer to sequentially perform plural image processing operations on input image data and thereby retouch the input image data, said computer program product comprising:
a computer readable recording medium; and
a computer program recorded in said recording medium, said computer program comprising:
a first program of, in response to reception of a user's instruction, identifying each image processing operation to be performed on the input image data and specifying settings of retouching parameters relevant to the identified image processing operation;
a second program of, in response to the identification and the specification of each image processing operation by said first program, performing the identified image processing operation with the specified settings of the relevant retouching parameters, so as to sequentially implement the plural image processing operations for conversion of the input image data to final retouched image data; and
a third program of, on completion of each image processing operation performed by said second program, updating a record file having an efficiently configured record, based on the identification of the image processing operation and the specification of the settings of the relevant retouching parameters by said first program, where the efficiently configured record of the record file includes results of the identification and the specification of the plural image processing operations grouped into multiple different image processing operations to be performed in a preset order for conversion of the input image data to the final retouched image data.

29. A computer program product in accordance with claim 28, wherein said third program comprises:
a record addition program that sequentially adds record data, which includes results of the identification and the specification of each image processing operation by said first program, to the record file; and
a record overwrite program that, when an identification result of one image processing operation currently identified and specified by said first program is identical with an identification result of another image processing operation previously performed on the input image data and recorded in the record file, prohibits said record addition program from adding new record data and overwrites existing settings of retouching parameters of the image processing operation previously performed and recorded in the record file with new settings of the retouching parameters of the currently identified image processing operation.

30. A computer program product in accordance with claim 29, wherein said computer program further comprises:
a fourth program of selecting one of the multiple different image processing operations recorded in the record file;
a fifth program of rewriting existing settings of retouching parameters of the selected image processing operation in the record file; and
a sixth program of performing the multiple different image processing operations in the preset order on the input image data according to the rewritten record file.

31. A computer program product in accordance with claim 30, wherein said sixth program comprises:
an input box display program that displays an input menu including multiple activation switches, which are arranged in the preset order to respectively correspond to the multiple different image processing operations recorded in the preset order in the record file and are operated to activate the corresponding image processing operations, on a display device; and
a dialog box display program that, in response to operation of one of the multiple activation switches to select a corresponding image processing operation, opens a dialog box for entry of retouching parameters relevant to the selected image processing operation on the display device,
said dialog box display program being configured to read recorded settings of the retouching parameters of the selected image processing operation from the record file and to display the recorded settings in the dialog box.

32. A computer program product in accordance with claim 28, wherein said computer program further comprises:
a seventh program of transferring the record file to a non-volatile memory to be stored in the non-volatile memory.

33. A computer program product that causes a computer to sequentially perform plural image processing operations on input image data and thereby retouch the input image data, said computer program product comprising:
a computer readable recording medium; and
a computer program recorded in said recording medium,
said computer program comprising:
a first program of receiving a user's instruction and identifying each of the plural image processing operations to be performed sequentially on the input image data;
a second program of, in response to the identification of each image processing operation by said first program, receiving the user's instruction and specifying settings of retouching parameters relevant to the identified image processing operation;
a third program of, in response to the specification of settings of retouching parameters relevant to the identified image processing operation by said second program, performing the identified image processing operation with the specified settings of the relevant retouching parameters, so as to sequentially implement the plural image processing operations for conversion of the input image data to final retouched image data;
a fourth program of receiving the user's instruction and entry of a character string in the course of the specification of settings of retouching parameters relevant to a certain image processing operation by said second program; and
a fifth program of storing character data, which represents the user's entry of the character string received by said fourth program, in relation to an identification result of the certain image processing operation with the settings of the relevant retouching parameters specified by said second program during the user's entry of the character string.

34. A computer program product in accordance with claim 33, wherein said computer program further comprises:
a sixth program of displaying a record of the character data stored by said fifth program with the related identification result of the certain image processing operation on a display device.

35. A computer program product in accordance with claim 34, wherein said sixth program opens a specific window on the display device to display a list of records of stored character data with related identification results of all the plural image processing operations performed on the input image data by said third program.

36. A computer program product that causes a computer to sequentially perform plural image processing operations on input image data and thereby retouch the input image data, said computer program product comprising:
a computer readable recording medium; and
a computer program recorded in said recording medium,
said computer program comprising:
a first program of setting mask data representing a mask, which is laid on the input image data to mask a specified area of an input image expressed by the input image data during execution of the selected image processing operation;
a second program of, in response to reception of a user's instruction, identifying each image processing operation to be performed on the input image data and specifying settings of retouching parameters relevant to the identified image processing operation; and
a third program of, in response to the identification and the specification of each image processing operation by said second program, performing the identified image processing operation with the mask data set by said first program and with the specified settings of the relevant retouching parameters, so as to sequentially implement the plural image processing operations for conversion of the input image data to final retouched image data.

37. A computer program product in accordance with claim 36, wherein said computer program further comprises:
a fourth program of registering each mask data set by said first program in a mask table; and
a fifth program of, in response to the user's instruction, selecting the user's desired mask data out of available mask data registered in the mask table,
wherein said third program uses the user's desired mask data selected by said fifth program for the mask data set by first program.

38. A computer program product in accordance with claim 37, wherein said fourth program registers each mask data with a name given to the mask data by the user's instruction, and
said fifth program selects the user's desired mask data by specifying a corresponding name given to the mask data.

39. A computer program product in accordance with claim 38, wherein said computer program further comprises:
a sixth program of, on completion of each image processing operation performed by said third program, sequentially adding a record, which includes an identification result of the image processing operation, specified settings of retouching parameters relevant to the identified image processing operation, and a name of mask data applied to the identified image processing operation, to a record file; and
a seventh program of, when said third program re-executes an identical image processing operation in combination with identical mask data, which was performed previously on the input image data and was recorded in the record file, prohibiting said sixth program from adding a new record to the record file and of overwriting existing settings of retouching parameters relevant to the identical image processing operation in the record file with new settings of the retouching parameters for re-execution.

40. A computer program product in accordance with claim 36, wherein said computer program further comprises:
a ninth program of storing the mask data in a non-volatile memory.
